(19) United States
(12) Patent Application Publication
(10) Pub. No.: US 2002/0052933 A1
(43) Pub. Date: May 2, 2002

(54) Method and apparatus for licensing media over a network

(76) Inventors: Gerd Leonhard, Winden (DE); Jack Wolosewicz, San Francisco, CA (US); Jim Kelly, San Francisco, CA (US); Andy Neil, Berkeley, CA (US); Igor Polovinchik, San Francisco, CA (US); Alex Talyamsky, Daly City, CA (US); Tobias Tornqvist, San Francisco, CA (US); Bill Wheeler, San Francisco, CA (US)

Correspondence Address: Morrison & Foerster LLP, 425 Market Street, San Francisco, CA, 94105-2482, US

(21) Appl. No.: 09/760,082

(22) Filed: Jan. 12, 2001

Related U.S. Application Data
(60) Provisional application No. 60/176,166, filed on Jan. 14, 2000.

(51) Int. Cl. G06F 15/16

(52) U.S. Cl. 709/219; 707/3

(57) ABSTRACT

A method and system is provided for searching for and licensing media content over a network.

### TECHNICAL FIELD

The present invention relates to management of media over a network, and more particularly to licensing and searching media over a network.

### BACKGROUND ART

Professionals wishing to find and purchase a license for high-quality original and copyrighted media content presently must undergo a process taking a minimum of weeks and often months. First, a potential purchaser must find music that suits the purchaser's needs, often relying on word of mouth, personal knowledge of bands, and various song and band lists. The purchaser must also locate a person legally entitled to negotiate for the owner or owners of the media content. Then, the purchaser must negotiate for a potentially arbitrary price for the use of the media content. During the negotiation process, lawyers may become involved, further driving up costs and the time required for the negotiation. Finally, a proposal would have to be accepted by both parties, with a risk of a party withdrawing from the agreement until the process is completed.

Such processes followed by a user seeking to find and license music are inefficient and lead to suboptimal results. What is needed is an apparatus and method for intelligently searching and efficiently licensing media content. The present invention fills this need.

### SUMMARY OF THE INVENTION

The present invention provides a method and apparatus for graphically searching and licensing media over a network. The present invention includes a method of graphically searching media over a network including a client, a server, and at least one database associated with the server by communicating to the client at least one objective parameter, receiving at least one objective parameter choice from the client, and searching the at least one database for at least one matching media file that matches the at least one objective parameter choice.

In an aspect of the invention, the method graphically displays to the client the at least one matching media file and communicates a license offer for the media content. In a further aspect of the invention, the at least one objective parameter of the method can be subject, instrument, region, language, composer, time period, and/or maximum price. In a further aspect of the invention, the graphical display of the invention may be in the form of a Venn Diagram.

In another aspect of the invention, the invention includes a method of graphically searching media over a network including a client, a server, and at least one database associated with the server by communicating to the client at least one subjective parameter, receiving at least one subjective parameter choice from the client, and searching the at least one database for at least one matching media file that matches the at least one subjective parameter choice. In a further aspect of the invention, the at least one subjective parameter of the method may be genre, style, tempo, and/or mood.

In another aspect of the invention, the invention displays search results for media content by receiving a first parameter choice, searching at least one database for media content matching the first parameter choice, displaying a graphic representation of media content matching the first parameter choice, receiving a second parameter choice, searching the at least one database for media content matching the second parameter choice, displaying a graphic representation of media content matching the second parameter choice, and displaying a graphic representation of media content matching both the first parameter choice and the second parameter choice.

In a further aspect of the invention, the method displays a graphic representation of media content matching the first parameter choice by displaying a first region representing the media content matching the first parameter choice. In a further aspect of the invention, the method displays a graphic representation of media content matching the second parameter choice by displaying a second region representing the media content matching the second parameter choice. In a further aspect of the invention, the method displays a graphic representation of media content matching both the first parameter choice and the second parameter choice by displaying a first intersection region, wherein the first intersection region represents the media content matching both the first parameter choice and the second parameter choice.

In another aspect of the invention, the method can calculate a number of matches associated with the first region and display the number of matches. The method can also calculate a number of matches associated with the second region and displays the number of matches. In a further aspect of the invention, the method displays a number of matches associated with the first intersection region. In a further aspect of the invention, the first region may be re-sized in connection with display of the second region. The second region may also be re-sized. In a further aspect of the invention, the size of the first region corresponds to the number of media content matches to the first parameter choice from the client. The size of the second region corresponds to the number of media content matches to the second parameter choice from the client. The regions can be substantially circular.

In another aspect of the invention, the method receives a third parameter choice from the client, searches the at least one database for media content matching the third parameter choice, displays a graphic representation of media content matching the third parameter choice, and displays a graphic representation of media content matching the first, second, and third parameter choices.

The invention also provides a method of displaying search results for data by receiving a first parameter choice and a second parameter choice, searching at least one database for matches to the first and the second parameter choices, displaying a graphic representation of data that matches the first parameter choice, displaying a graphic representation of data that matches the second parameter choice, and displaying a graphic representation of data that matches both the first and the second parameter choices. In a further aspect of the invention, the data may be media content.

The invention also provides a method of licensing media over a network including a client and a server by receiving over the network a request associated with media content, wherein the request contains at least one preference, calculating a license fee for the media content using the at least one preference, and communicating a license offer for the media content. In a further aspect of the invention, the media content may be audio content, still image content, and/or video content. In a further aspect of the invention, the at least one preference can include a use for the media content.

In a further aspect of the invention, the at least one preference may be a medium for use of the media content, a duration of the media content, and/or a production size for use of the media content.

In another aspect of the invention, the use may be a game use, a corporate use, an internet use, an advertisement use, a motion picture production use, a home video use, a CD-ROM use, a roll-over advance use, a music compilation use, a music programming and syndication use, and/or a buyout use.

In another aspect of the invention, a method is provided for licensing media over a network having a client, a server, and a database associated with the server, wherein the database stores a plurality of media files, by receiving a search request from the client, wherein the search request contains at least one parameter specified by the client, searching the database in the server for at least one media file matching the at least one parameter specified by the client, and sending a license offer for the at least one media file matching the set of the at least one parameter.

In another aspect of the invention, a method is provided for licensing media over a network including a client, a server, and a database associated with the server, wherein the database includes a plurality of media files, by receiving a search request from the client, wherein the search request contains at least one parameter specified by the client, searching the database for at least one media file matching the at least one parameter specified by the client, communicating to the client a list of at least one preview file associated with the at least one matching media file, receiving a request for a preview file from the list, and communicating to the client the requested preview file.

In a further aspect of the invention, the at least one listed preview file includes a portion of the associated at least one matching media file. In another aspect of the invention, the at least one listed preview file includes the entire associated at least one matching media file. In a further aspect of the invention, the invention communicates to the client a matching media file associated with the requested preview file.

In another aspect of the invention, a method is provided for licensing media over a network including a client associated with a user, a server, and a database associated with the server, wherein the database includes a plurality of media files, by receiving a search request from the client, wherein the search request includes at least one parameter specified by the client, searching the database for at least one media file matching the at least one parameter specified by the client, communicating to the client a list of the at least one matching media file, receiving a license request for at least one of the matching media files, wherein the license request includes at least one user preference, calculating a license for the at least one requested media file using the at least one user preference, and sending a license offer for the at least one requested matching media file.

### BRIEF DESCRIPTION OF THE DRAWINGS

FIG. 1 is a diagram illustrating a network for graphically searching and licensing media in the present invention.

FIG. 2 is a diagram of an exemplary database of the invention.

FIG. 3 is a flowchart showing an exemplary basic media licensing process followed by a client according to the invention.

FIG. 4 is a screenshot of an exemplary beginning webpage for a media licensing website seen by a user at the client.

FIGS. 5 and 6 are screenshots of an exemplary search tool of the present invention.

FIG. 7 is a screenshot of another exemplary search tool of the present invention.

FIG. 8 is a screenshot of another exemplary search tool of the present invention.

FIG. 9 is a screenshot of an browse artist screenshot or search tool of the present invention.

FIG. 10 is a screenshot of an exemplary search results screen of the present invention.

FIG. 11 is a screenshot of an exemplary edit project details screen of the present invention.

FIG. 12 is a screenshot of an exemplary my music screen of the present invention.

FIG. 13 is a screenshot of an exemplary select medium, or select use screen of the present invention.

FIGS. 14-17 are screenshots of an exemplary visual media search mechanism webpage seen by a user associated with the client in one embodiment of the invention.

FIGS. 18-25 show flowcharts and algorithms for an embodiment of a visual media search, such as a graphical search engine.

FIGS. 26-37 show an embodiment of an exemplary pricing engine for the invention.

FIG. 38 is a screenshot of an exemplary song details, or select medium and/or use screen of the present invention.

FIGS. 39-53 are exemplary screenshots of an embodiment of screens seen by the user during the licensing process.

FIGS. 54-65 show an embodiment of choices for some parameters by which a user may search using one or more of the search tools in the invention.

FIGS. 66-72 show an embodiment of screenshots of an exemplary classical track indexing form including exemplary parameters and parameter choices by which the user may search.

FIG. 73 is a screenshot of an exemplary budget library screen or search tool of the present invention.

FIGS. 74-80 are flowcharts of an exemplary searching and licensing process for another embodiment of the invention.

Appendix A shows exemplary source code for an embodiment of the invention.

Appendix B shows exemplary source code for another embodiment of the invention.

### DETAILED DESCRIPTION OF THE PREFERRED EMBODIMENTS

The present invention provides a method and apparatus for graphically searching and licensing media over a network. In the following description, numerous details are set forth in order to enable a thorough understanding of the present invention. However, it will be understood by those of ordinary skill in the art that these specific details are not required in order to practice the invention. Further, well-known elements, devices, process steps and the like are not set forth in detail in order to avoid obscuring the present invention.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

System and Process Overview

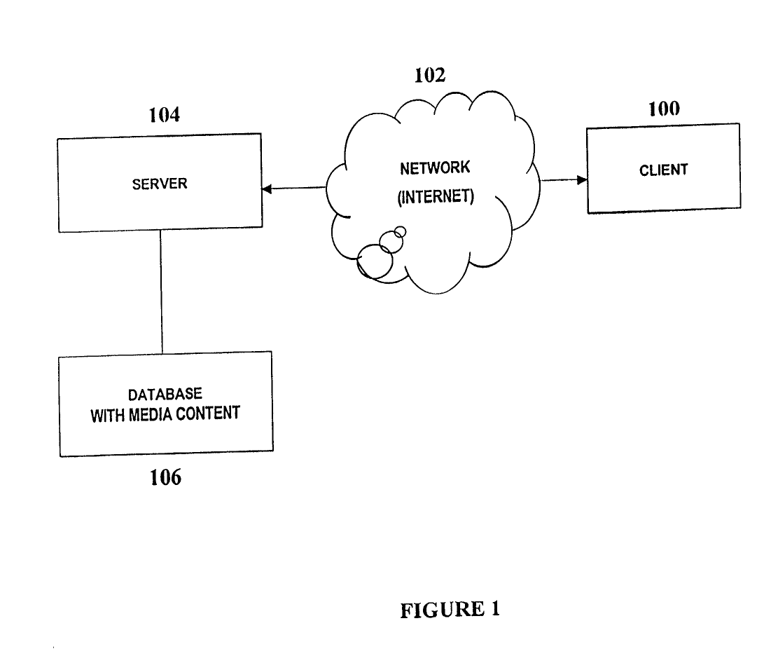

FIG. 1 is a diagram illustrating a network for graphically searching and licensing media in the present invention. A client is connected to a server over a network, such as the Internet. Using a web browser, such as Microsoft Internet Explorer or Netscape Navigator, a user associated with the client accesses a website associated with the server, via a published URL. The user then logs into the website in order to identify the user to the server. Through the use of cookies, the user can be automatically logged in on subsequent visits. The server may be associated with a database containing media content, such as music, movies, and images. In one embodiment of the invention, the database is located in the server. In another embodiment of the invention, the database can be located remotely at another location in the network, such as an internetwork or the Internet, or in another storage device associated with the server.

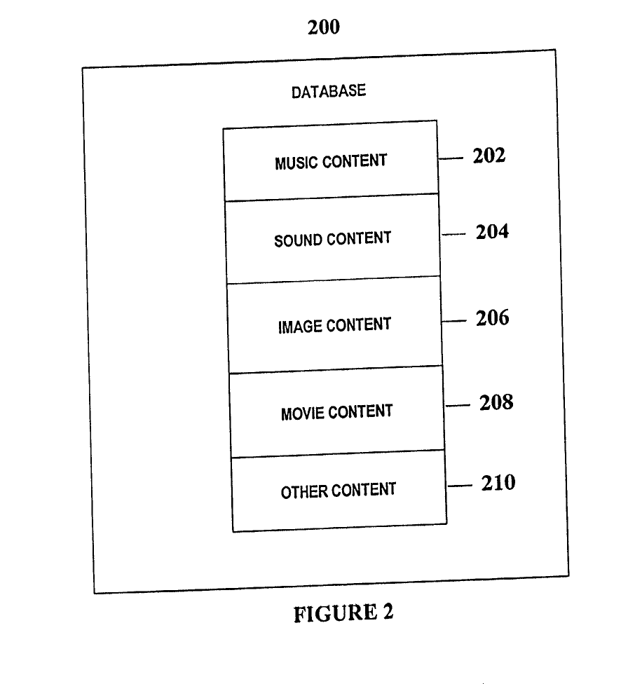

FIG. 2 is a diagram of an exemplary database of the invention. The database can hold audio content, sound content, still image content, movie content, and/or other content. Audio content, such as music, can be held in file formats such as .asx, .rm, .ram, .au, .wav, .wma, .aiff, .mp, .mp2, .mp3, and MIDI. Still image content can be held in file formats such as .jpg, .jpeg, .bmp, and .gif. Video content, such as movies, can be held in file formats such as .avi, .asx, .mpg, .mpeg, .qt, .lqt, .lq1, .ls1, .m3u, and shockwave. Other content can include any future digital file formats in which sound, image, moving image or multimedia content can be stored.

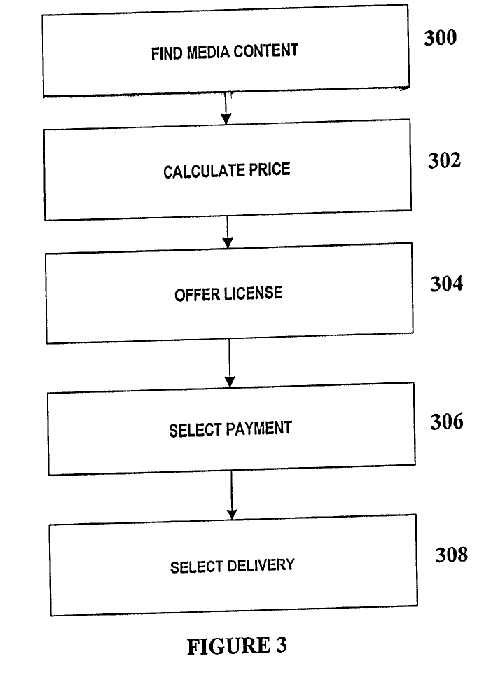

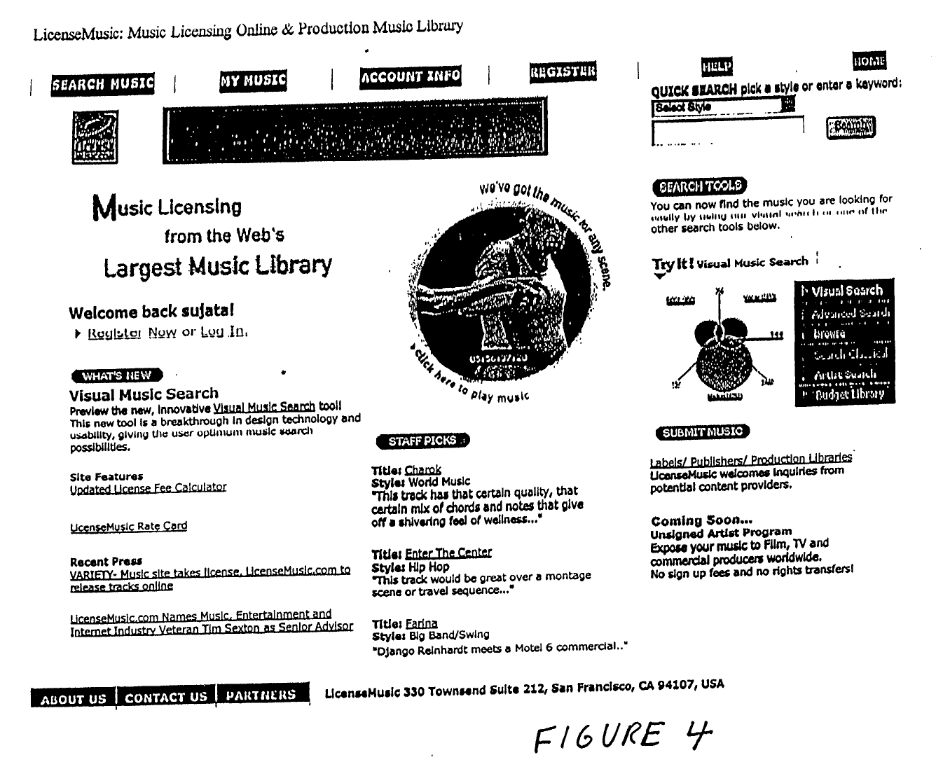

FIG. 3 is a flowchart showing an exemplary basic media licensing process followed by a client according to the invention. First, the license procedure begins by the system finding the media content that the user wishes to license. A user at the client requests media content that the user wishes to license, either by directly specifying the particular content or through a search engine, such as one of the engines described in more detail below. The user can use one of six search engines to find media content: QUICK SEARCH, VISUAL SEARCH, ADVANCED SEARCH, BROWSE, ARTIST SEARCH, SEARCH CLASSICAL, and BUDGET LIBRARY, as shown in FIG. 4 and described below.

After the user requests media content that the user wishes to license, the server receives the one or more requests and may perform a price calculation routine to determine a license price for the media content.

The user may select a use for the media (such as use in Film, Television, Internet, or Business Presentation, etc), a license duration, an audience size, and other criteria specific to that use. A licensing or pricing engine uses a price factor associated with the media content and multiplies the price factor by a price (which can be fixed) for the use and percentages associated with requirements associated with each use to determine a license fee. Some uses provide for a single price multiplier, disregarding other criteria. For example, a Student film may have a fixed price of $50, regardless of the other selections.

In one embodiment of the invention, the server communicates a license offer for the media content to the user. The user selects a payment method for the media content. The payment method can be a credit card transaction, a purchase order invoiced for an authorized purchase, or another well-known form of payment. The user selects a delivery format for the media content. The delivery format can be, for example, direct download of media files from a network site, streaming to the user, or shipment of a high quality compact disk to a location of the user's choice.

Exemplary Screenshot Interface Overview

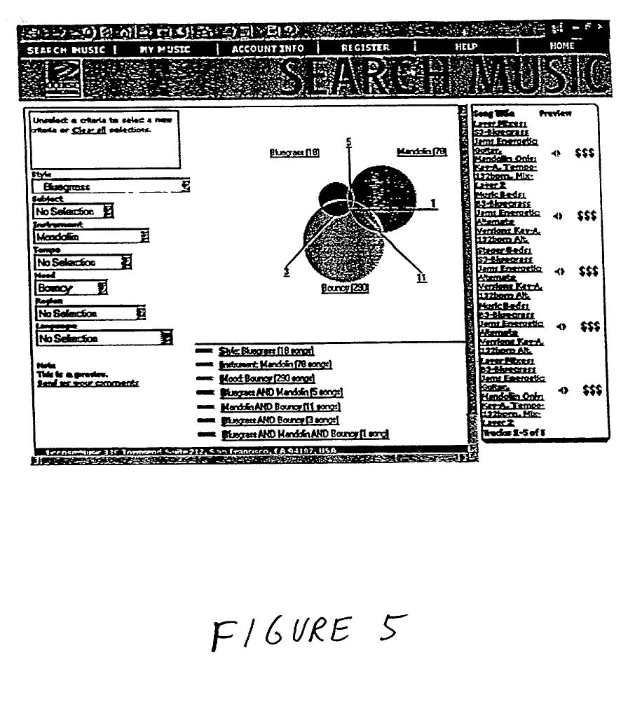

FIG. 4 is a screenshot of an exemplary beginning webpage for a media licensing website seen by a user at the client. In one embodiment of the invention, the website is for music licensing. The user can search for music by using one of six search tools: visual search; advance search; browse; search classical; artist search; and budget library. If the user clicks or selects visual search, a webpage is communicated to the client showing the visual media search mechanism in one embodiment of the invention, as exemplified in FIG. 5.

Visual Media Search Screenshot Interface

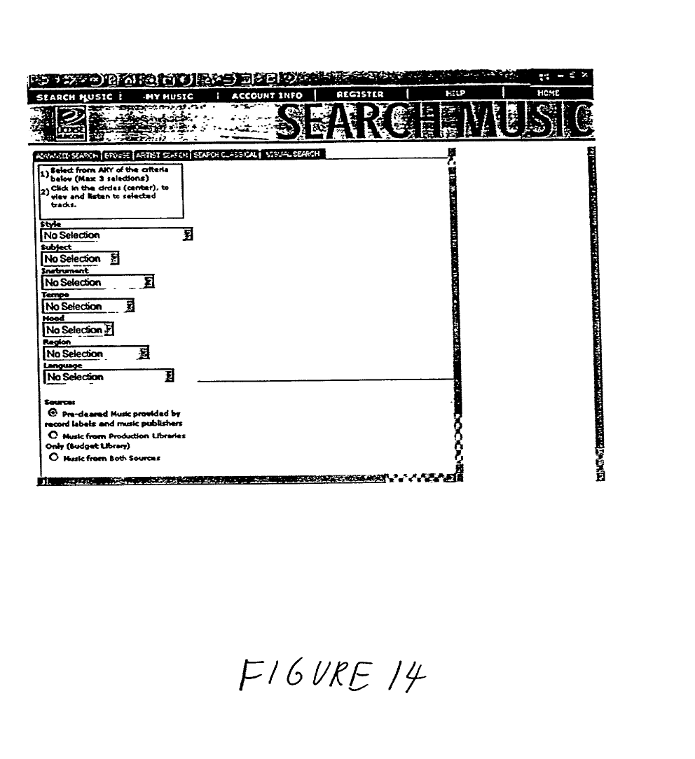

FIGS. 14-17 are screenshots of the visual media search mechanism webpage seen by a user associated with the client in one embodiment of the invention. As the visual media search webpage is displayed to the client, a Java applet runs to interactively allow graphical display of the user's choices. In one embodiment, the visual media search is a graphical search engine. Referring to FIG. 14, parameters communicated to the client for the search can include STYLE, SUBJECT, INSTRUMENT, TEMPO, MOOD, REGION, and LANGUAGE. In an embodiment of the invention, additional parameters communicated from the server to the client can include GENRE, COMPOSER, TIME PERIOD, and MAXIMUM PRICE.

One or more parameters may be objective. An objective parameter may be based on factual data or other relevant “objective” information. Objective parameters can include subject, instrument, region, language, composer, time period, maximum price, and other “objective” parameters.

One or more parameters may be subjective. A subjective parameter may be based upon discretionary data, human judgment, or other relevant “subjective” information. Subjective parameters can include genre, style, tempo, mood, and other “subjective” parameters.

One or more parameters may also be both objective and subjective, or have both objective and subjective components.

As parameter choices are selected by the user, the server searches the associated database to find associated parameter choice matches for media content. The Java applet draws up to three circles in different colors and sizes, in a form that represents a Venn Diagram. Each circle represents a set of matching media content for a parameter choice.

The overlap between drawn circle areas is defined by the number of elements common to the corresponding set of matching media content, or circles.

In another embodiment of the invention, the server receives two or more parameter choices from the client before graphically displaying search result information to the client.

In another embodiment of the invention, the regions drawn by the Java applet can be any shape or format that conveys search result information.

The Java applet can determine how the circles are drawn. The color of each circle may be determined by the parameter it represents. For instance, a parameter choice from a parameter such as Genre may be displayed as an orange circle. The first drawn circle may be represented as and drawn to 100% of the maximum circle size. Each subsequent parameter selection may prompt creation of another circle having a color associated with the parameter the corresponding circle represents.

As a new circle is drawn in response to a new parameter search result, one or more of the displayed circles may be resized in relation to the relative number of results for each parameter. Each circle may have a minimum size, such as 20% of the maximum size, for ease of visibility for the user in the event that a parameter selection is significantly greater or smaller than an earlier parameter selection. Each circle may be positioned in such a way as to overlap the other circles to represent an intersection of the results for the group of results that match each of the parameter choices represented by each overlapped circle. The amount of intersection overlap may be proportional to the number of items represented, with a minimum overlap, such as 20% of the circle size. Each overlapping portion may be given a unique color. The size and position of each circle may be calculated based on the number of results represented by each circle and the number of results that meet the criteria represented by more than one circle. Lines may be drawn from the overlapped area to text which indicates the number of items represented by that overlapped area. The result can look like a Venn diagram.

As circles are displayed to the user, they can be resized, or morphed, to more accurately represent the relative number of matches for each parameter choice or parameter represented by the corresponding circle.

In another embodiment of the invention, the circles are drawn and displayed to the user after the two or more parameter choices have been selected.

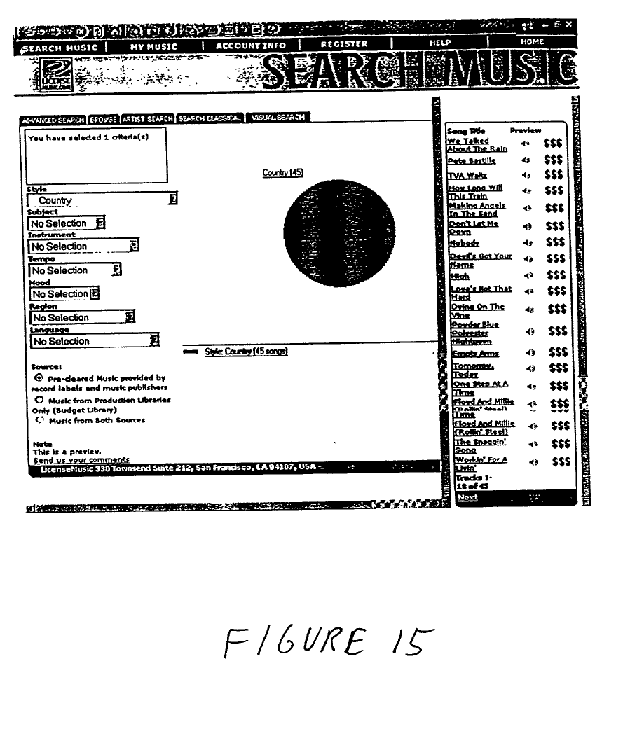

The user can select any of the parameters first by clicking or selecting the arrow associated with the parameter. Referring to FIG. 15, when the user selects a first parameter, such as STYLE, a drop-down list of choices appears. The user can click or select any choice in the drop-down list, such as, for example, “COUNTRY.” When a first parameter choice is selected, such as “COUNTRY,” an orange colored circle, for example, visually appears on the screen representing the matches for the first parameter choice. In another embodiment of the invention, visual representations of parameter choices are displayed only after two or more parameter choices are received.

The server searches the associated database to find the number of songs that match the first parameter choice. In FIG. 15, 45 songs match the COUNTRY parameter choice for style.

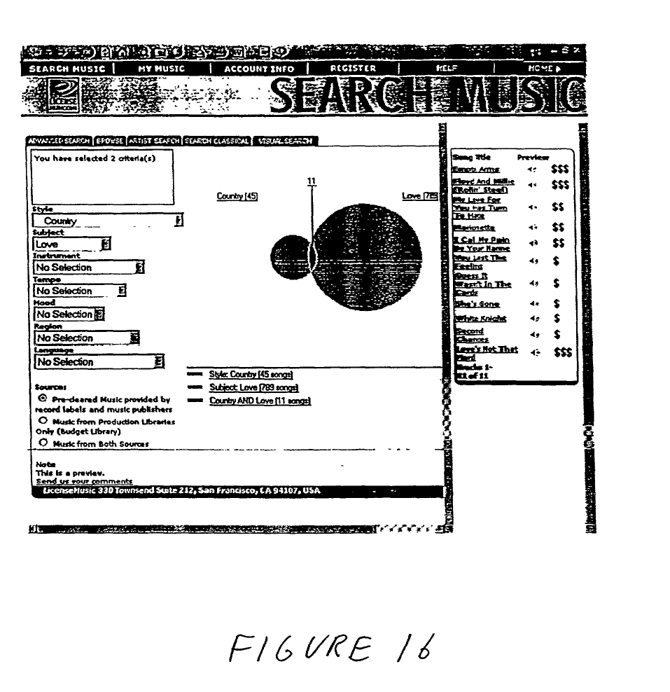

Referring to FIG. 16, the user can select a second parameter, such as SUBJECT, by selecting that parameter. When the user selects the second parameter, a drop-down list of choices appears. The user can click or select any choice in the drop-down list, such as “LOVE.” When a second parameter choice is selected, the server searches the associated database to find the number of songs that match the parameter choice. In FIG. 16, 789 songs with the subject LOVE are found in the database. A green colored circle, for example, visually appears on the screen representing the matches for the second parameter choice, LOVE.

The server also analyzes the number of songs that matches both the first parameter choice and the second parameter choice. In FIG. 16, 11 songs match both the first parameter choice, COUNTRY, and the second parameter choice, LOVE. Moreover, the red circle representing the first parameter choice is visually resized to give the user an approximate representation of the relative number of matches of the first parameter choice versus the second parameter choice.

In this example, the second parameter choice LOVE has more matches than first parameter choice COUNTRY, so the red circle representing COUNTRY can be proportionately resized to be a smaller circle than the green circle representing LOVE. The proportionate resizing can be subject to minimum and maximum circle sizes, and/or limitations with regards to areas of intersection or overlap size.

The two circles representing the two parameter choices are drawn in a Venn diagram format, such that an area of intersection that matches both parameters is displayed. In FIG. 16, 11 songs match both COUNTRY and LOVE. The area of intersection may be colored to be an intermediate color between the colors of the first two circles, e.g., in FIG. 16, a bluish color.

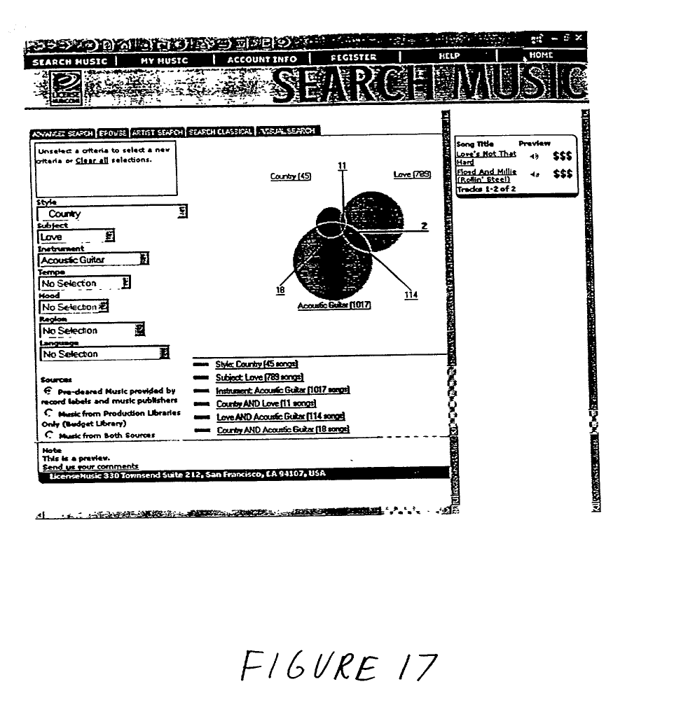

Referring to FIG. 17, the user can select a third parameter, such as INSTRUMENT. When the user selects the third parameter, a drop-down list of choices appears. The user can click or select any choice in the drop-down list, such as ACOUSTIC GUITAR. When a third parameter choice is selected, the server searches the associated database to find the number of songs that match the third parameter choice. As shown in FIG. 17, 1017 songs with a ACOUSTIC GUITAR instrument are found in the database. A purple circle visually appears on the screen representing the matches for the third parameter choice, ACOUSTIC GUITAR.

The server also analyzes the number of songs that match both the second and third parameter choices, LOVE and ACOUSTIC GUITAR. As shown in FIG. 17, 114 songs match both LOVE and ACOUSTIC GUITAR.

The server also analyzes the number of songs that match both the first and third parameter choices, COUNTRY and ACOUSTIC GUITAR. As shown in FIG. 17, 18 songs match COUNTRY and ACOUSTIC GUITAR.

The server also analyzes the number of songs that match all of the first, second, and third parameter choices. As shown in FIG. 17, 2 songs match COUNTRY, LOVE, and ACOUSTIC GUITAR. This intersection of the three circles is designated by a boldfaced number “2.”

The red circle representing the first parameter choice and the blue circle representing the second parameter choice can be visually re-sized to give the user an accurate representation of the relative number of matches of the first parameter choice proportionate to the second parameter choice, and proportionate to the third parameter choice. The resizing can be subject to minimum and maximum size and proportion limitations. The resizing can take the form of two or more visual changes to the user, so that the user sees one or more circles “growing” and one or more circles “shrinking” until desired sizes are reached for the circles.

In FIG. 17, ACOUSTIC GUITAR has 1017 matches, versus 789 matches for LOVE, and 45 matches for COUNTRY. The orange circle representing COUNTRY is re-sized to be the smallest circle. The green circle representing LOVE is re-sized to be a larger circle than the orange circle. The purple circle representing ACOUSTIC GUITAR is sized or resized to be the largest circle of the three circles.

Referring again to FIG. 17, the three circles may be drawn in a Venn Diagram format, such that areas of intersection represent matches for all of the corresponding parameter choices. Each area of intersection between circles may also be visually colored to be an intermediate color between the intersected circles, such as red for the intersection between the orange circle and the purple circle, and blue for the intersection between the green circle and the purple circle.

Referring again to FIG. 17, link COUNTRY (45), which is for example a hypertext link, and link STYLE: COUNTRY (45 songs) are created by the Java applet so that the user may click or select either of them to be shown a list of media content matching style COUNTRY. This list is shown on the right side of the user's graphical user interface or window, in a preview box. The user may also click anywhere on the orange circle representing COUNTRY (45) to bring up the preview box.

In another embodiment of the invention, clicking or selecting a link can play, stream, or download one or more media files, such as songs.

Links LOVE (789) and SUBJECT: LOVE (789 songs) are created by the Java applet so that the user may click or select either of them to be shown a list of media content matching the subject of LOVE. This list is shown on the right side of the user's graphical user interface or window, in a preview box. The user may also click anywhere on the blue circle representing LOVE (789) to bring up the preview box.

Links ACOUSTIC GUITAR (1017) and INSTRUMENT: ACOUSTIC GUITAR (1017 songs) are created by the Java applet so that the user may click or select either of them to be shown a list of media content matching the instrument ACOUSTIC GUITAR. This list is shown on the right side of the user's graphical user interface or window, in a preview box. The user may also click on the blue circle representing ACOUSTIC GUITAR (1017) to bring up the preview box.

Links COUNTRY AND LOVE (11 songs) and “11” are created by the Java applet so that the user may click or select either of them to be shown a list of media content matching COUNTRY and LOVE. This list is shown on the right side of the user's graphical user interface or window, in a preview box. The user may also click anywhere on the area of intersection between the circles representing COUNTRY AND LOVE to bring up the preview box.

Similarly, links LOVE AND ACOUSTIC GUITAR (114 songs), and COUNTRY AND ACOUSTIC GUITAR (18 songs) are created by the Java applet so that the user may click either of these choices or the areas of intersection of the circles representing these choices. In an embodiment, the Java applet is programmed such that moving a cursor or pointer and clicking in the region of intersection causes the preview box to be displayed.

Referring again to FIG. 17, Links COUNTRY AND LOVE AND ACOUSTIC GUITAR (2 songs) and “2” are created by the Java applet so that the user may click on these links to be shown a preview box and list of media content, in this case two songs, matching COUNTRY, LOVE, and ACOUSTIC GUITAR. Similarly, the user may click on the area of intersection of the three circles or the “2” in order to bring up the preview box.

After a preview box and list has been brought up, the user may click or select any other link or area to display an updated set of corresponding matches in the preview list. The user may also at any time during the process click a link, a circle or an area of intersection, such as in FIG. 15, by clicking COUNTRY (45) or by clicking anywhere in the orange circle representing the matches for style COUNTRY.

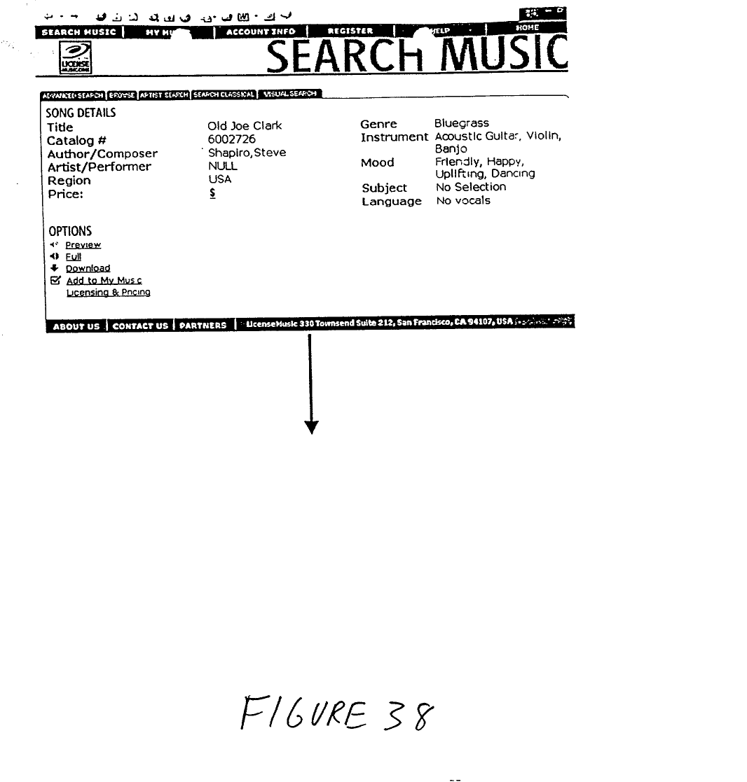

The preview list contains a link associated with each title for all matching media content for the one or more parameter choices selected by the user. The user can select or click any link, circle or area of intersection to obtain further information about the corresponding media content and to proceed towards licensing the corresponding media content, as can be seen by a screenshot such as the one shown in FIG. 38 and described below. In an embodiment, each link may be a text link, a hyperlink, or another type of link.

The user can also select a loudspeaker preview link to download a preview version of the corresponding media content. In an embodiment, this preview version contains the full-length media content for sampling purposes. The user can also choose to download a full length version of the corresponding media content.

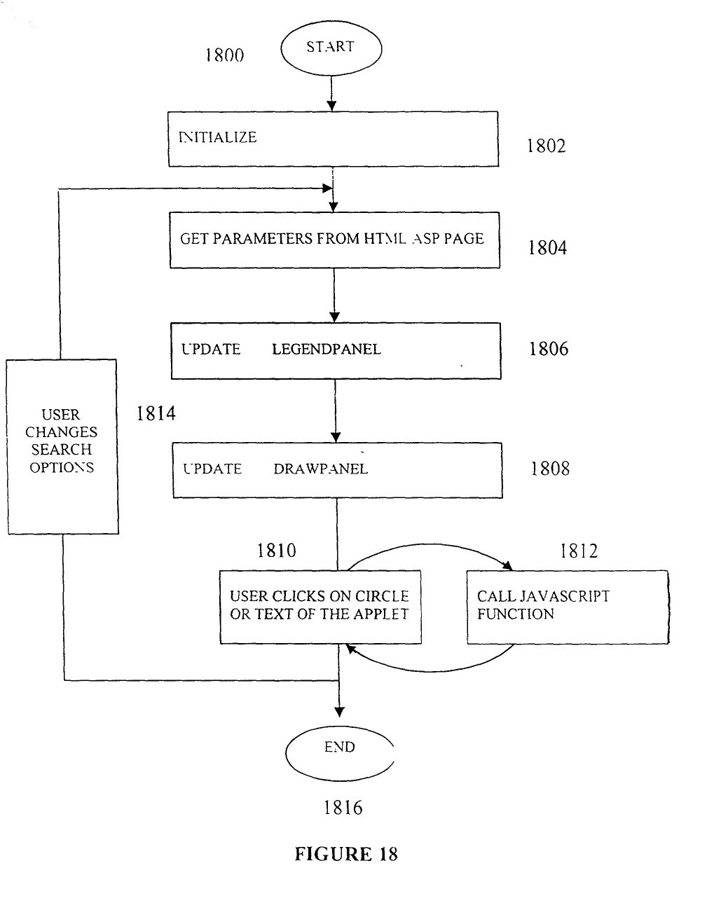

FIGS. 18-25 show flowcharts and algorithms for an embodiment of a visual media search, such as a graphical search engine. An embodiment of the graphical search engine, such as source code programmed in Java, is attached in Appendix A.

Java Applet Embodiment of Graphical Search Engine

In an embodiment of the invention, a Java applet for the graphical search engine has two main display areas, a LEGENDPANEL and a DRAWPANEL. The DRAWPANEL shows the graph of three circles, such as the pictorial portion showing the circles in FIG. 17. The LEGENDPANEL shows a legend for the drawn circles, such as the legend or key that appears below the circles in FIG. 17.

Referring to FIG. 18, step START begins with a standard loading of the application as a user enters a webpage for the graphical search engine, such as the one shown in FIG. 14. In step INITIALIZE (for example, see code lines 113-127 in Appendix A), when the applet is loaded, the applet can initialize. The applet can set its basic values to become ready to run. The applet can create three main components, a MAIN PANEL, the LEGENDPANEL (for example, see code lines 205-209 in Appendix A), and the DRAWPANEL (for example, see code lines 210-214 in Appendix A). The MAIN PANEL may contain the LEGENDPANEL and the DRAWPANEL. All panels at the beginning may be blank and awaiting user input from the HTML/ASP page.

In an embodiment of the invention, in step GET PARAMETERS FROM HTML/ASP PAGE (for example, see code lines 130-167 in Appendix A), the applet takes 7 integers, each one representing a number associated with items matching the search criteria selected by the user, and overlaps/areas of intersection, such as subsets of matches for two or more criteria. There can be, for example, up to 3 search criteria, and up to four overlaps/areas of intersection. For example, if X, Y, and Z are selected as search criteria the applet can require following information:

1. number of items satisfying requirement X,

2. number of items satisfying requirement Y,

3. number of items satisfying requirement Z,

4. number of items satisfying requirements X and Y,

5. number of items satisfying requirements X and Z,

6. number of items satisfying requirements Y and Z,

7. number of items satisfying requirements—X, Y, and Z.

In an embodiment of the invention, the applet can uses text input describing the search criteria, and additional information about the look and feel of the search criteria.

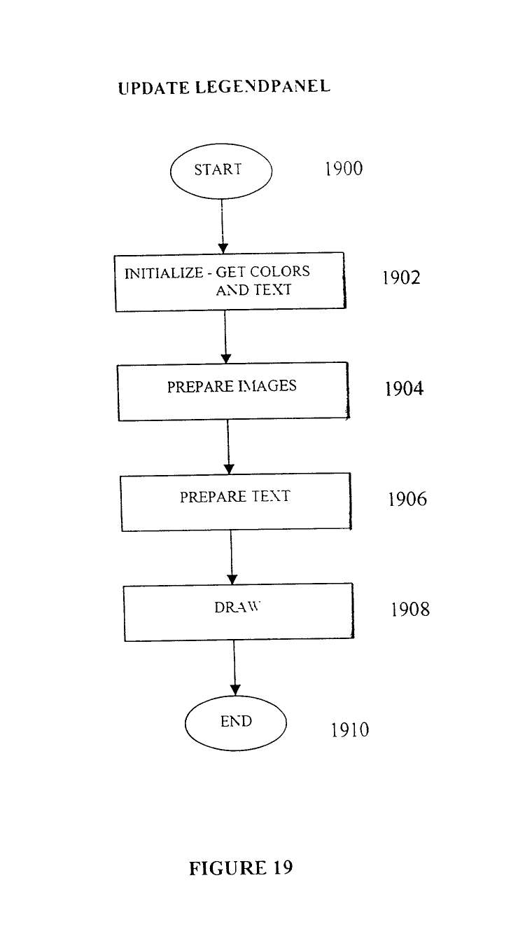

In step UPDATE LEGENDPANEL (for example, see code line 259 in Appendix A), the LegendPanel displays the legend for the graphical representation of a search. For each search result (supplied to the applet in step GET PARAMETERS FROM HTML/ASP PAGE) greater the zero, a row in the legend can be displayed. Each row shows a color sample representing the corresponding area in the graph, number of elements, and short text description of the criteria it represents. An example of a LEGENDPANEL display is shown in FIG. 17. More details about the LEGENDPANEL are shown in FIG. 19.

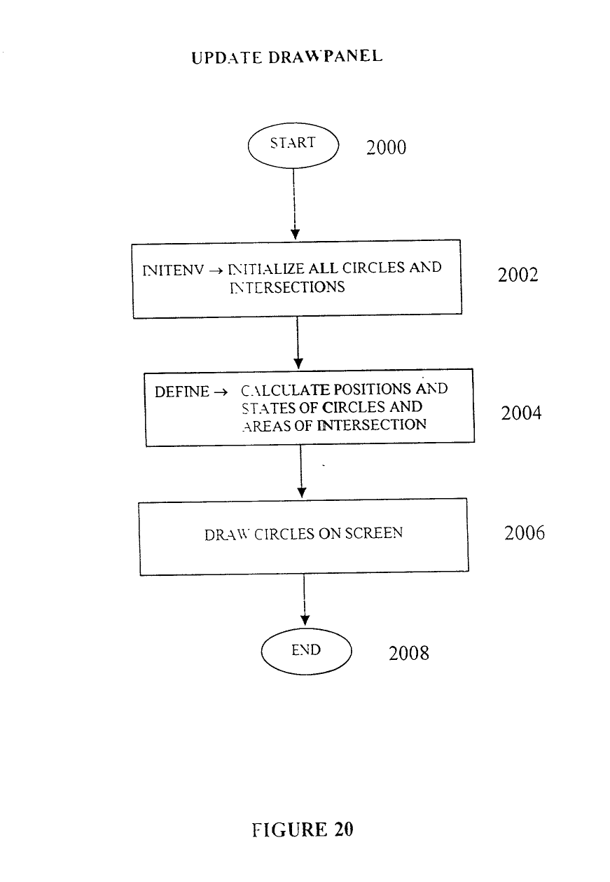

Referring again to FIG. 18, in step UPDATE DRAWPANEL (for example, see code line 260 in Appendix A), the DRAWPANEL displays a main graph, for example, zero to three circles, and their intersections. The sizes of the circles and their intersections are calculated based on the parameters provided in step GET PARAMETERS FROM HTML/ASP PAGE. The surface area of each circle and the area of each intersection are proportional to the number of elements each area represents. Each circle may be a different color. Each intersection area color may be a combination of colors of the circles that form the intersection area. More details on the DRAWPANEL are shown in FIG. 20.

Referring again to FIG. 18, step USER CLICKS ON CIRCLE OR TEXT OF THE APPLET can occur when a user event is detected by the applet. The user event can occur when the user clicks or selects an area in a circle or an intersection, or legend text containing a link. In response to a user event, the applet performs step CALL A JAVASCRIPT FUNCTION (for example, see code lines 238-248 in Appendix A) in the HTML/ASP page to display a list of items represented by the clicked area or text.

In step USER CHANGES SEARCH OPTIONS, which occurs if the user changes or adds search options, the applet loops back to step GET PARAMETERS FROM HTML/ASP PAGE (for example, see code lines 130-167 in Appendix A) and continues to steps UPDATE LEGENDPANEL (for example, see code line 259 in Appendix A) and step UPDATE DRAWPANEL (for example, see code line 260 in Appendix A).

In step END (for example, see code lines 216-220 in Appendix A), the user exits the page, calling a standard exit handling function.

In FIG. 19, a flowchart is shown for an embodiment of an UPDATE LEGENDPANEL function. In step START, the applet calls functions and initializes the LEGENDPANEL after receiving a new set of parameters.

In step INITIALIZE-GET COLORS AND TEXT (for example, see code lines 756-764 in Appendix A), the UPDATE LEGENDPANEL function determines which colors are used by the applet for each drawn circle. In an embodiment, these colors may be determined by the programmer of the applet. The function may also determine new text labels to describe each circle and area of intersection.

In step PREPARE IMAGES (for example, see code lines 824-858 in Appendix A), for each circle and area of intersection displayed by the graphical search engine, the UPDATE LEGENDPANEL function creates a rectangular image showing a sample of the color for that circle or area of intersection. Each rectangle is displayed before a corresponding text label. The color of each area of intersection between circles may be a combination of the colors of the intersecting circles.

In step PREPARE TEXT (for example, see code lines 859-907 in Appendix A), for each circle and area of intersection displayed to the user, the function creates a text label.

In step DRAW (for example, see code line 913 in Appendix A), graphics prepared in step PREPARE IMAGES and step PREPARE TEXT are drawn on the LEGENDPANEL.

In step END, the UPDATE LEGENDPANEL function completes.

In FIG. 20, a detailed flowchart for an UPDATE DRAWPANEL function of an embodiment of the invention is shown.

In step START, when the applet receives a new set of parameters, the applet calls functions updating the DRAWPANEL and the LEGENDPANEL.

In step INITENV (for example, see code lines 1302-1362 in Appendix A), all circles and areas of intersection are initialized by retrieving the values needed to draw the circles, such as a number of matches for the parameter represented by each circle and the number of matches for a combination of multiple parameters represented by each area of intersection between circles.

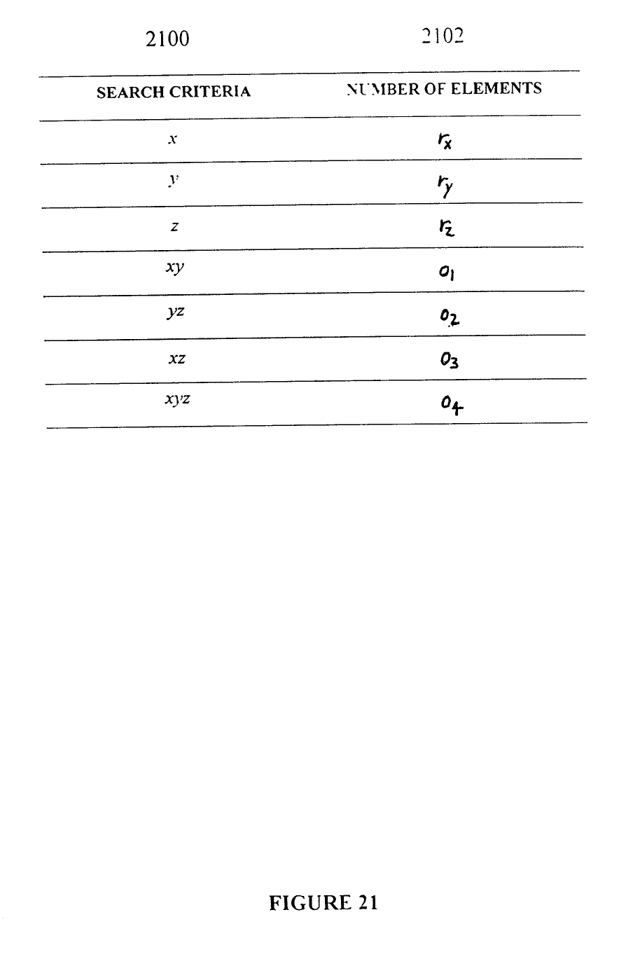

In step DEFINE (for example, see code lines 1363-1544 in Appendix A), the applet prepares images by calculating a size and a position for each circle, including areas of intersection. FIGS. 21-24 show further details for these calculations. In an embodiment of the invention, graphics created in step DEFINE are scaled and centered to fit in the DRAWPANEL (for example, see code lines 1528-1544 in Appendix A) area for display to the user.

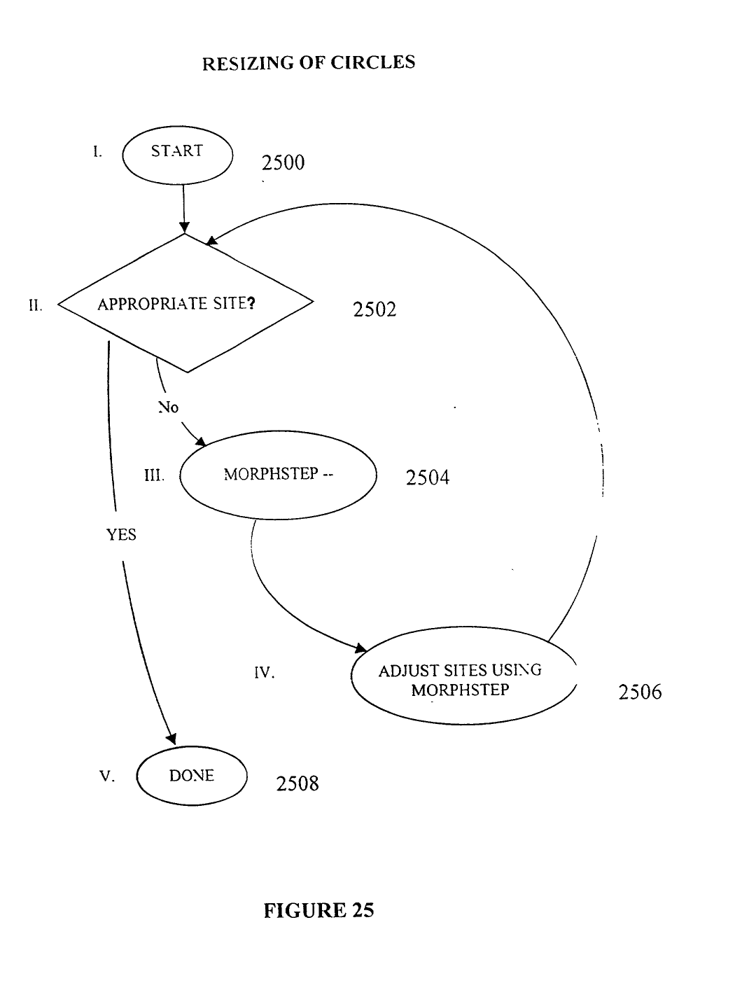

Referring again to FIG. 20, in step DRAW CIRCLES ON SCREEN (for example, see code line 1181 in Appendix A), graphics prepared in step DEFINE are drawn and displayed to the user. The size of the circles may be readjusted gradually and visually resized for display to the user. FIG. 25 describes this resizing in more detail.

Referring again to FIG. 20, in step END, the UPDATE DRAWPANEL function is completed.

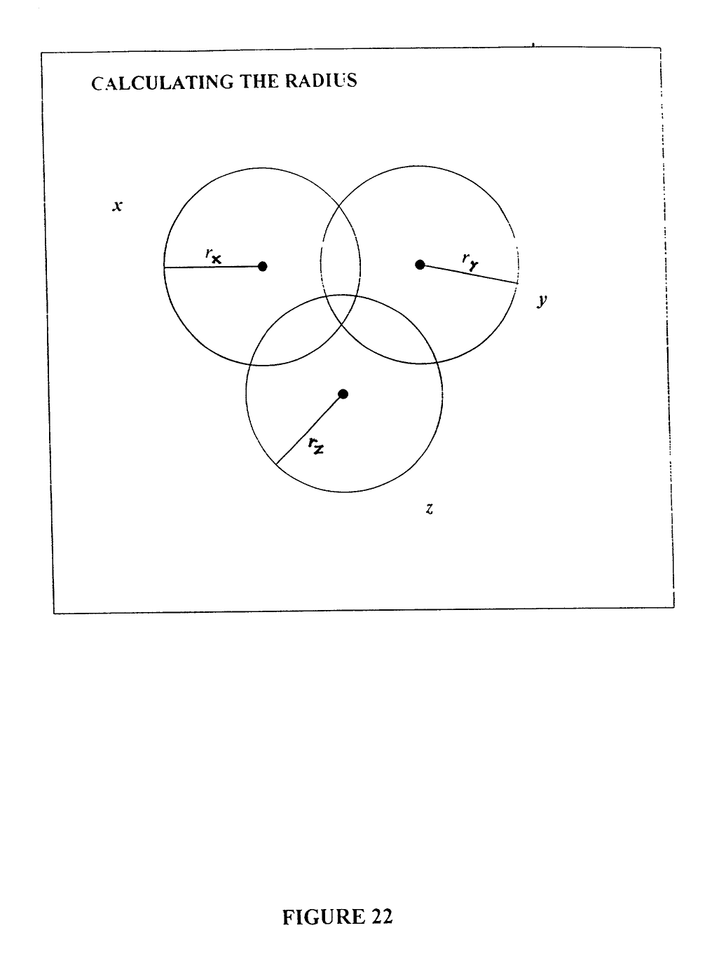

FIG. 21 shows a table of search criteria and corresponding elements that are used in FIGS. 22-24. “x,” “y,” and “z” are search criteria, such as parameters entered by the user using one of the search tools in the invention to find media content. “rₓ,” “r_{y},” and “r_{z}” correspond to the number of matches for each corresponding search criteria. “xy,” “yz,” “xz,” and “xyz” are combinations of search criteria that can be matched by media content. For instance, “xy” is used to find media content having both search criteria “x” and search criteria “y.” “o₁,” “o₂,” “o₃,” and “o₄” correspond to the number of matches for each corresponding combination of parameters, which can be shown as areas of intersection or overlaps between circles in the graphical search engine. “rₓ,” “r_{y}, “r_{z},” “o₁,” “o₂,” o₃,” and “o₄” represent the number of corresponding matches scaled to fit within the DRAWPANEL.

FIG. 22 shows a graphical explanation of a CALCULATING THE RADIUS (for example, see code lines 1376-1404 in Appendix A) function in an embodiment of the invention. The radius of each circle corresponds to the number of elements, from FIG. 21, that match each search criteria. For example, if search criteria “x” has more matches than search criteria “y,” then the rₓ will be larger than r_{y}, and the circle representing search criteria “x” will be larger than the circle representing search criteria “y.”

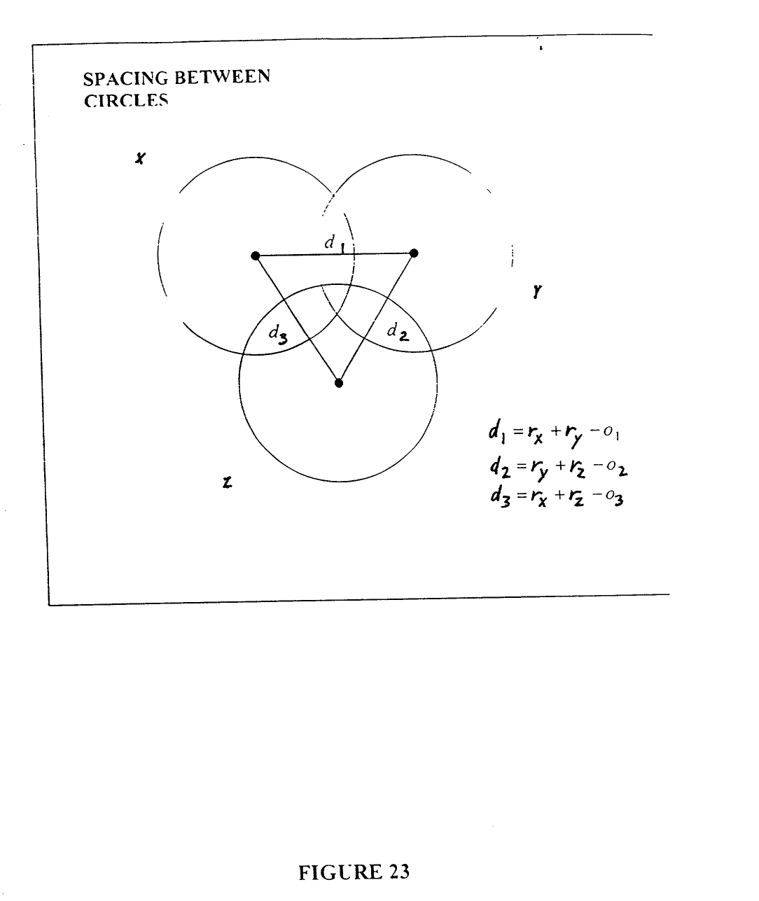

FIG. 23 shows a graphical explanation of SPACING BETWEEN CIRCLES (for example, see code lines 1405-1408 in Appendix A). “d₁, ” “d₂,” and “d₃” are the distances between the centers of each of the circles. “o₁,” “o₂,” and “o₃” correspond to the number of matches for each corresponding combination of parameters, which can be shown as areas of intersection or overlaps between circles in the graphical search engine. “x,” “y,” and “z” are search criteria, such as parameters entered by the user using one of the search tools in the invention to find media content. “rₓ,” “r_{y},” and “r_{z}” correspond to the number of matches for each corresponding search criteria. The equations for “d₁,” “d₂,” and “d₃” show that the distance between centers of the circles is the sum of their radii minus the overlap between the circles. For example, the overlap between circles “x” and “y” is represented by “o₁,” and can be, for example, a number of media content files containing both search criteria “x” and search criteria “y.”

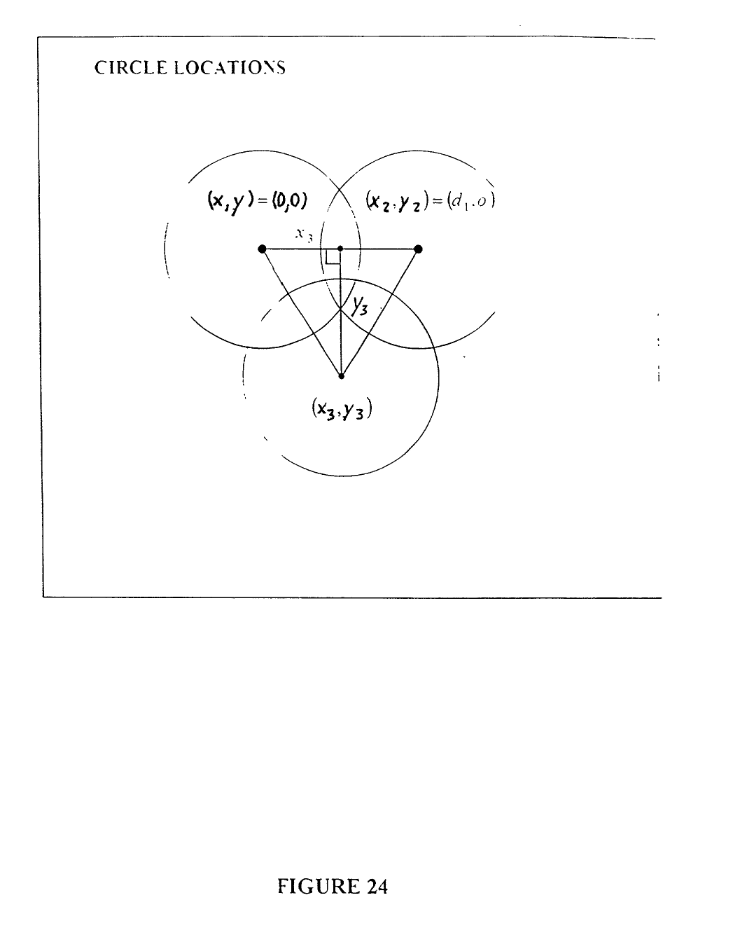

FIG. 24 shows a graphical explanation of a CIRCLE LOCATIONS (for example, see code lines 1405-1444 in Appendix A) function, which shows how circles drawn by the graphical search engine can be positioned for display to the user. The center of the first circle may be positioned at point (0, 0). The center of the second circle is positioned at point (0+d₁, 0), where d₁ is the distance between the centers of the circles calculated from FIG. 23.

Referring again to FIG. 24, to calculate the coordinates of the third circle (for example, see code lines 1421-1444 in Appendix A), the following formulas can be used:

$$\begin{matrix}{x}_{3} = \frac{{d}_{2}^{2} - {d}_{3}^{2} - {d}_{1}^{2}}{{x}_{1} - {x}_{2}} / 2 \\ {y}_{3} = {d}_{3}^{2} - {( {x}_{3} - {x}_{1} )}^{2}\end{matrix}$$

FIG. 25 (for example, see code lines 1079-1125 in Appendix A) shows an exemplary flowchart for an embodiment for RESIZING OF CIRCLES function, which can resize circles for visual display to the user. In an embodiment, circles may be resized when the user selects a new search criteria or parameter choice. Resizing of circles can occur so that a new search result or parameter choice may be gradually shown to the user, instead of a sudden switch from one graph to another. Resizing of circles can appear to the user to be circles growing and/or shrinking in appearance. In an embodiment of the invention, in step START 2500, a DRAWPANEL function calls for a redisplay of graphics.

In step APPROPRIATE SIZE? 2502 (for example, see code lines 1096-1104 in Appendix A), the RESIZING OF CIRCLES function checks to see if the sizes of circles and areas of intersection between circles, or overlaps, are of the appropriate size, for example if current radii for the circles are already the correct size. In an embodiment of the invention, RESIZING OF CIRCLES can use the equations described in the CALCULATING THE RADIUS function in FIG. 22. If APPROPRIATE SIZE? 2502 returns a “no,” then step MORPHSTEP 2504 is invoked.

In step MORPHSTEP 2504, the circles may be visually moved, enlarged, and shrunk for visual effect until the exact search result counts are returned to the webpage, which may be accomplished using, for example, a Javascript object. The system or applet may then paint the actual circles for the user. In an embodiment, the randomizer morphing may contain the following code:

//variable declaration

RAD2DEG=57.295779551; //constant for converting from radiant to degree

radiusC1=0; //initial radius circle 1

radiusC2=0; //initial radius circle 2

radiusC3=0; //initial radius circle 3

oscillStep=0; // the steps between morphing stages

//In an embodiment, this block gets called until the applet receives the song number count from

//the webpage or system. In an embodiment, this may be a loop, in which every time it is executed, it

//takes values from the previous loop.

r1=radiusC1;

r2=radiusC2;

r3=radiusC3;

oscillStep=(oscillStep+1) % 360

radiusC1=r1*(1+0.2*SIN((0+3*oscillStep)/RAD2DEG));

radiusC2=r2*(1+0.2*SIN((240+3*oscillStep)/RAD2DEG));

radiusC3=r3*(1+0.2*SIN((120+3*oscillStep)/RAD2DEG));

//In an embodiment, once the applet obtains the actual count of the media files or songs,

//the circles morph from the present (randomly generated) radius

//to the actual desired size of the circle, depending on the value.

In an embodiment, in step ADJUST SITES USING MORPHSTEP 2506, the sizes of circles are adjusted to obtain the correct sizing.

For example, to find the radius of a first circle, the following equation can be used:

$${r}_{new} = \frac{{r}_{current} \cdot ( MorphStep - 1 ) + {r}_{final}}{MorphStep}$$

When the APPROPRIATE SIZE? 2502 returns a “yes,” meaning that the appropriate size has been reached for all circles, the RESIZING OF CIRCLES function completes at step DONE 2508.

Graphical Search Engine Java Applet

In an embodiment of the invention, a graphical search engine or a search engine that conveys search results graphically, such as embodied in the source code in Appendix A, may be structured as follows:

In an exemplary embodiment, the Java applet may run on the client-side to display the colored circles and capture user clicks, using client-side JavaScript to control the UI elements on the page; client-side Java applet and server-side scripting may be used to send and retrieve data required to perform the queries to a media content database.

The applet may draw up to three or more circles in different colors and sizes, in a form that resembles a Venn Diagram. Each circle may represent a set of elements, such as a set of parameter choice matches.

After the circles are drawn, the applet can record, accept user clicks, which can represent parameter choices, search criteria choices, and/or requests for data, to determine which “set” or overlap the user wishes to view. The applet may then display a list of songs in another frame in the browser, such as in the form of a preview list at the right side of the screenshots in FIGS. 14-17.

Overlap, or areas of intersection, between circle areas may be defined by a number of elements common to each “set,” or circle. The applet can read an array with, for example, 10 values to determine how the circles maybe drawn.

An exemplary array (broken into two lines in this example) showing exemplary data passed back from a server-side script, appears as follows:

| [chemical structure] | [chemical structure] | [chemical structure] | [chemical structure] | [chemical structure] | [chemical structure] |
|---|---|---|---|---|---|
| 1 | 232 | 2 | 89 | 4 | 66 |
| [chemical structure] | [chemical structure] | [chemical structure] | [chemical structure] | | |
| 17 | 5 | 2 | 1 | | |

In an embodiment, information for an example array may also be shown as follows:

| | | | | |
|---|---|---|---|---|
| Circle | Selector | Total songs | 2 way | 3-way |

| | | | | |
|---|---|---|---|---|
| | 1 | 1 | 232 | 17 |
| (1-2) | 1 | | | |
| | 2 | 2 | 89 | |
| | 5 (2-3) | | | |
| | 3 | 4 | 66 | |
| | 2 (3-1) | | | |

In the above examples, selector 1 may correspond to circle 1, which is associated with 232 matches for a first parameter choice. In this example, a user has chosen selector 1, such as Style, as a first parameter choice. Selector 2 may correspond to circle 2, which is associated with 89 matches for a second parameter choice. Selector 4 may correspond to circle 3, which is associated with 66 matches for a third parameter choice. There are 17 items, such as media content files, that match both the first parameter choice and the second parameter choice. These 17 items may be graphically represented by an area of intersection between circles 1 and 2. There are 5 items that match both the second parameter choice and the third parameter choice. These 5 items may be graphically represented by an area of intersection between circles 2 and 3. There are 2 items that match the first and third parameter choices, and these items may be graphically represented by an area of intersection between circles 1 and 3. There are 3 items that match the first, second, and third parameter choices, and these items may be graphically represented by an area of intersection between circles 1, 2, and 3.

An exemplary color scheme for parameters and/or parameter choices in a graphical search engine or graphical display tool of the present invention appears as follows:

| [chemical structure] | [chemical structure] | [chemical structure] |
|---|---|---|
| 1 | Style | Blue |
| 2 | Keywords | Red |
| 3 | Instrument | |
| 4 | Tempo | Green |
| 5 | Attitude | Violet |
| 6 | Country | Brown |
| 7 | Language | White |
| 8 | Price | Black |

The exemplary 8 selectors above represent 8 possible parameter choices that a user at a client may select. If, for example, the user selects a style choice as a first parameter choice, then the first graphical circle representing the selector is blue. As previously described, in an embodiment of the graphical search engine display, areas of intersection between circles may be an intermediate color between the colors of the two circles. For example, if a user selects a style choice as a first parameter choice and a keyword choice as a second parameter choice, the area of intersection between the two circles that represents item matches for both parameter choices may be purple.

Drawing mathematics and scaling functions for the Java applet may be exemplified by four drawing algorithms that draw the circles on an (x,y) coordinate plane to correctly reflect the result sets and areas of intersection. Summaries of exemplary functions that may be used by the Java applet are as follows (see the exemplary source code in Appendix A for more details):

A first exemplary function that the Java applet may use is a scaling function. The scaling function may provide proper scaling of circles so that no matter how large or small a result set, a corresponding circle remains displayed in a visible manner. The scaling function may take the size of the largest circle out of the one to three or more circles to determine and draw an (x, y) scale.

A second exemplary function that can be used by the Java applet is a DrawCircle function. The DrawCircle function may be a main function that draws a third circle next to any two existing circles, or that draws a second circle next to a first circle. For example, when drawing three circles, there may be overlap (representing common elements) between the 1^{st} and 2^{nd} only, 1^{st} and 3^{rd} only, 2^{nd} and 3^{rd} only or all three. The DrawCircle function can be passed the size of each circle, and the amount of overlap of each, and plot the three circles on an (x, y) plane.

A third exemplary function that can be used by the Java applet is a Midpoint function. The Midpoint function may be a common function in plane geometry used to find a midpoint in coordinate terms, of any two points on an (x, y) plane. The Midpoint function may be used to draw tags or captions, for example showing the values for each circle, in proper locations.

A fourth exemplary function that can be used by the Java applet is a Distance function. The Distance function may be a common formula used in geometry, for example to find the “distance” between any two points on an (x, y) plane.

Another exemplary function that can be used by the Java applet may be a pen masking and merging function. The pen masking and merging function can be used to correctly draw colors of overlapping and/or areas of intersection for any two or more circles. When any two or more circles are drawn to have some overlap or areas of intersection, the overlapping or area of intersection is colored by “adding” or combining the two colors together. This adding or combining may be handled internally by the Java applet through a DrawMode function, which can apply to objects in a graphics class.

In another embodiment of the invention, the system uses XML to perform the objectives of the invention. Appendix B shows exemplary source code for an XML embodiment of the invention, including *.ASP files containing the functionality of the invention and a custom XML parser, followed by all relevant *.INC files and *.XML files. In an embodiment, the XML separates the functionality of a webpage from its visual output (e.g., design and/or layout). Each piece of code in Appendix B reads or parses .xml design documents and applies the design to the functionality. In an embodiment, implementation of the XML technology allows for multiple designs having the same functionality. In an embodiment, the functionality of each set of *.ASP pages may remain the same with the application of different XML templates.

An exemplary *.XML design template may contain specific XML Tags having specific functionalities. Exemplary XML Tags include the following:

<!--FORM_START-->

<!--PRICE-->

<!--FORM_END-->

<!--FRAME_PRICE_WINDOW-->

<!--FRAME_MAIN_WINDOW-->

<!--JAVASCRIPT-->

<!--PROJECT_INFO-->

In an embodiment, when a user requests a *.ASP page, the entire XML template is loaded and replaces all XML Tags with actual code representing the needed functionality. For example the XML Tag

<!--FORM_START-->

may be replaced with the code

<form method=“post” target=“pricewindow”

action=“pricewindow.asp?partner=placebo&iSelectedTrackID=22&iProjectI

D=10&nT

rackFactor=1.5&btnModel=2”>

Search Parameters

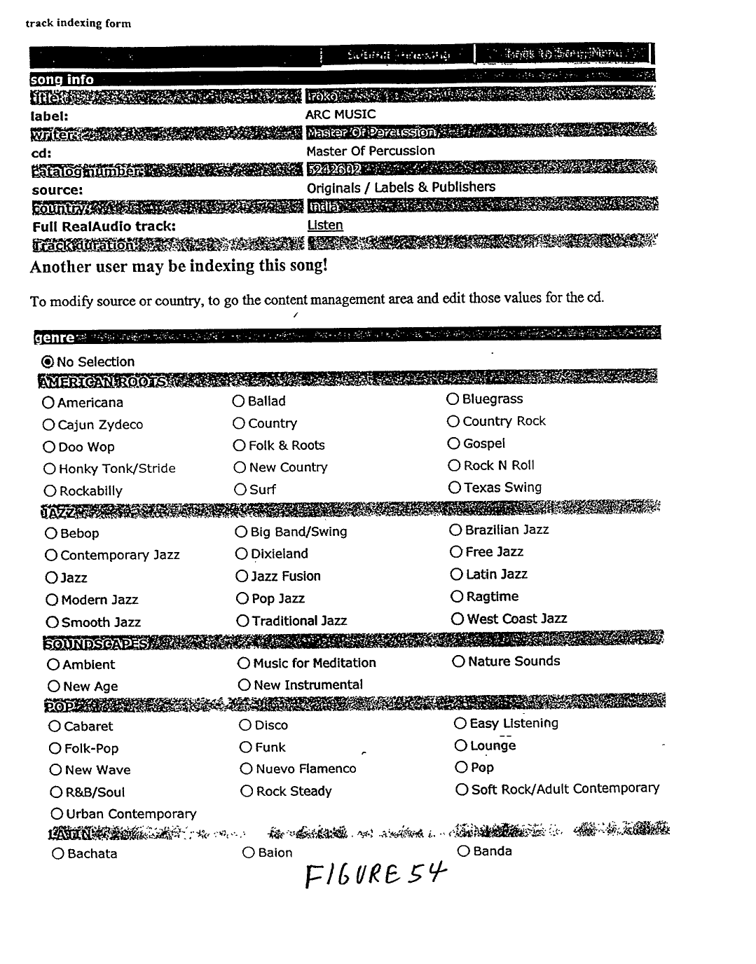

FIGS. 54-65 show an embodiment of choices for some parameters by which a user may search using one or more of the search tools in the invention.

Referring to FIG. 54, an embodiment is shown for a screenshot of a first page of a TRACK INDEXING FORM for a song and the parameter choices that match the song. A database manager for the invention or another person may use the TRACK INDEXING FORM to input characteristics or parameters for each song. The database manager or person inputting parameters can listen to the song or to part of the song by clicking or selecting LISTEN. When the database manager or person has finished inputting or wishes to save any changes made, she may click or select SUBMIT INDEXING.

Characteristics or parameters for a song that are listed in the TRACK INDEXING FORM may be used to match parameter choices made by a user searching for music or other media content through one of the search tools of the invention. Each song may have multiple entries for each parameter. These parameters can include GENRE, REGION, MOOD, STYLE, INSTRUMENT, TEMPO, TRACK LENGTH, ORIGINAL RELEASE YEAR, VOCAL MIX, LANGUAGE, SUBJECT, and KEY.

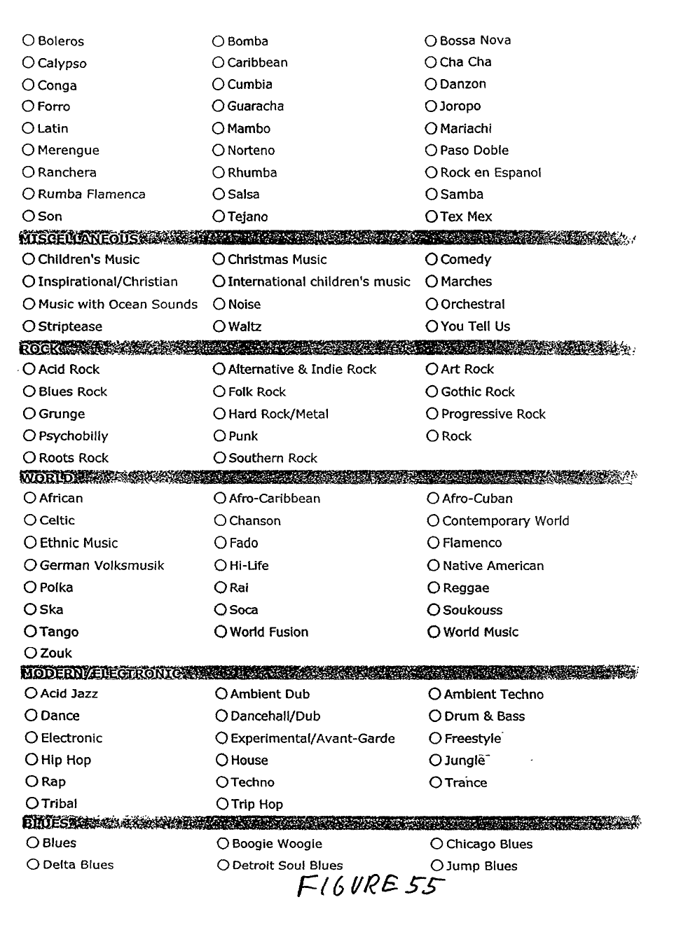

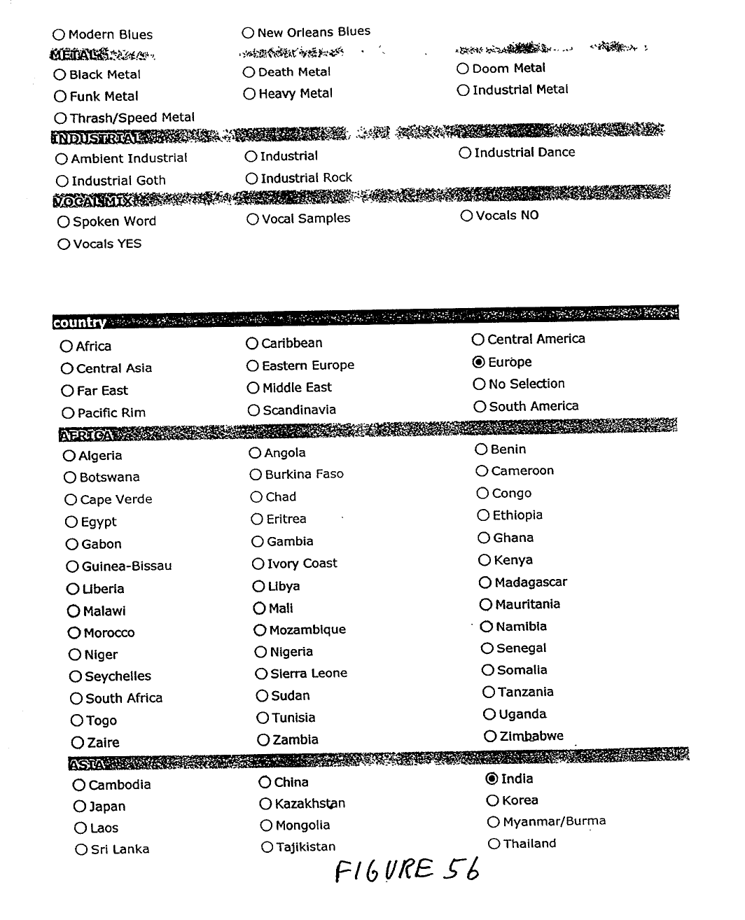

GENRE can include AMERICAN ROOTS, JAZZ, SOUNDSCAPES, POP, AND LATIN, as shown in FIG. 54. Other GENRE parameter choices include MISCELLANEOUS, ROCK, WORLD, MODERN/ELECTRONIC, and BLUES, as shown in FIG. 55, and METAL, INDUSTRIAL, AND VOCAL MIX, as shown in FIG. 56.

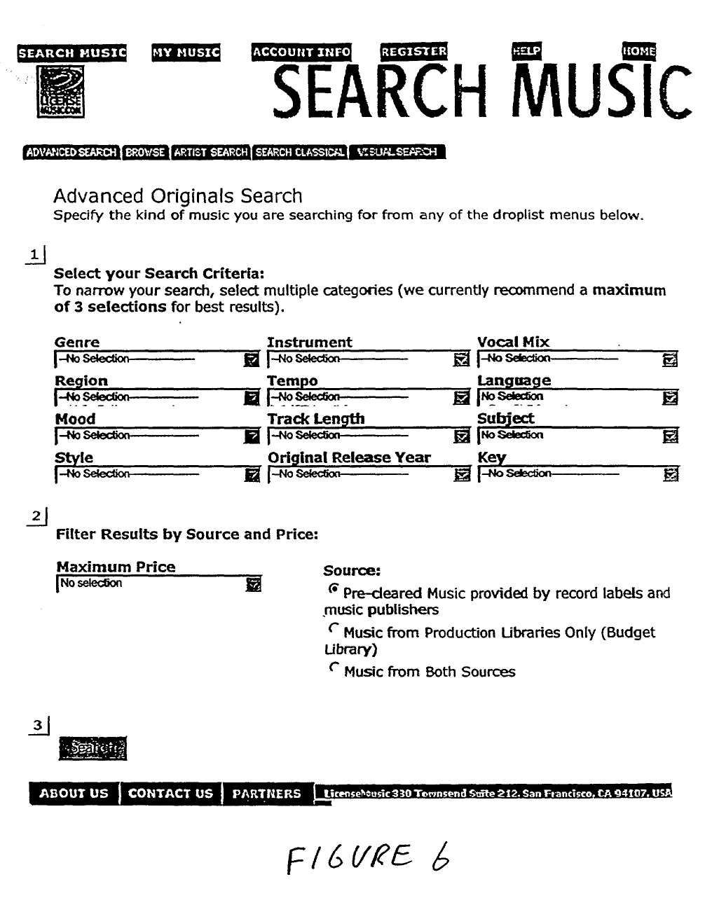

Referring to FIG. 54, the GENRE for a song is used to match STYLE parameter choices selected by a user, such as in ADVANCED SEARCH screen in FIG. 6 and for the other search tools in the invention. Each parameter choice, such as AMERICAN ROOTS, is further divided into additional categories, such as AMERICANA, BALLAD, BLUEGRASS, CAJUN ZYDECO, and other categories as shown in FIG. 54.

If a user selects a parameter choice such as AMERICAN ROOTS, all songs having one or more of the AMERICAN ROOTS categories, such as AMERICANA or BALLAD, is returned by the server as a match.

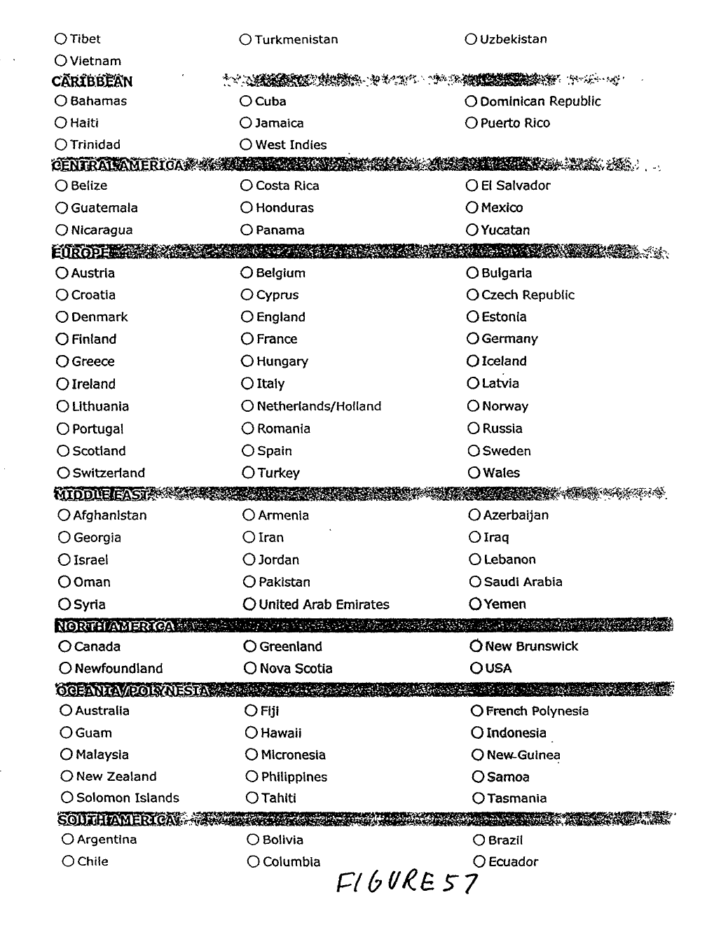

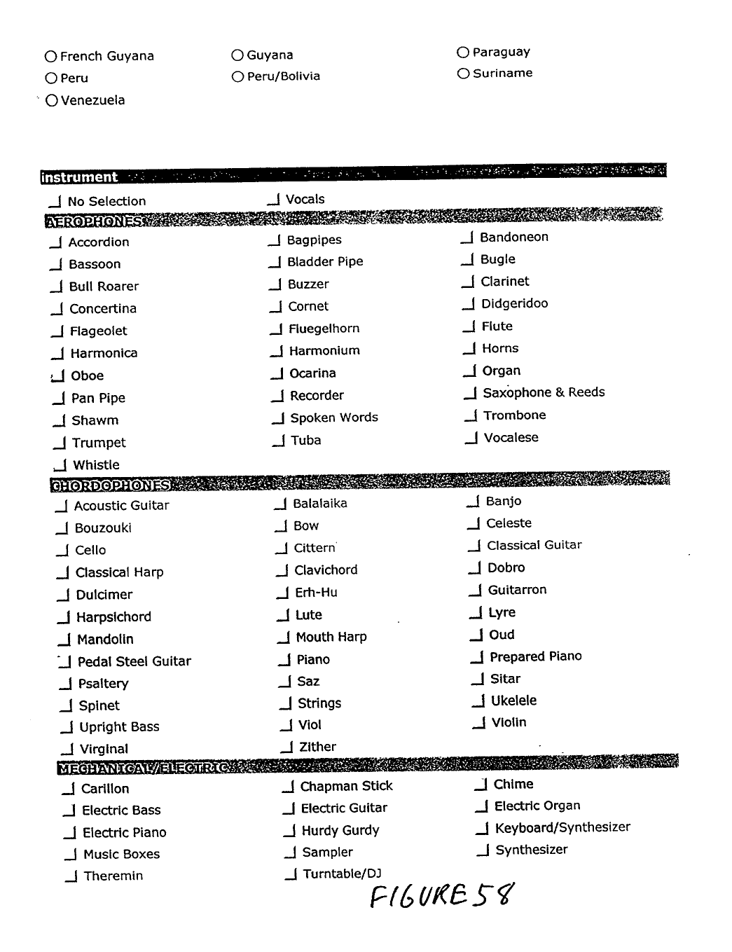

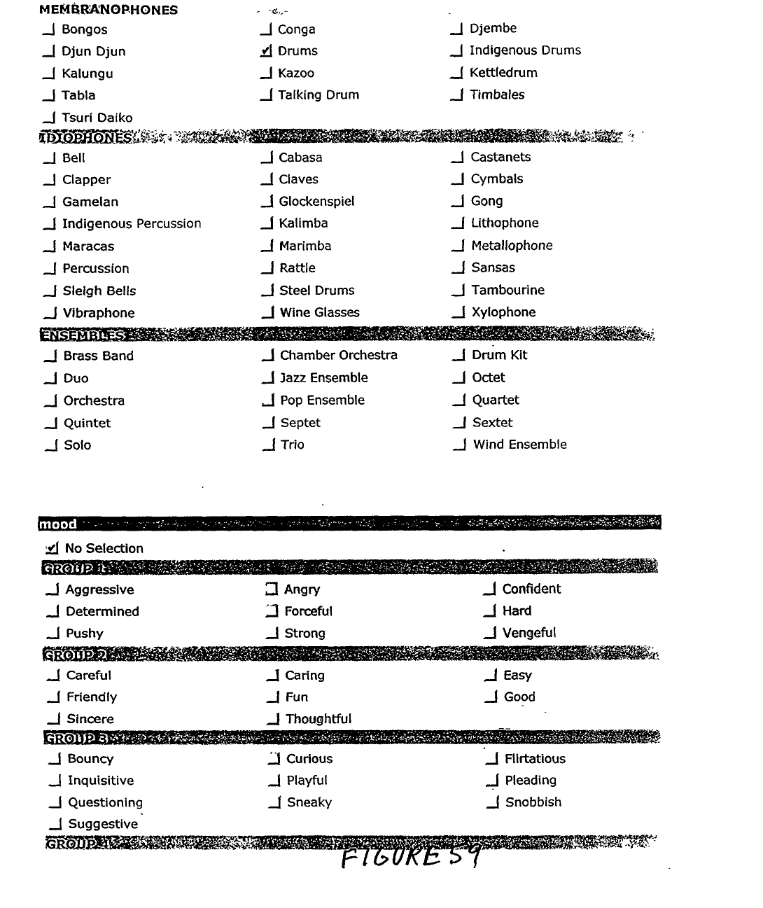

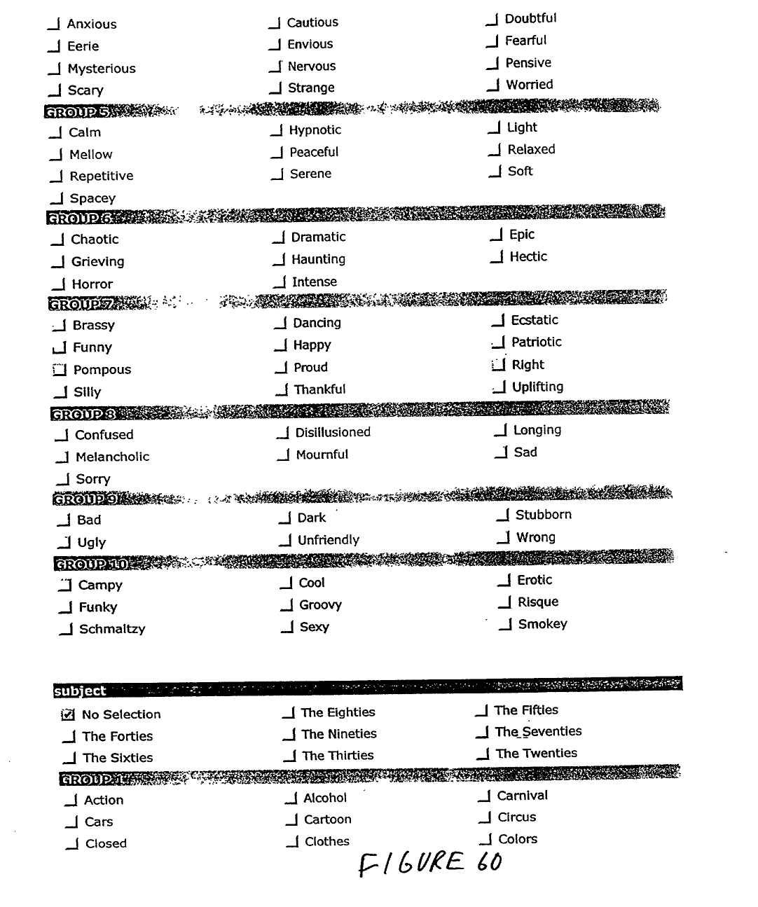

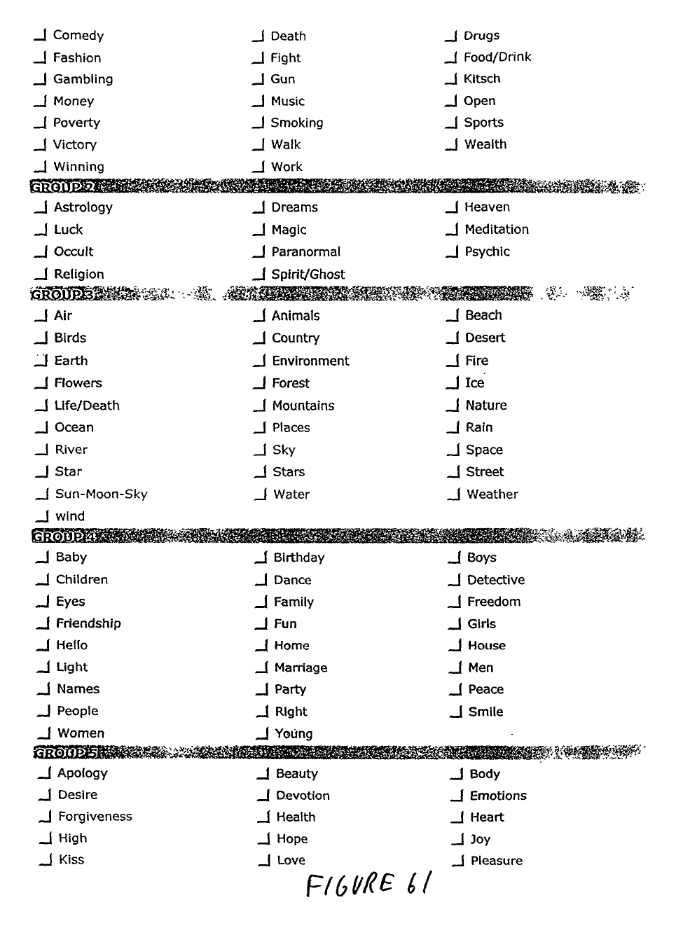

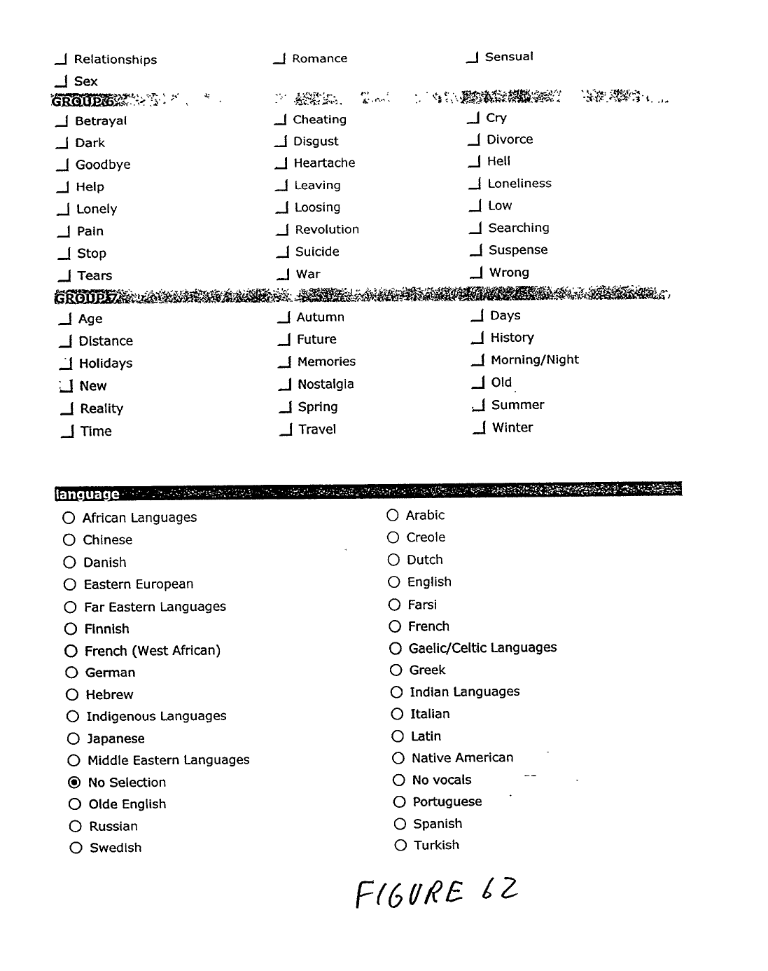

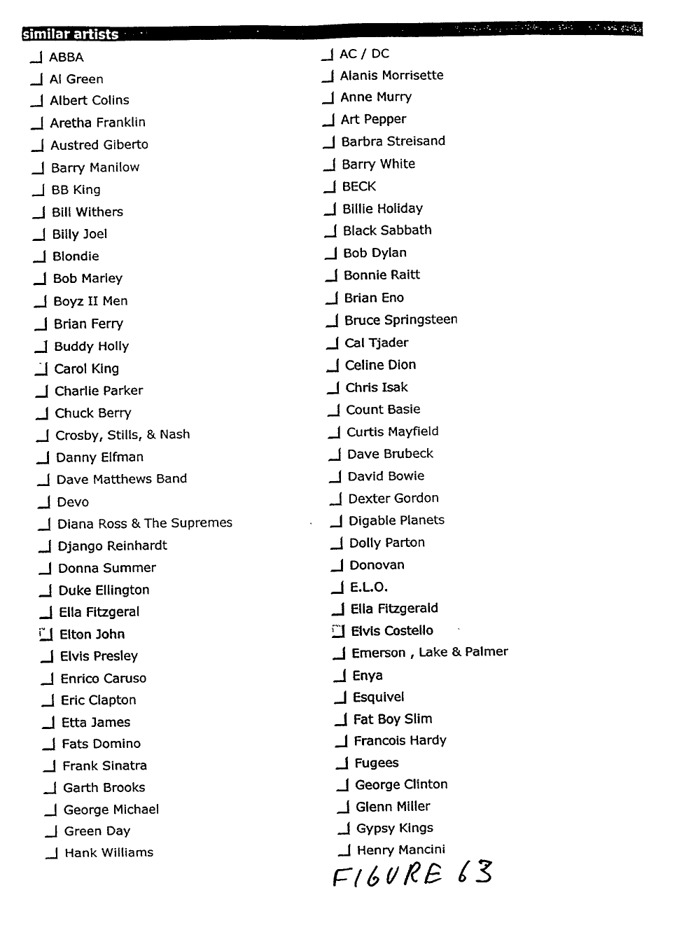

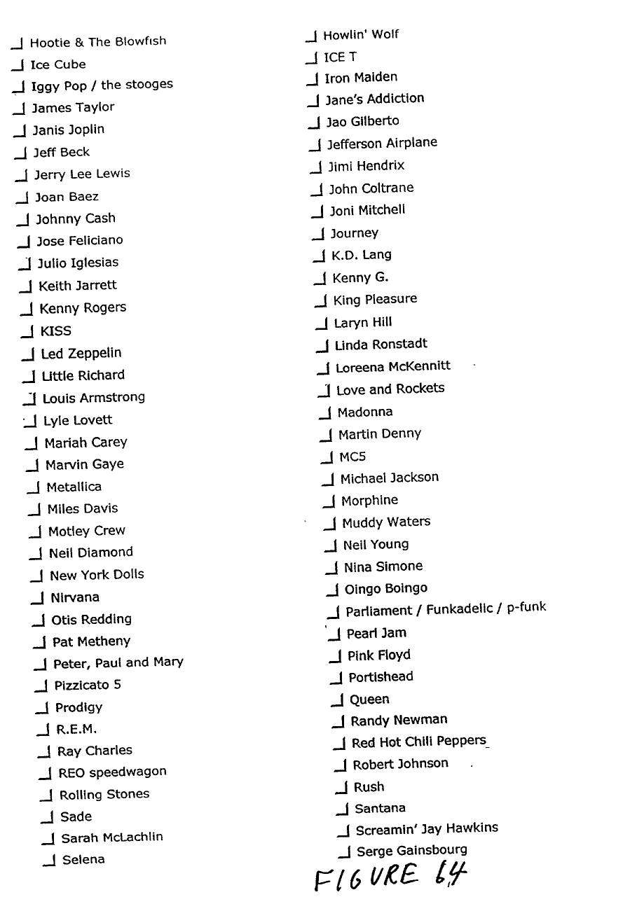

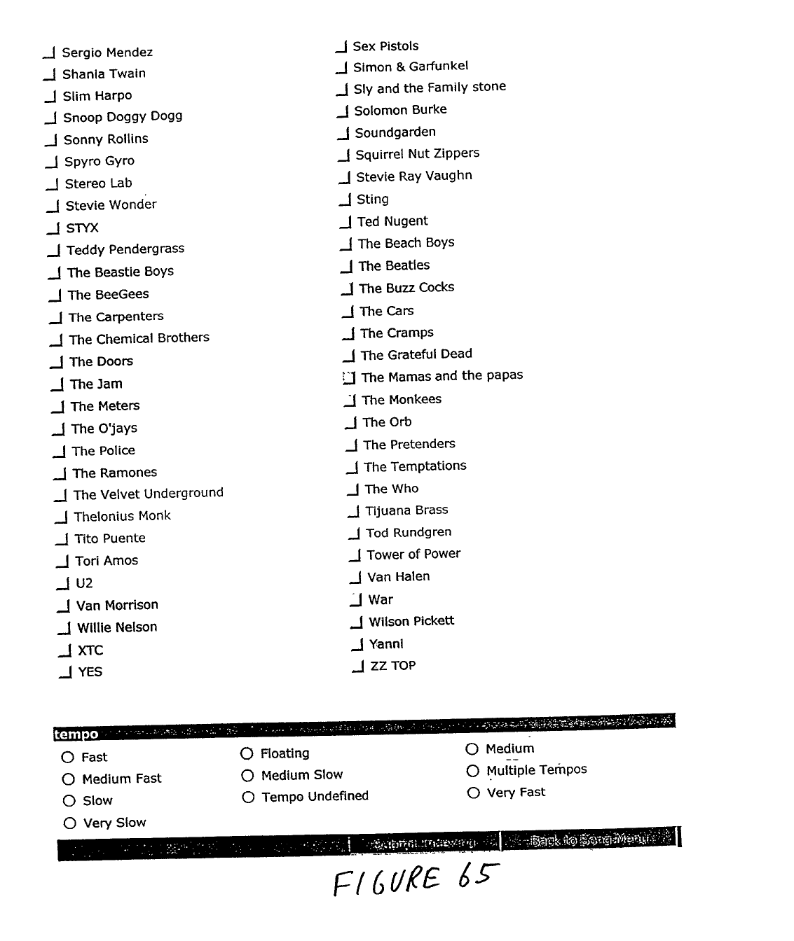

Referring to FIG. 55, an embodiment is shown for a screenshot of a second page of a track indexing form for a song and the parameter choices for GENRE that match the song. Referring to FIG. 56, an embodiment is shown for a screenshot of a third page of a track indexing form for a song and the parameter choices for GENRE and COUNTRY that match the song. Referring to FIG. 57, an embodiment is shown for a screenshot of a fourth page of a track indexing form for a song and the parameter choices for COUNTRY that match the song. Referring to FIG. 58, an embodiment is shown for a screenshot of a fifth page of a track indexing form for a song and the parameter choices for INSTRUMENT that match the song. Referring to FIG. 59, an embodiment is shown for a screenshot of a sixth page of a track indexing form for a song and the parameter choices for INSTRUMENT and MOOD that match the song. Referring to FIG. 60, an embodiment is shown for a screenshot of a seventh page of a track indexing form for a song and the parameter choices for MOOD and SUBJECT that match the song. Referring to FIG. 61, an embodiment is shown for a screenshot of a eighth page of a track indexing form for a song and the parameter choices for SUBJECT that match the song. Referring to FIG. 62, an embodiment is shown for a screenshot of a ninth page of a track indexing form for a song and the parameter choices for SUBJECT and LANGUAGE that match the song. Referring to FIG. 63, an embodiment is shown for a screenshot of a tenth page of a track indexing form for a song and the parameter choices for SIMILAR ARTISTS that match the song. Referring to FIG. 64, an embodiment is shown for a screenshot of a eleventh page of a track indexing form for a song and the parameter choices for SIMILAR ARTISTS that match the song. Referring to FIG. 65, an embodiment is shown for a screenshot of a twelfth page of a track indexing form for a song and the parameter choices for SIMILAR ARTISTS and TEMPO that match the song.

Referring again to FIG. 56, COUNTRY is an exemplary parameter choice for the song. In an embodiment, the COUNTRY parameter for a song may also be used to match REGION parameter choices selected by a user, such as in ADVANCED SEARCH screen in FIG. 6 and for the other search tools in the invention. Referring to FIG. 56 and FIG. 57, COUNTRY parameter choices can include AFRICA, ASIA, CARIBBEAN, CENTRAL AMERICA, EUROPE, MIDDLE EAST, NORTH AMERICA, OCEANIA/POLYNESIA, and SOUTH AMERICA.

Referring to FIG. 58, INSTRUMENT is another parameter choice. Referring to FIGS. 58-59, INSTRUMENT parameter choices can include AEROPHONES, CHORDOPHONES, MECHANICAL/ELECTRIC, MEMBRANOPHONES, IDIOPHONES, and ENSEMBLES. Each INSTRUMENT parameter choice is divided into additional categories as shown in FIG. 58 and FIG. 59. In an embodiment of the invention, if a user selects one of the specific categories, the server can return matches for other instruments in the same category.

Referring to FIG. 59 and FIG. 60, MOOD is another parameter choice. MOODS are divided into ten groups, as shown in FIG. 59 and FIG. 60. In an embodiment of the invention, if a user selects a category within one of the groups, all songs within that group are returned as matches. For instance, referring to GROUP 1, if the user selects AGGRESSIVE as a parameter choice, songs with a MOOD of DETERMINED are returned as matches for the AGGRESSIVE parameter choice, along with other songs within the group.

Referring to FIG. 60, SUBJECT is another parameter choice. Referring to FIGS. 60-62, SUBJECT parameter choices include THE FORTIES, THE SIXTIES, THE EIGHTIES, THE NINETIES, THE THIRTIES, THE FIFTIES, THE SEVENTIES, THE TWENTIES, and seven groups of subjects. In an embodiment of the invention, if a user selects a category within one of the groups, all songs within that group are returned as matches. For instance, if the user selects ACTION as a parameter choice from GROUP 1, songs with a SUBJECT of CARS are returned as matches for the ACTION parameter choice, along with other songs within the group.

Referring to FIG. 62, LANGUAGE is another parameter choice. LANGUAGES for a song can include AFRICAN LANGUAGES, CHINESE, DANISH, EASTERN EUROPEAN, FAR EASTERN LANGUAGES, FINNISH, and other languages shown in the screenshot in FIG. 62.

Referring to FIG. 63, SIMILAR ARTISTS is another parameter choice. Referring to FIGS. 63-65, SIMILAR ARTISTS can include ABBA, AC/DC, AL GREEN, ALANIS MORRISETTE, and other artists as shown in FIGS. 63-65. In an embodiment of the invention, a user can search for songs that sound like a singer or band, such as ABBA. A user can also use SIMILAR ARTISTS as an additional parameter choice to limit the number of matches returned for a search.

Referring to FIG. 65, TEMPO is another parameter choice. TEMPO for a song can include FAST, FLOATING, MEDIUM, MEDIUM FAST, and other choices as shown in FIG. 65.

The user also can limit a search by selecting a maximum price parameter in one of the search tools of the invention. Referring to FIG. 6, “$$” as shown is an intermediate price limitation. The price limitations may include “$$$$,” “$$$,” “$$,” “$,” and “no selection.” “$$$$” is an exemplary highest price limitation, which may return a high number of matches if selected, whereas “$” is an exemplary lowest price limitation, which may return matches only for the most inexpensive songs if selected. “No selection” as a price limitation may return the highest number of matches because price would not be used as a limiting search criteria or parameter.

Referring again to FIG. 6, after selecting one or more search criteria and/or a price limitation, the user can click or selects SEARCH to begin the search.

The system of the present invention or the server may conduct a Boolean search of all media content files in databases in the system in order to determine matches for the parameters entered by the user. The system of the present invention or the server may also use any other well-known search methods to find parameter matches and/or matches to search criteria.

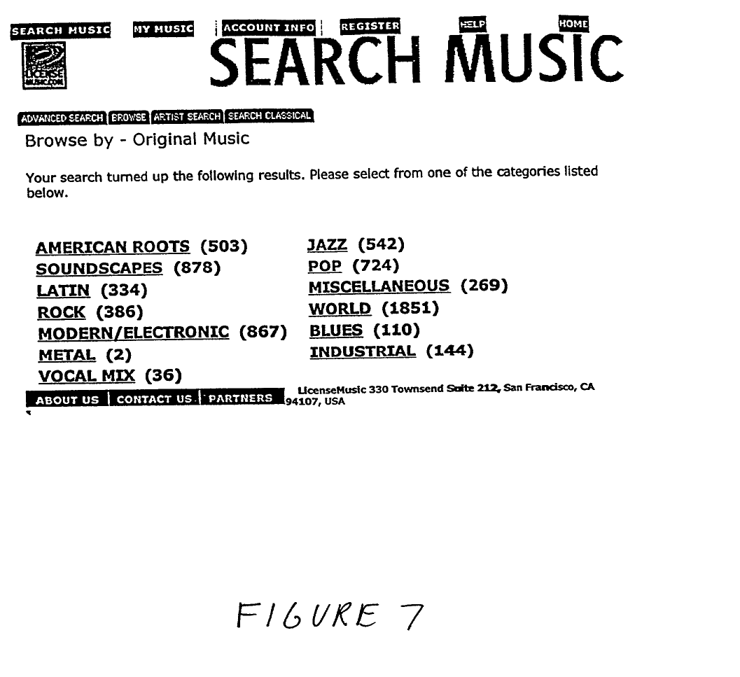

By clicking or selecting BROWSE on the screen in FIG. 4, a BROWSE BY—ORIGINAL MUSIC screen such as the one shown in the screenshot of FIG. 7 is displayed. Music content files sorted by parameter, category, or type are presented to the user. Each parameter, category, or type is followed by a number in parentheses representing the number of files matching that category. The parameters or categories may, for example, include AMERICAN ROOTS, SOUNDSCAPES, LATIN, ROCK, MODERN/ELECTRONIC, METAL, VOCAL MIX, JAZZ, POP, MISCELLANEOUS, WORLD, BLUES, and INDUSTRIAL.

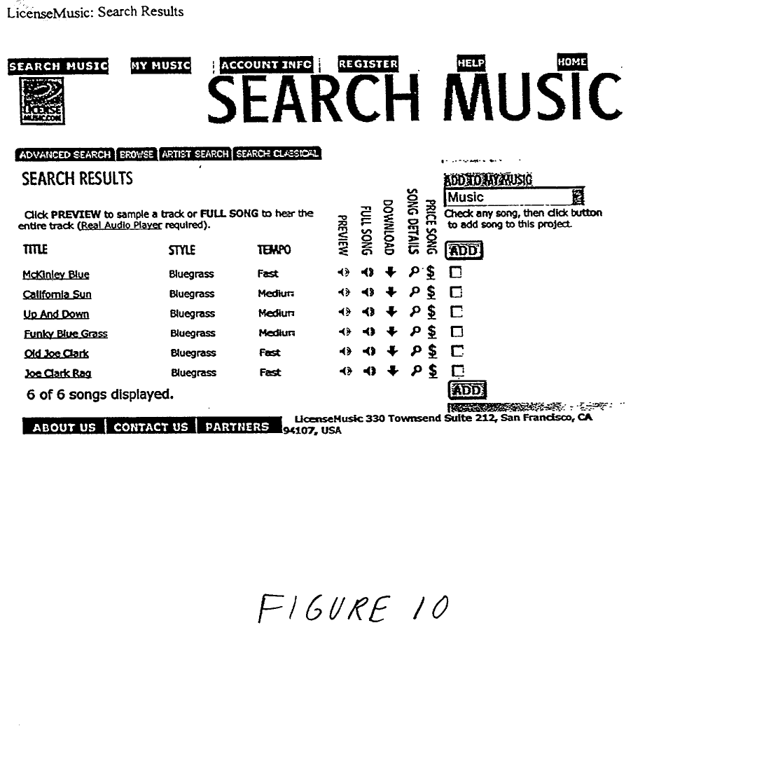

Each parameter or category listing may contain a hyperlink. If the user clicks or selects one of the hyperlinks, the system or server of the invention conducts a search of media content for matches to the selected parameter or category, and a list of media content matching that category may be displayed to the user, for example in a SEARCH RESULTS screen as exemplified by the screenshot in FIG. 10.

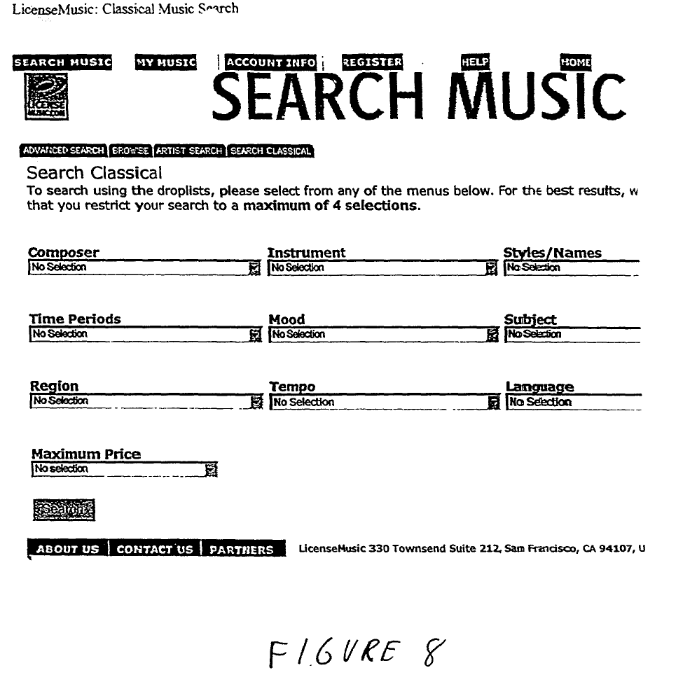

If the user selects “Search Classical” from the screen in FIG. 4, the user is shown the search classical screen in FIG. 8. The user is given a choice of 10 search parameters by which the user can search. These parameters can include COMPOSER, INSTRUMENT, STYLES/NAMES, TIME PERIODS, MOOD, SUBJECT, REGION, TEMPO, LANGUAGE, and MAXIMUM PRICE.

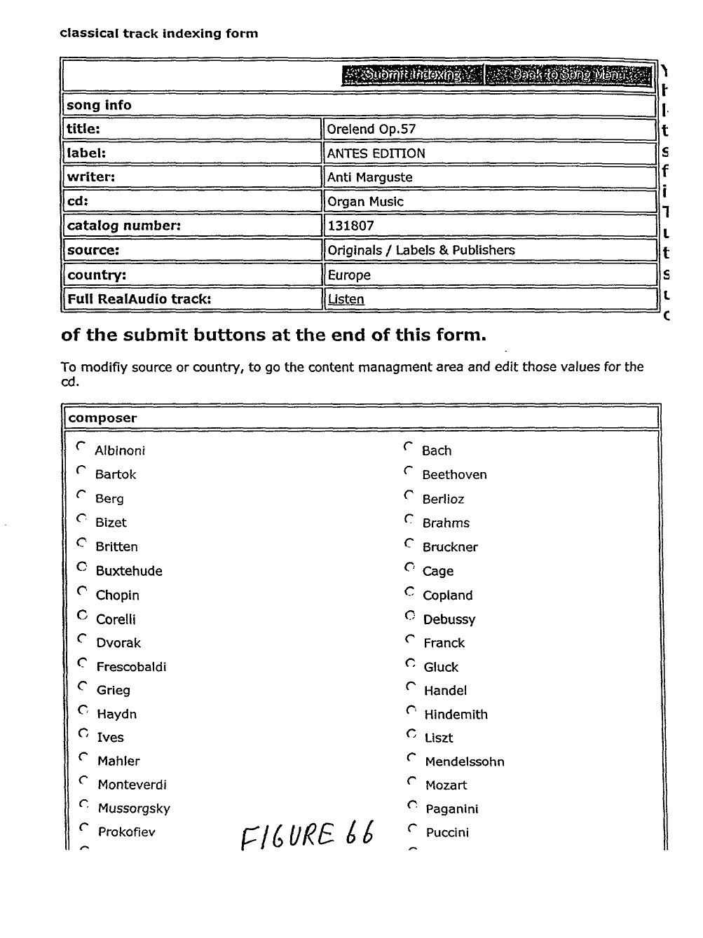

FIGS. 66-72 show an embodiment of screenshots of an exemplary CLASSICAL TRACK INDEXING FORM including exemplary parameters and parameter choices by which the user may search. These parameter choices can correspond with the parameter choices for the parameters shown in FIG. 8.

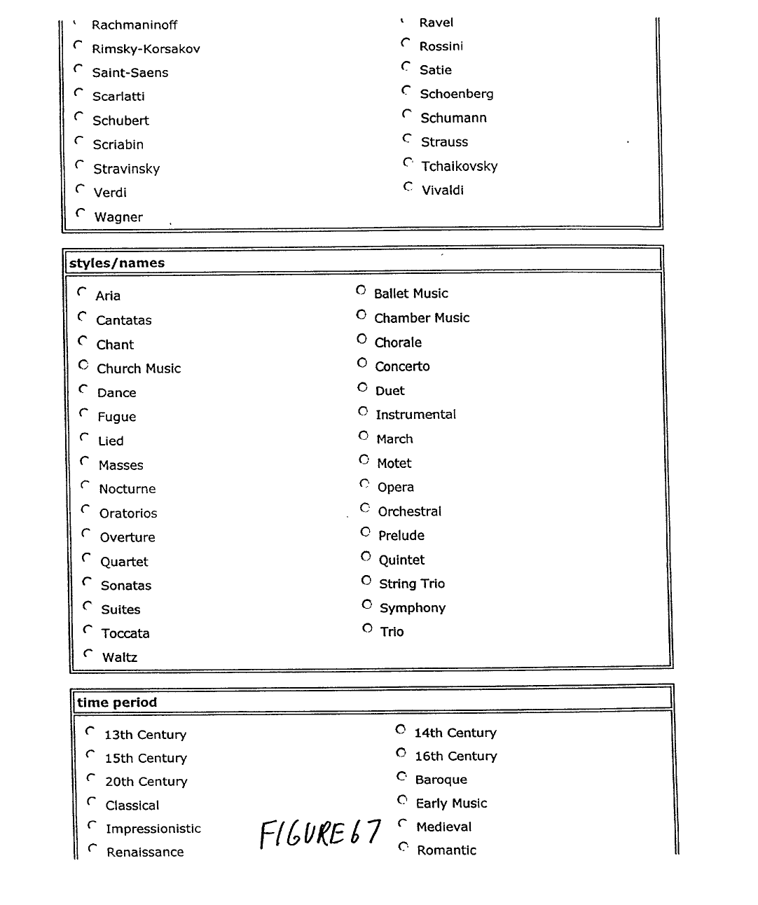

FIGS. 66 and 67 are screenshots showing exemplary COMPOSER parameter choices.

FIG. 67 is a screenshot showing exemplary STYLES/NAMES and TIME PERIOD parameter choices.

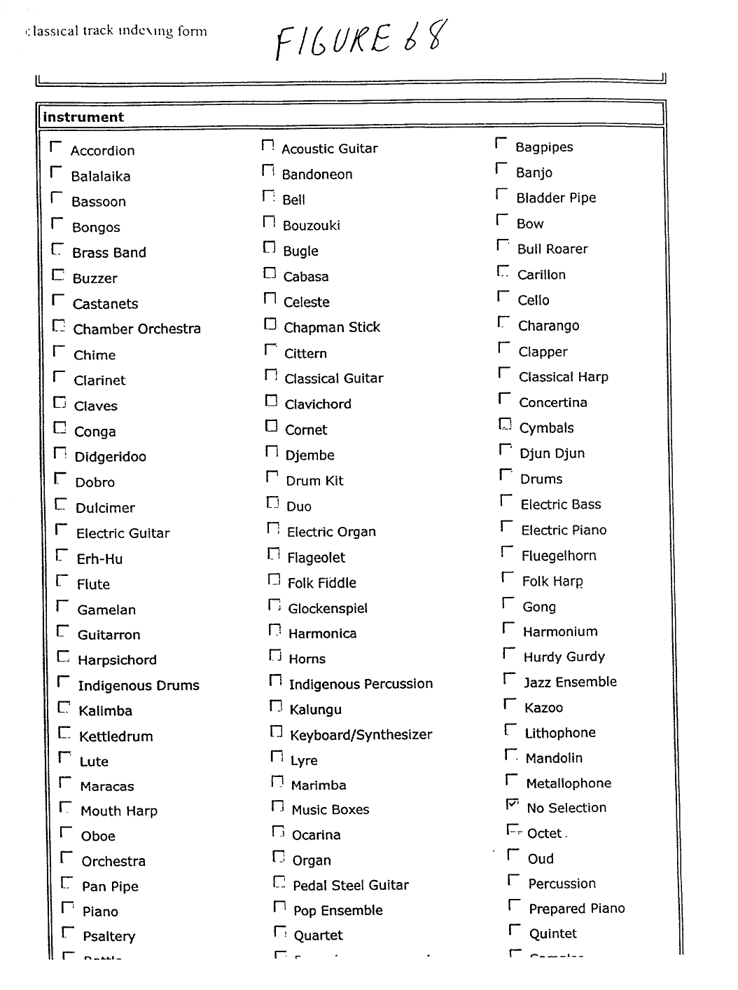

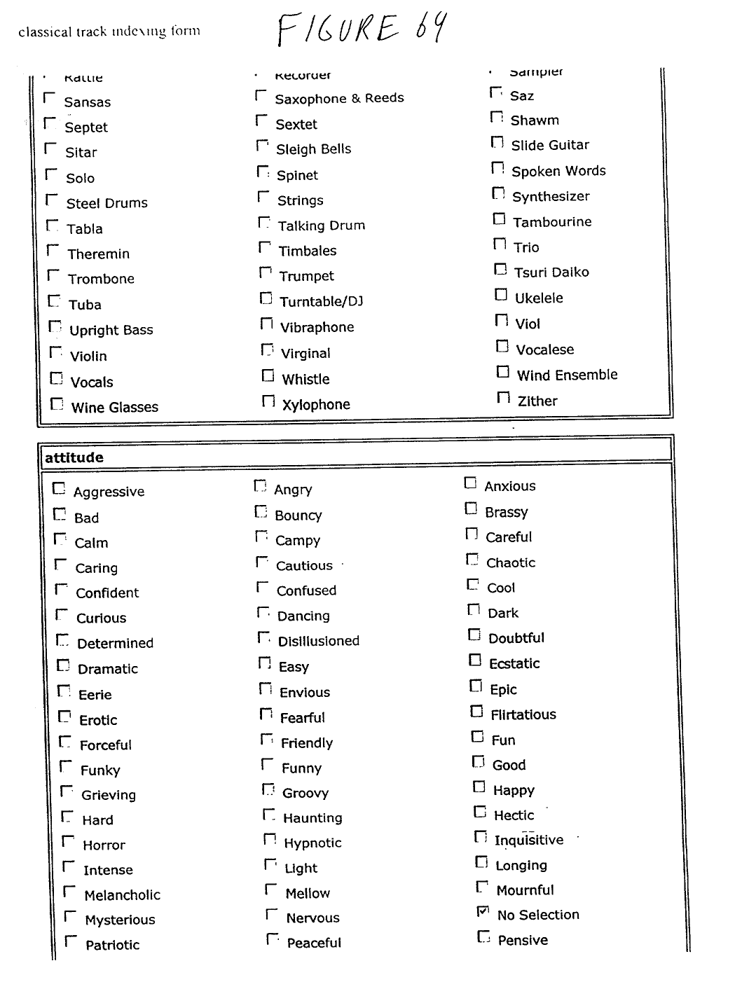

FIGS. 68 and 69 are screenshots showing exemplary INSTRUMENT parameter choices.

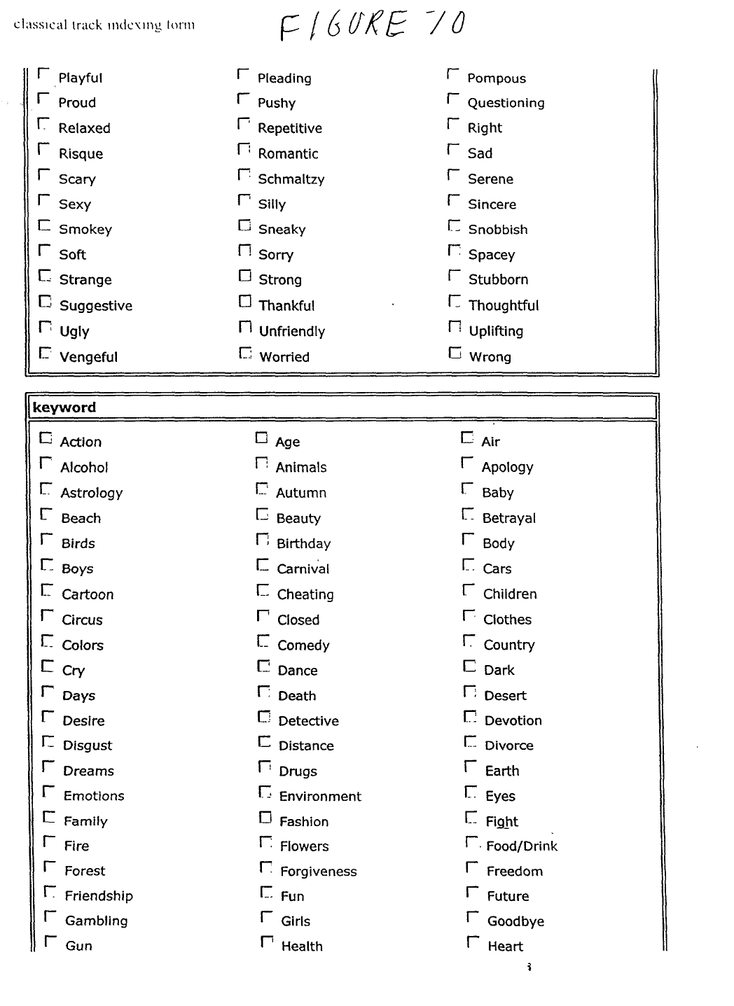

FIGS. 69 and 70 are screenshots showing exemplary ATTITUDE or MOOD parameter choices.

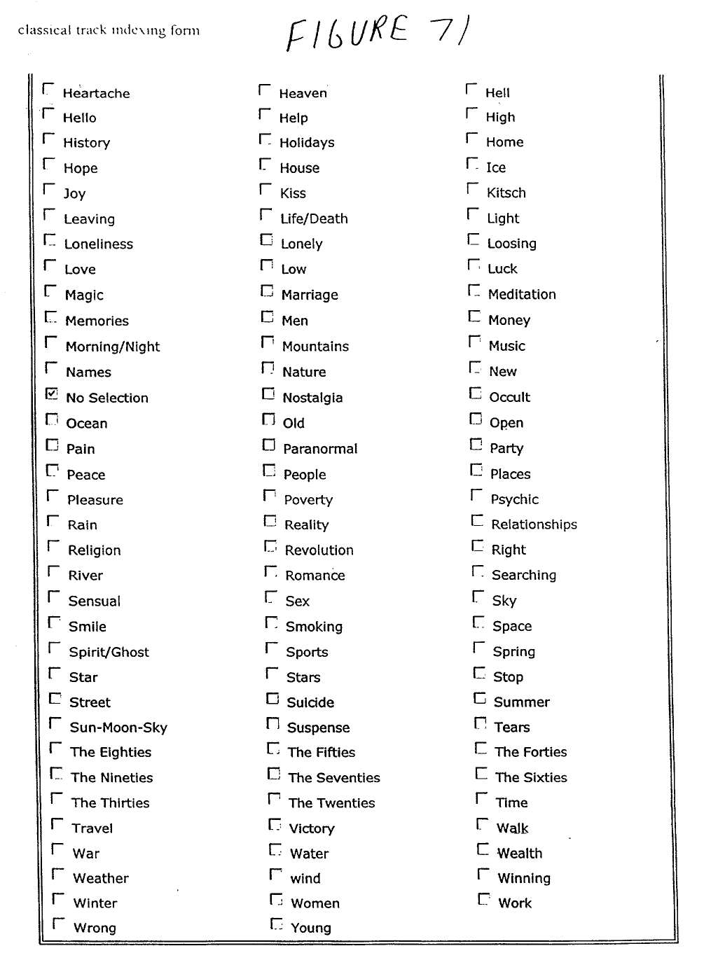

FIGS. 70 and 71 are screenshots showing exemplary KEYWORD parameter choices.

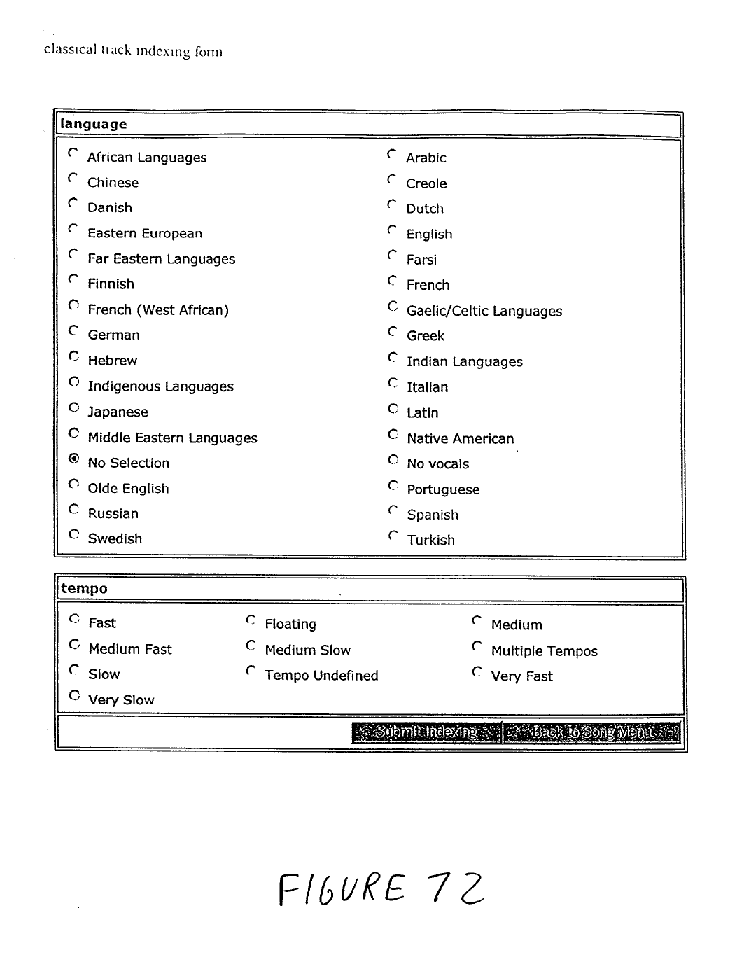

FIG. 72 is a screenshot showing exemplary LANGUAGE and TEMPO parameter choices.

A database administrator, manager, or another person may input parameter choices for a given song or media content file. Referring to FIG. 72, if the administrator selects or clicks SUBMIT INDEXING, the parameter choices for a song are input.

After selecting one or more search criteria and/or a price limitation from any of the search tools of the invention, such as SEARCH CLASSICAL, the user can click or select a “search” button to begin the search.

When one of the search tools of the present invention is used, the system of the present invention can conduct a Boolean search, or any other well-known search, of some or all media content files in databases in the system in order to determine matches for the parameters or search criteria entered by the user.

Advanced Search

Referring again to FIG. 4, if the user clicks or selects ADVANCED SEARCH, a webpage is communicated to the client showing the screen in FIG. 6. Referring to FIG. 6, the user can specify the type of music for the search by clicking or selecting one or more parameters. The parameters may include GENRE, REGION, MOOD, STYLE, INSTRUMENT, TEMPO, TRACK LENGTH, ORIGINAL RELEASE YEAR, VOCAL MIX, LANGUAGE, SUBJECT, and KEY. In another embodiment, parameters can include “similar artists.”

Artist Search

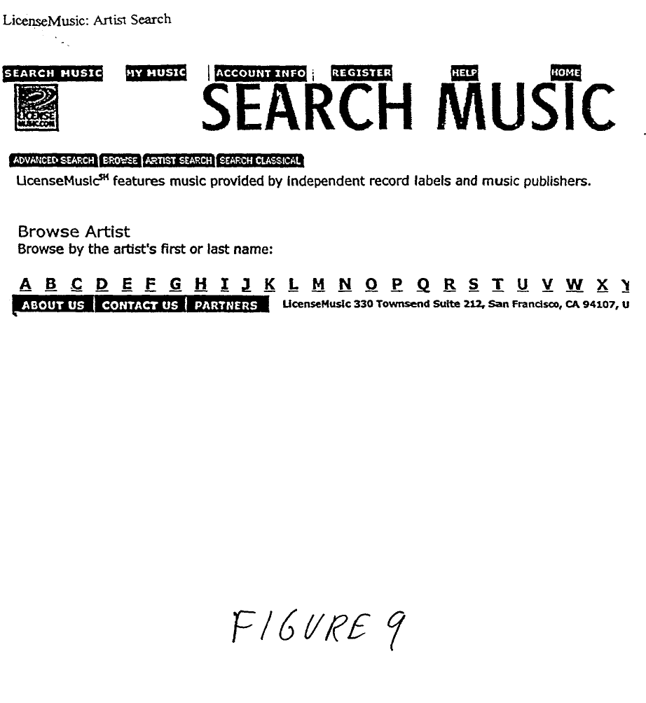

Referring to FIG. 4, if the user selects ARTIST SEARCH, the user may be shown the BROWSE ARTIST screen shown in FIG. 9. Each letter of the alphabet in FIG. 9 can contain a hypertext, other link, or dropdown list. When the user selects a letter, information for all artists whose first or last names begin with that letter may be displayed to the user in alphabetical order. The user can then select any artist shown to bring up a list of music files corresponding to that artist.

Budget Library Search

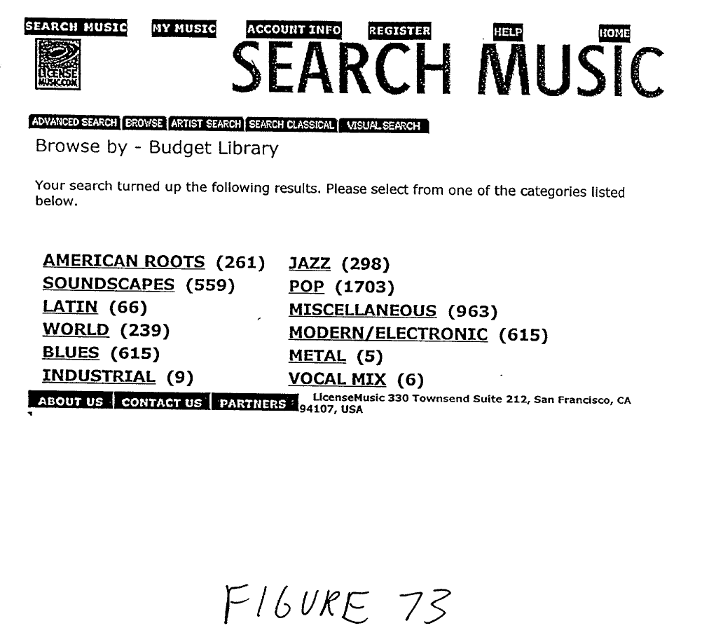

If the user selects “Budget Library” from the screen shown in FIG. 4, the screen shown in FIG. 73 is displayed to the user. The Budget Library contains media content that have a lower license price than other media content. Referring to FIG. 73, the user can narrow his search for budget-priced media content by clicking or selecting a genre, such as AMERICAN ROOTS, JAZZ, SOUNDSCAPES, POP, LATIN, MISCELLANEOUS, WORLD, MODERN/ELECTRONIC, BLUES, METAL, INDUSTRIAL, OR VOCAL MIX. After selecting a genre, the user is shown a list of media content that is budget-priced and that matches the genre selection.

Exemplary Search Results Interface

FIG. 10 shows a search results screen that is shown to the user after the user makes a sufficient set choices from the VISUAL SEARCH, ADVANCE SEARCH, BROWSE, SEARCH CLASSICAL, ARTIST SEARCH, BUDGET LIBRARY, OR QUICK SEARCH tools described above. The TITLE LIST shown in FIG. 10 represents a list of music files having the lowest license fees, all having the “$” price parameter. The style and tempo of each music file is displayed to assist the user in choosing one or more suitable files. From this screen, the user may click or select one of the following options: PREVIEW, FULL SONG, DOWNLOAD, SONG DETAILS, and ADD to my music.

If the user clicks or selects PREVIEW for a music file, a full-length version of that music file may be communicated to the client. This version of the music file may assist the user in determining whether the music file suits the user's licensing needs.

If the user selects FULL SONG for a music file, the entire music file is communicated to the client. The user may then listen to the entire music file in its entirety.

If the user selects DOWNLOAD for a music file, the entire music file or part of the music file may be communicated to the client for permanent storage into a hard disk or another storage device located at the client.

In an embodiment of the invention, search tools in the invention may return search results in the form of song titles which can then be listened to by clicking on a corresponding icon next to each returned title. Clicking on the corresponding icon may cause, for example, a Real Audio player, or any other media content player, to begin streaming music or media content to the user so that the music or media content can be heard. In an embodiment of the invention, there is a delay when a media content player algorithm first connects to a streaming server, buffers a first few seconds of media content, and then begins to play the media content.

In another embodiment of the invention, a Real Audio player, or any other media content player, begins connecting and pre-buffering music from, for example, a first number of media content files, such as five, that are returned as a search result, wherein the buffering occurs as soon as the search result is returned by a search engine or tool. A significant portion of each media content file may be buffered while the user reads or analyzes returned search results. Real Audio player, or any other media content player, is prevented from audibly playing any of the media content by engaging a pause function or a similar halting mechanism before audible playing of a music sample begins. In this manner, a first number of media content files may have completed connecting and pre-buffering and be ready to play instantly as soon as a PREVIEW or FULL icon next to any of the pre-buffered songs is selected or clicked. This pre-buffering significantly improves the searching and sampling experience for a user, or an Internet-based music or media content library or distribution service.

Referring again to FIG. 10, if the user selects SONG DETAILS for a music file, a detailed description of the song may be communicated to the client. This detailed description includes the title, catalog number, author/composer, artist/performer, region, price, genre, instrument, mood, subject, and language. One or more choices can exist for the each of the following parameters: region, genre, instrument, mood, subject, language, and other parameters.

Project Interface

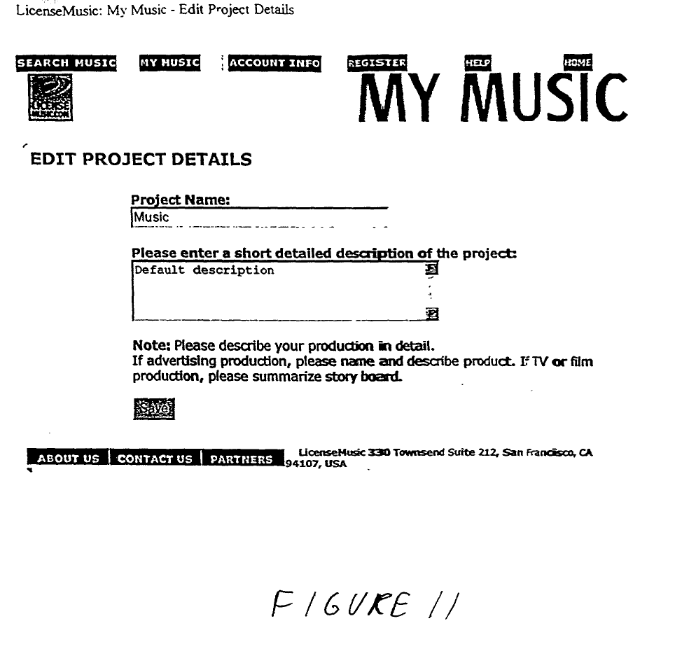

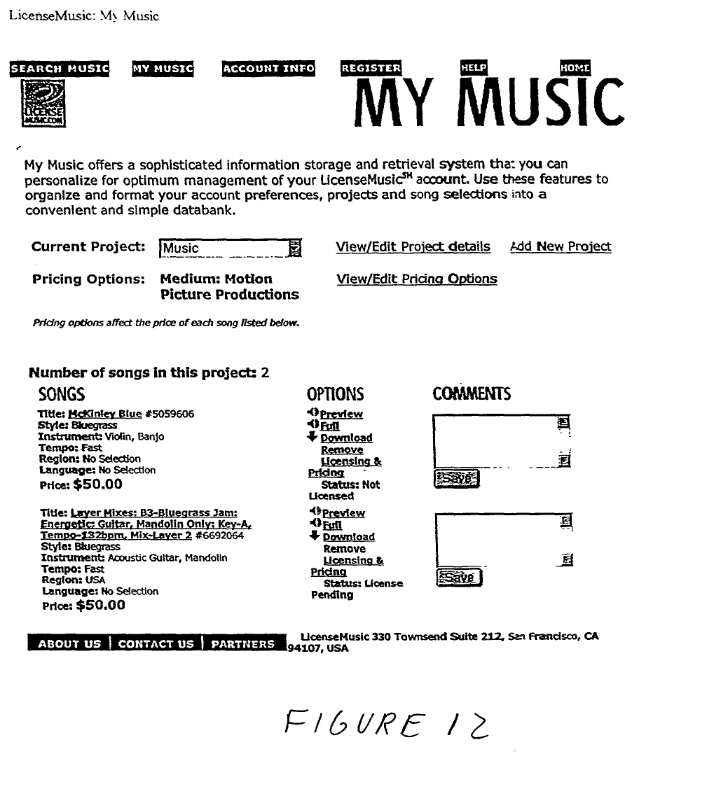

According to an embodiment of the invention, a user may create and save projects, including preferences, uses, and other information, into a personalized interface. For example, in one embodiment, if the user selects MY MUSIC from FIG. 10 or from any other screen with a MY MUSIC hypertext link, the EDIT PROJECT DETAILS screen shown in FIG. 11 is communicated to the user. The user is prompted to enter a PROJECT NAME and a SHORT DESCRIPTION of the project. The most recently entered project name and description may be default entries when the user is displayed the screen in FIG. 11. Such information may be based on the user's login, which may be stored on a database associated with the system. The user's login may be based on cookies associated with the user. In an embodiment, the user may at any time select SAVE to save the user's entries. When SAVE is selected, the MY MUSIC screen shown in FIG. 12 is displayed to the user.

Referring to FIG. 12, CURRENT PROJECT displays a drop-down list of project titles previously entered by the user. The most recently entered project title is the default entry first displayed on the screen. PRICING OPTIONS shows a medium or use previously selected by the user. The user can select VIEW/EDIT PROJECT DETAILS to edit the title and/or description of the project. The user can select ADD NEW PROJECT to create a new project, including a new title and description. The user can select VIEW/EDIT PRICING OPTIONS to change the use or medium for a music license request, thereby reducing or increasing the license fees accordingly.

Referring again to FIG. 12, NUMBER OF SONGS shows the number of music files selected for potential licensing in the project by the user. SONGS may show a title, style, instrument, tempo, region, language, price, and other information for each song.

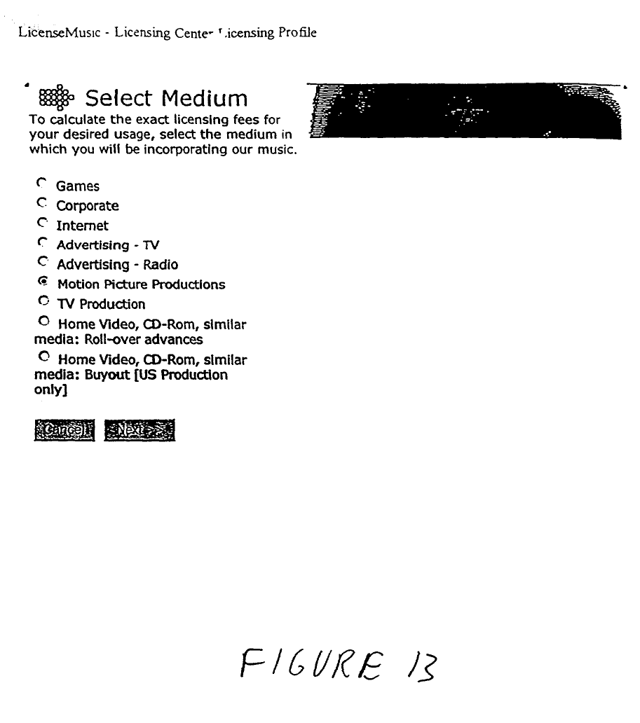

The user can select any hypertext in the OPTIONS section, including PREVIEW, FULL, DOWNLOAD, REMOVE, and LICENSING & PRICING. PREVIEW communicates a shortened version of the music file to the client for audio display. FULL communicates the entire music file to the user for audio presentation. DOWNLOAD communicates the file to the client for storage at the client, for example in a hard drive or tape drive at the client. REMOVE deletes the music file from the music license request. If the user selects LICENSING & PRICING, a SELECT MEDIUM screen, such as the one shown in FIG. 13, may be displayed to the user.

Licensing Uses and Mediums

Referring to FIG. 13, the user can select a licensing use or medium for the music license request. License use options include GAME, CORPORATE PRESENTATION, INTERNET, TELEVISION ADVERTISEMENT, RADIO ADVERTISEMENT, MOTION PICTURE PRODUCTION, TELEVISION PRODUCTION, HOME VIDEO/CD-ROM/ROLL-OVER ADVANCES, and HOME VIDEO/CD-ROM/BUYOUT, and COMPILATION uses.

A GAME use for media content can include use of the content in or for an electronic game for arcades or consumers, such as hand-held, kiosk, DVD, CD, or internet-related, that utilizes music as an added stimulus or feature to enhance the experience of gaming.

A CORPORATE PRESENTATION use for media content can include use of the content for a multimedia presentation used directly on computers, CD_ROMs, DVDs, or videos, such as for in-house or tradeshow presentations in which media content is used. A CORPORATE PRESENTATION use can also include use of the content for a training video for company employees or for business-to-business presentations.

An INTERNET use for media content can include use of the content for a website, such as for use with visual graphics and for other internet uses.

A TELEVISION ADVERTISEMENT use for media content can include use of the content for an television related use, such as free television, pay television, subscription television, cable television, satellite television, closed-circuit television, home video, and public television worldwide advertisement.

A RADIO ADVERTISEMENT use for media content can include use of the content for any form of radio use of media content, such as in advertisements, station promotions, background beds, and similar uses worldwide.

A MOTION PICTURE PRODUCTION use for media content can include use of the content related to a motion picture production, such as for a film for worldwide distribution in theaters, for a festival film, for a student film, for an independent film, for a major studio production, or for a home video film.

A TELEVISION PRODUCTION use for media content can include use of the content for any form of television production, such as for free television, for cable television, for pay-per-view, for subscription television, for satellite television, for closed-circuit television, for a home video television production, or for a theatrical worldwide television production.

A HOME VIDEO/CD-ROM/ROLL-OVER ADVANCES use for media content can include use of the content such as for continual licensing of use for continued, if necessary, production or creation of such items as home videos and CD-ROMs. In an embodiment of the invention, for each additional 10,000 units, an additional amount is calculated as a license fee.

A HOME VIDEO/CD-ROM/BUYOUT use for media content can include use of the content for continued licensing in production or creation of such items as home videos or CD-ROMs, for an unlimited number of copies. In an embodiment of the invention, a HOME VIDEO/CD-ROM/BUYOUT use is similar to a HOME VIDEO/CD-ROM/ROLL-OVER ADVANCES use, except that a larger fee is paid for the HOME VIDEO/CD-ROM/BUYOUT so that the media content can be used without limit.

A COMPILATION use for media content can include use of the content for premium business products or special markets products, which can include free promotional CDs given to employees as gifts or educational/training devices, premium items given to consumers as value-adds or “free-with-purchase” promotions, or demonstration devices utilizing content as an end result of demonstrated functionality.

Pricing Engine

A pricing mechanism or pricing engine of the invention determines a license price for a piece of media content, such as a song. In an embodiment of the invention, a licensing fee, such as for a track of music or a song, varies according to the proposed use or uses of the track. In an embodiment of the invention, the user can select one or more uses. The license fee also varies according to the assessed value of the song itself

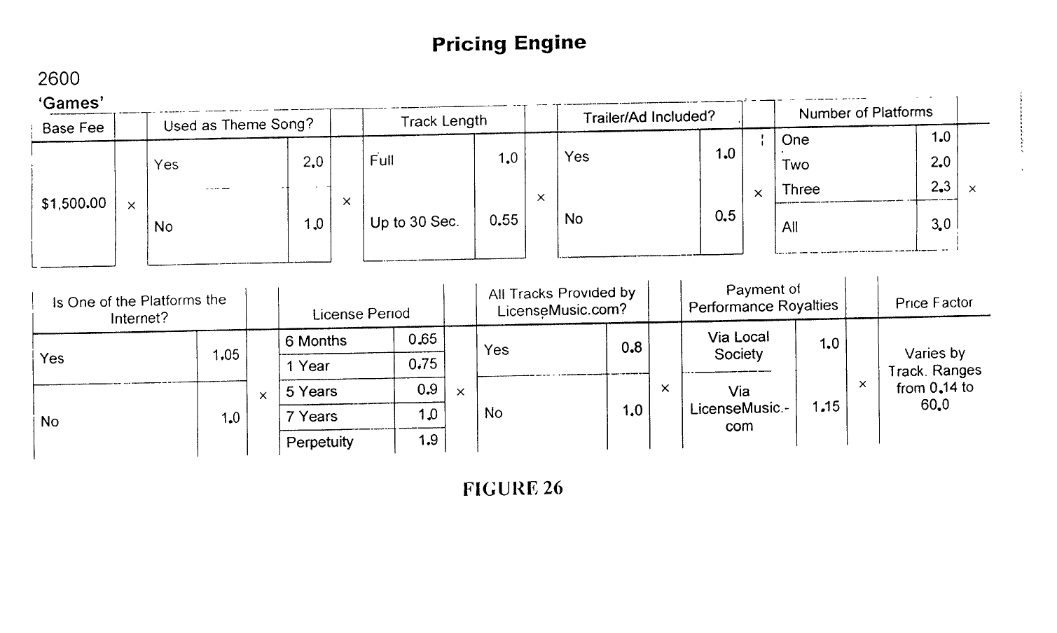

FIGS. 26-37 show an embodiment of an exemplary pricing engine for the invention. The pricing engine is used to calculate a license price for media content. The license price for media content depends on a number of factors, beginning with an intended use for the media content.

FIG. 26 shows an embodiment of a pricing algorithm for a GAME use for media content. In an embodiment of the invention, for GAME or GAMING use, a license fee for a media content can be based on factors such as:

1. Whether the media content is used as a theme song;

2. A length of the media content being used;

3. Whether a Trailer is included;

4. The number of platforms for which the game or games will be built such as DOS, Windows 32, Macintosh or Unix;

5. Whether one of those platforms is the internet;

6. A license period;

7. Whether all of the media content for the game use will be provided by LicenseMusic.com or a content provider associated with the invention.

8. How royalties will be paid, such as via a local society (e.g., ASCAP or BMI) or via LicenseMusic.com; and

9. A price factor associated with the media content.

In an embodiment of the invention the license fee for a media content used in a game is the product of a base fee (e.g., $1500) and the above factors associated with aspects of the media content. For example:

If the media content is used as a theme song, the multiplier associated with this aspect of use can be 2.0; or if the media content is not used as a theme song, the multiplier associated with this aspect of use can be 1.0

If more than 30 seconds of the media content is used in the game, a multiplier associated with this aspect of use can be 2.0; or if 30 seconds or less of the media content is used in the game, a multiplier associated with this aspect of use can be 1.0

If the media content is used in a trailer or advertisement, the a multiplier associated with this aspect of use can be 1.0; or If the media content is not used in a trailer or advertisement, the multiplier associated with this aspect of use can be 0.5.

If the game is built for 1 platform, the multiplier associated with this aspect of use can be 1.0; or if the game is built for 2 platforms, the multiplier associated with this aspect of use can be 2.0; or if the game is built for 3 platforms, the multiplier associated with this aspect of use can be 2.3; or if the game is built for all platforms, the multiplier associated with this aspect of use can be 3.0.

If one of the platforms for which the game is being built is the internet, the multiplier associated with this aspect of use can be 1.05; or if one of the platforms for which the game is being built is not the internet, the multiplier associated with this aspect of use can be 1.0.

If the license period required for the media content is 6 months, the multiplier associated with this aspect of use can be 0.65; or if the license period required for the media content is 1 year, the multiplier associated with this aspect of use can be 0.75; or if the license period required for the media content is 5 years, the multiplier associated with this aspect of use can be 0.9; or if the license period required for the media content is 7 years, the multiplier associated with this aspect of use can be 1.0; or if the license period required for the media content is perpetuity, the multiplier associated with this aspect of use can be 1.9.

If all of the media content used in the game are provided by LicenseMusic.com, the multiplier associated with this aspect of use can be 0.8; or if some, but not all, of the media content used in the game are provided by LicenseMusic.com, the multiplier associated with this aspect of use can be 1.0.

If the royalties on the media content are paid via a local society, the multiplier associated with this aspect of use can be 1.0; or if the royalties on the media content are paid via LicenseMusic.com, the multiplier associated with this aspect of use can be 1.15.

A price factor is associated directly with each media content, and can range from a multiplier of 0.14 to a multiplier of 60.0.

Pricing Algorithms and Calculation of Licensing Fees

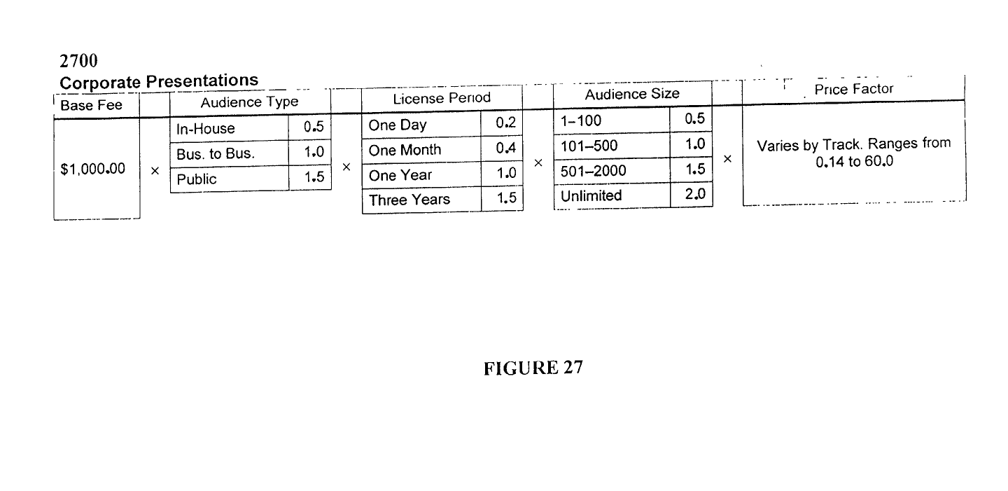

FIG. 27 shows an embodiment of a pricing algorithm for a CORPORATE PRESENTATION use for media content. In an embodiment of the invention, for CORPORATE PRESENTATION use, a license fee for a media content can be based on factors such as:

1. Audience Type, such as in-house, business to business or public;

2. A license period;

3. An audience size; and

4. A price factor associated with the media content.

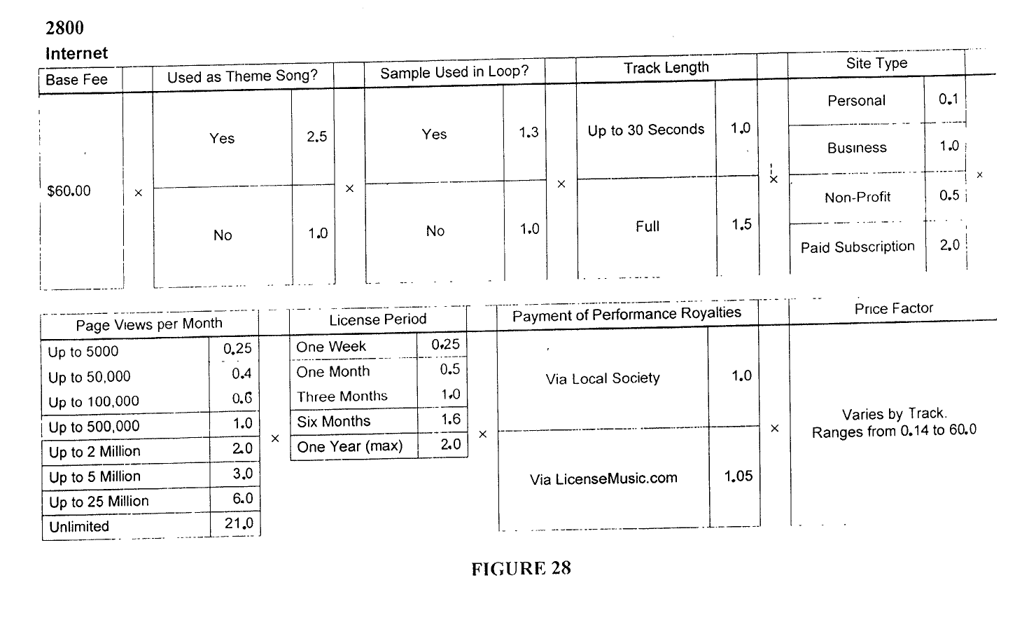

FIG. 28 shows an embodiment of a pricing algorithm for an INTERNET use for media content. In an embodiment of the invention, for INTERNET use, such as a web site, a license fee for a media content can be based on factors such as:

1. Whether the media content is used as a theme song;

2. Whether a sample, which can be any portion of the media content up to and including the whole media content, will be used in a loop, which may be a unique piece of content which includes the sample or samples;

3. The length of the media content being used;

4. Type of internet site, such as personal web page, business web page, Non-Profit organization web page or Paid Subscription web site, which is a web site which charges a subscription fee to its users;

5. How many times the content is viewed per month;

6. A license period.

7. How royalties may be paid, such as via a local society, such as ASCAP or BMI, or via a content provider such as LicenseMusic.com; and

8. A price factor associated with the media content file.

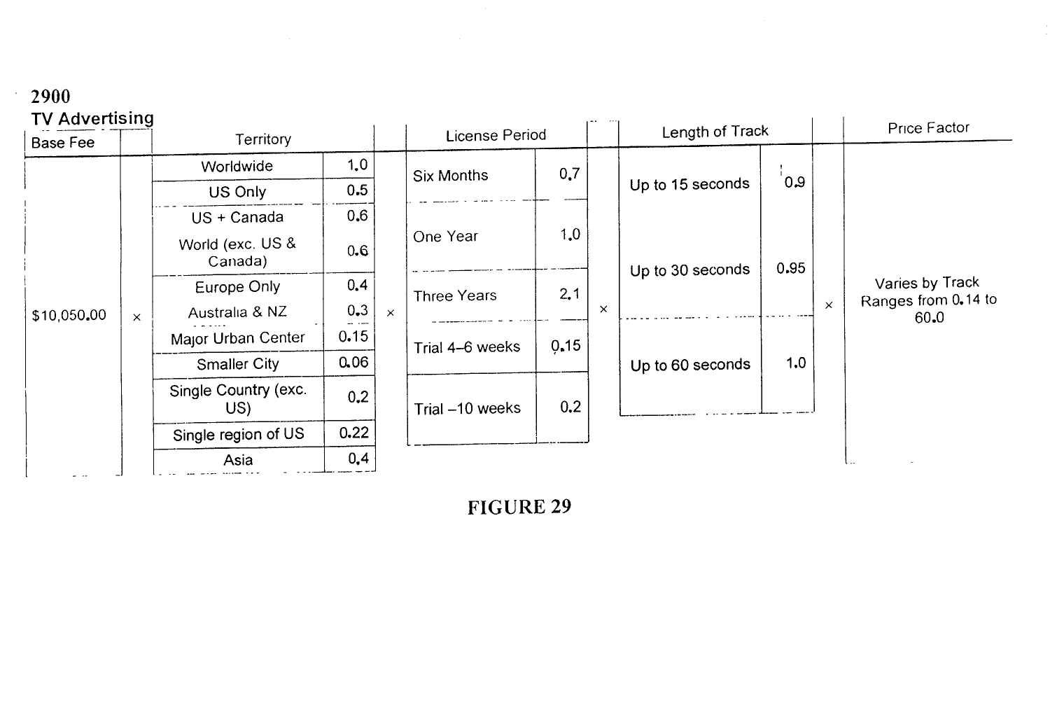

FIG. 29 shows an embodiment of a pricing algorithm for a TELEVISION ADVERTISEMENT use for media content. In an embodiment of the invention, for TELEVISION ADVERTISEMENT or TV ADVERTISING use, a license fee for a media content can be based on factors such as:

1. Where the advertisement will be shown, such as Worldwide, US Only, US and Canada, World (except US and Canada), Europe Only, Australia and New Zealand, Major urban center, Smaller city, Single Country (except US), singe region of the US or Asia;

2. A license period;

3. The length of the media content being used; and

4. A price factor associated with the media content file.

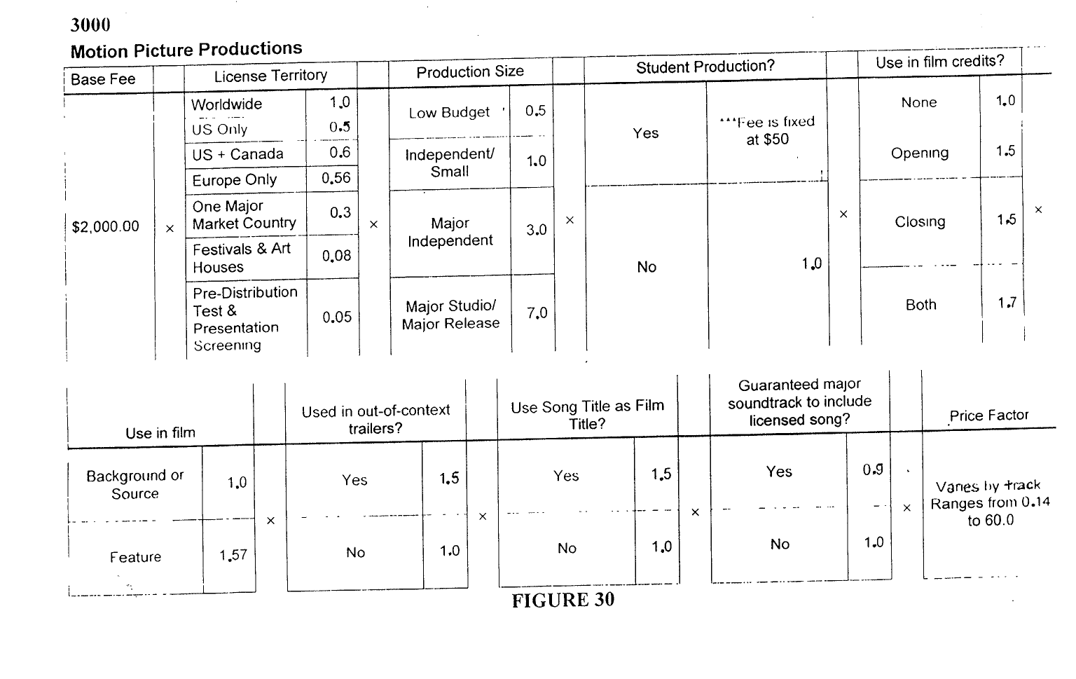

FIG. 30 shows an embodiment of a pricing algorithm for a MOTION PICTURE PRODUCTION use for media content. In an embodiment of the invention, for MOTION PICTURE PRODUCTION use, a license fee for a media content can be a fixed price, such as for a student production, or can be based on factors such as:

1. Where the motion picture will be shown, such as Worldwide, US Only, US and Canada, Europe only, Other major market countries, Festivals and Art Houses and Pre-distribution test and presentation screenings;

2. The size of the production, such as Low budget, Independent/Small, Major independent or Major Studio/Major release;

3. Whether the media content is used in the opening and/or closing credits;

4. How the media content is used in the production, such as in the background or featured;

5. Whether the media content is used in movie trailers in a manner that is out-of-context with the way it is used in the motion picture production;

6. Whether the title of the media content will be used as a title of the motion picture production;

7. Whether there will be a major soundtrack release that will include the media content;

How royalties will be paid, such as via a local society, such as ASCAP or BMI, or such as via LicenseMusic.com or a content provider associated with the invention; and

8. A price factor associated with the media content.

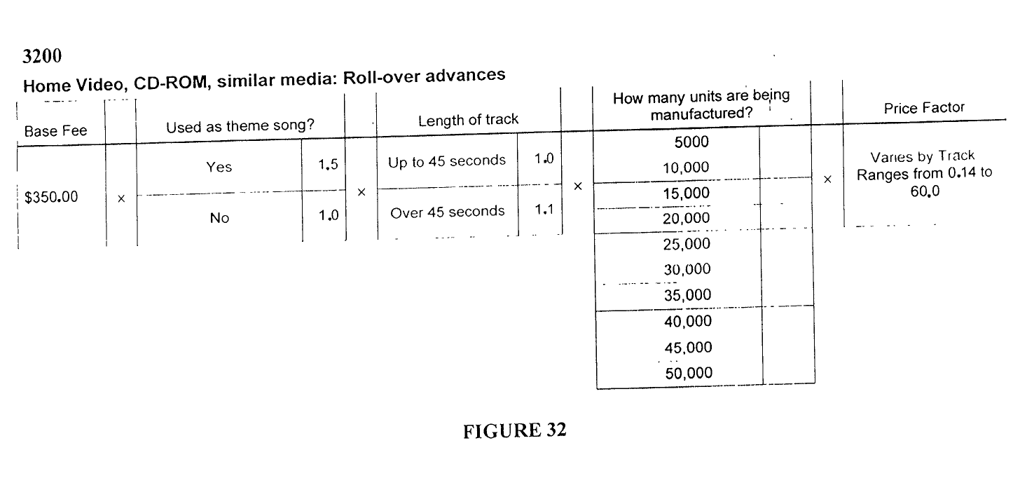

FIG. 32 shows an embodiment of a pricing algorithm for a HOME VIDEO/CD-ROM/ROLL-OVER ADVANCES use for media content. In an embodiment of the invention, HOME VIDEO, CD-ROM or similar use for which the user would like to pay a fee based on the number of unit being manufactured (termed ROLL-OVER ADVANCES), a license fee for a media content can be based on factors such as:

1. Whether the media content is used as a theme song;

2. The length of the media content being used;

3. The number of unit being manufactured; and

4. A price factor associated with the media content.

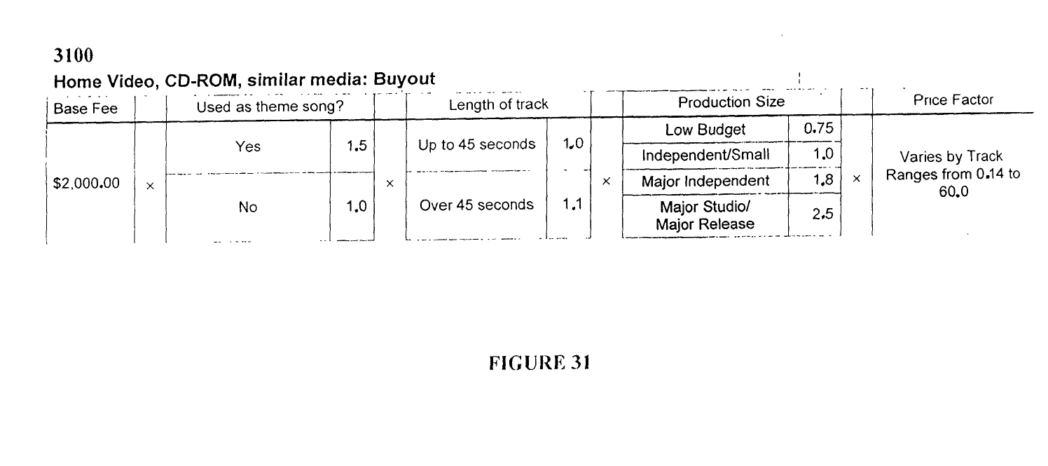

FIG. 31 shows an embodiment of a pricing algorithm for a HOME VIDEO/CD-ROM/BUYOUT use for media content. In an embodiment of the invention, HOME VIDEO, CD-ROM or similar use for which the user would like to pay a single fee regardless of the number of unit being manufactured (termed BUYOUT), a license fee for a media content can be based on factors such as:

1. Whether the media content is used as a theme song;

2. The length of the media content being used;

3. A size of the production, such as Low Budget, Independent/Small, Major Independent or Major Studio/Major Release; and

4. A price factor associated with the media content.

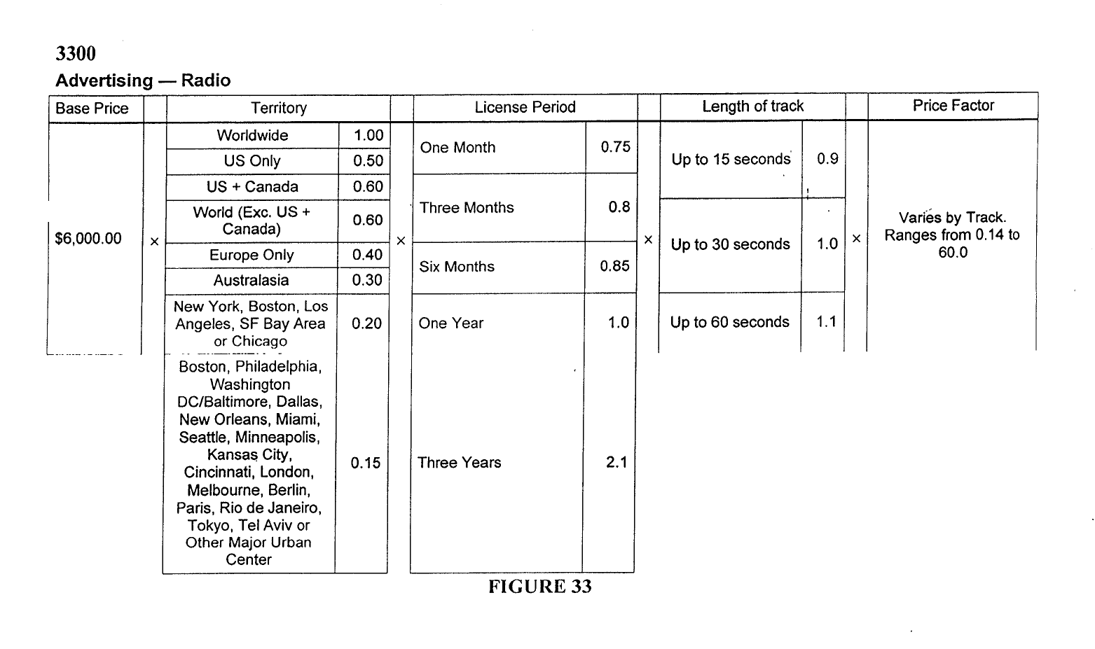

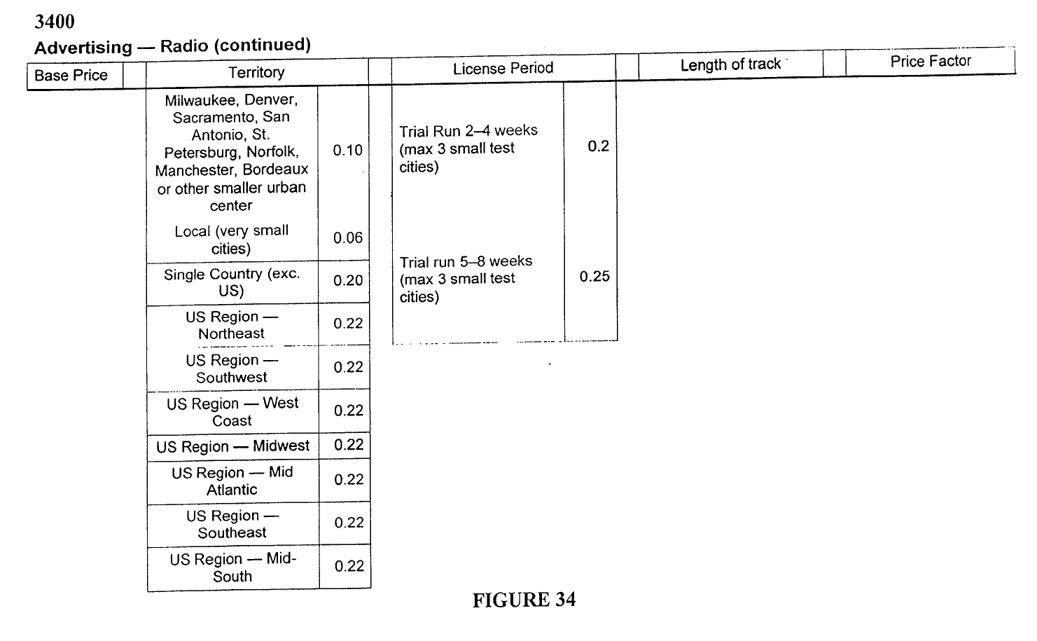

FIGS. 33 and 34 show an embodiment of a pricing algorithm for a RADIO ADVERTISEMENT use for media content. In an embodiment of the invention, for RADIO ADVERTISING or RADIO ADVERTISEMENT use, a license fee for a media content can be based on factors such as:

1. The territory in which the media content could be broadcast, such as Worldwide, US only, US and Canada, Europe only, Australasia, Major US Cities, Major Urban Centers, Smaller urban centers, very small cities, Single country (excluding US), or US region;

2. A license period;

3. The length of the media content being used; and

4. A price factor associated with the media content.

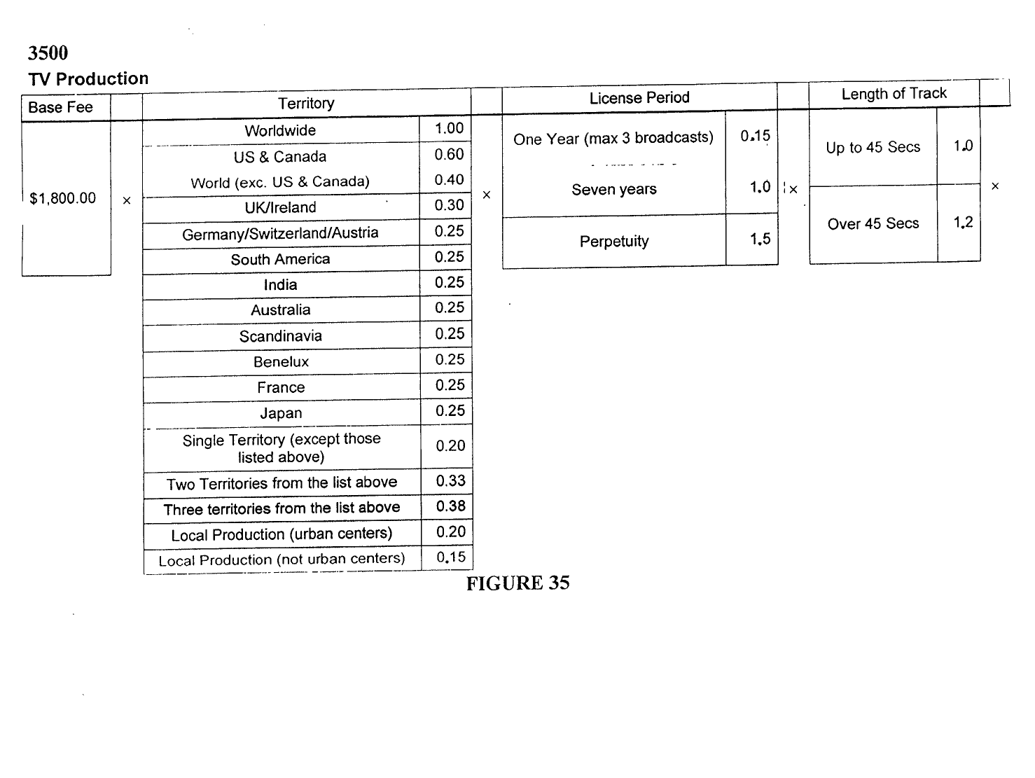

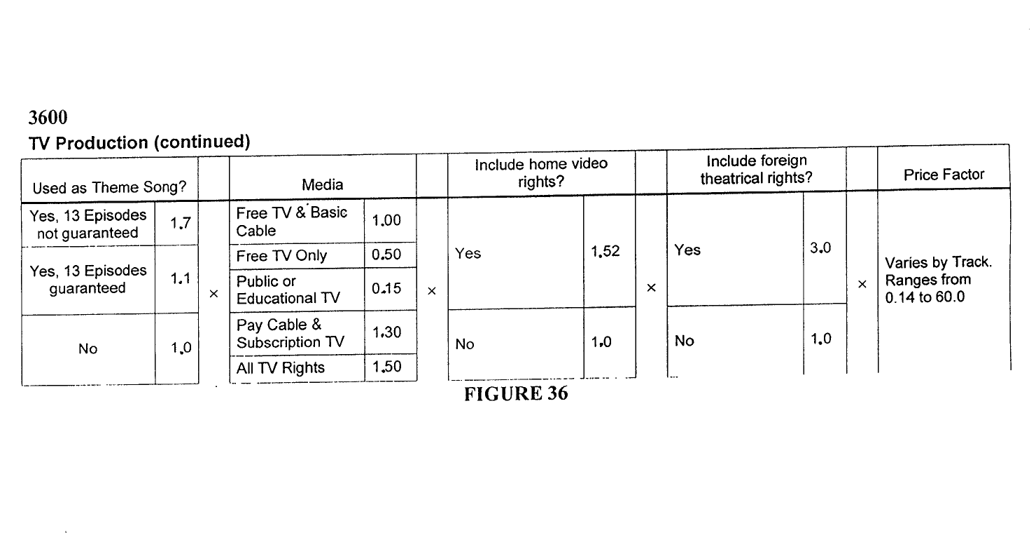

FIGS. 35 and 36 show an embodiment of a pricing algorithm for a TELEVISION PRODUCTION use for media content. In an embodiment of the invention, for TELEVISION PRODUCTION use, a license fee for a media content can be based on factors such as:

1. The territory in which the media content may be seen, such as Worldwide, US and Canada, World (except US and Canada), UK/Ireland, Germany/Switzerland/Austria, South America, India, Australia, Scandinavia, Benelux, France, Japan, Other single territory, multiple territories, Local Production in an urban center or local production not in an urban center;

2. A license period;

3. The length of the media content being used;

4. Whether the media content is being used as a theme song;

5. What media for which the television production is being produced, such as Free TV/Basic Cable, Free TV Only, Public/Educational TV, Pay cable/subscription TV or Any;

6. Whether the media content will be used in a home video based on the TV production;

7. Whether the media content will be used in a production, such as Foreign theatrical rights, which can cover the showing of a television production in a foreign movie house; and

8. A price factor associated with the media content.

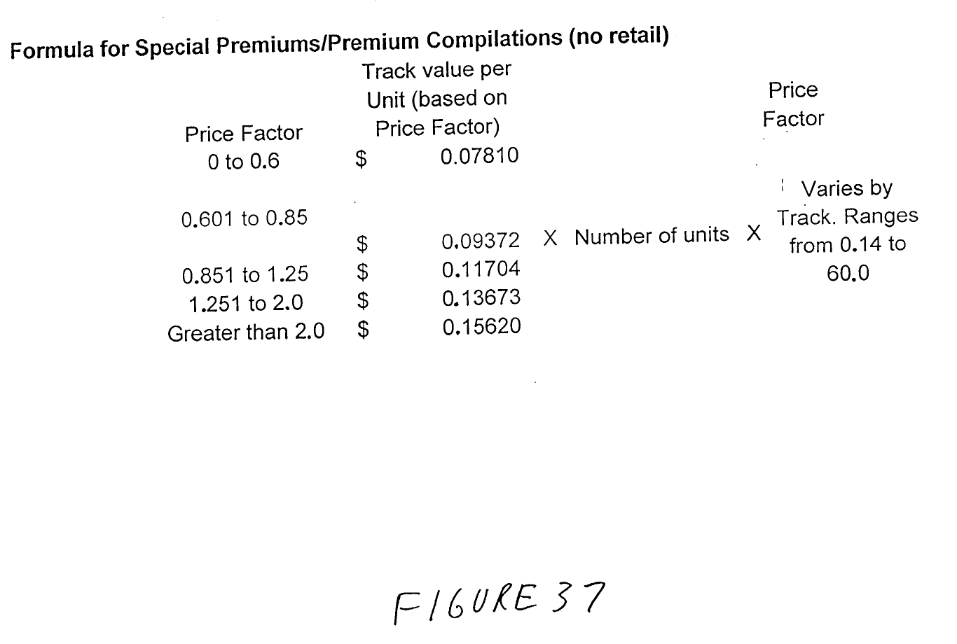

FIG. 37 shows an embodiment of a pricing algorithm for a COMPILATION use for media content. In an embodiment of the invention, for special product or premium compilation use, such as units that are produced for free promotions or giveaways, not for retail, a license fee for a media content can be based on factors such as:

1. The number of units being produced;

2. A valuation of the media content based on the price factor of that media content, such as a valuation of $0.0781 per unit if the price factor is less than or equal to 0.6; and

3. A price factor associated with the media content.

The price factor for a media content can be used to determine a track valuation, which can then be multiplied by the price factor.

Exemplary Attributes and Metamodel Interface for Licensing Fee Calculation

In an embodiment of the invention, for use in a specific medium, particular attributes of a proposed use are evaluated to determine appropriate licensing fees. For example, for use of a track in a MOTION PICTURE PRODUCTION, relevant attributes can include a geographic region of distribution, whether the track is used during the film titles, and whether the name of the track is used as the film title.

In an embodiment of the invention, for use of a track in a CORPORATE PRESENTATION, relevant attributes can include audience size and duration of the license.

To accommodate the inherent variability of attributes relevant to a specific medium, in an embodiment, the present invention uses an abstract metamodel to store and process questions and answers that are important in a fee calculation process. Depending on the user's answers to questions presented to the user, the pricing engine calculates an appropriate license fee for the media content. This metamodel may be based on a user-selected use for the track to be presented to the user as part of the licensing process, and to evaluate the user's answers.

The metamodel can include a collection of one or more pricing models. In an embodiment, each pricing model uses one or more of these attributes: ID number, model name (internal), name to be displayed to the user, base price, exclusivity indicator, and other attributes. If the exclusivity indicator is set, the user can be offered the option to license the track for exclusive use within the selected medium. Each pricing model in the metamodel can correspond directly to a “medium” or use in the user interface display.

Each pricing model can include a collection of one or more questions representing attributes of the proposed use. Each question as stored by the system of the invention contains the following attributes: ID number, question name, text to be displayed to the user, control type, number of rows, and other attributes. Control types can include checkbox, dropdown/listbox, radiobutton, and/or other types. These control types can determine the construction of the question-and-answer display to be presented to the user. If the control type is a dropdown/listbox, the number of rows attribute can determine the size of the control as displayed to the user.

Each question can include a collection of zero, one, or two or more answers. Each answer can have these attributes: ID number, answer text to be displayed to the user (ignored for checkboxes), pricing multiplier, initial selection indicator, and other attributes. In one embodiment, associated with the collection of answers for a single question, only one of the answers may have the initial selection indicator set to “true.” In another embodiment, multiple answers may be set to “true.”

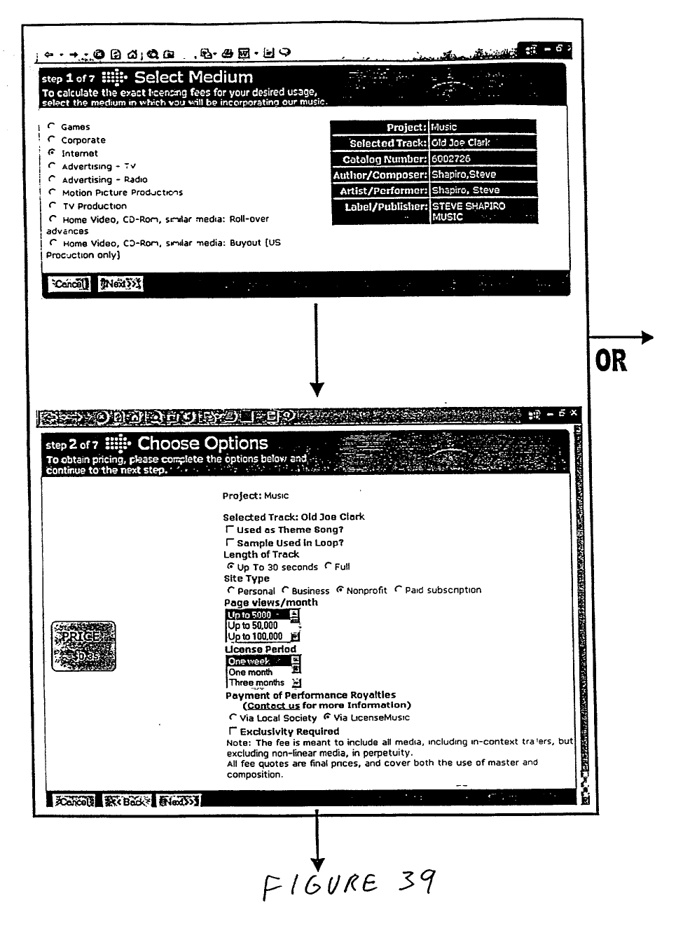

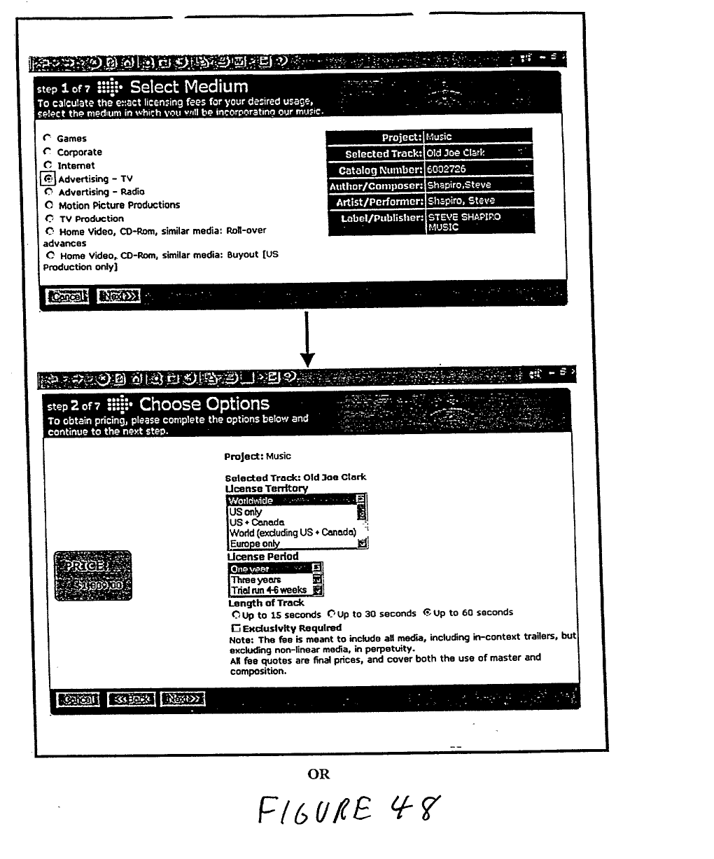

In an exemplary embodiment of the pricing metamodel of the invention, the media content licensing process as seen by the user can be implemented as exemplified but not limited to the following seven steps shown in various embodiments in FIGS. 39-53:

1. STEP 1 OF 7: SELECT MEDIUM, such as the screenshots in FIG. 13 or FIG. 39.

a. Inputs can include:

i. SelectedTrackID (optional and/or can default to zero for “typical”)

ii. ProjectID (optional and/or can default to ID of the user's first project)

iii. PricingModelTag (optional and/or can default to the first in the metamodel)

iv. Metamodel

v. Stored medium selection from a previous session (if any—stored in “My Music” project record)

b. Operation can include:

i. Metamodel is scanned to determine the display name for each medium

ii. If a stored medium selection is available, that medium is set as the default when the page is displayed, otherwise the first medium in the metamodel is set as the default.

iii. User selects desired medium.

2. STEP 2 OF 7: CHOOSE OPTIONS, such as the screenshot at the bottom of FIG. 39.

a. Inputs can include:

i. SelectedTrackID

ii. ProjectID

iii. PricingModelOffset (index into metamodel collection)

iv. Metamodel

v. SelectedTrackMultiplier (default zero=Typical)

vi. Stored user responses from a previous session (if any—stored in “My Music” project record)

b. Page assembly (server-side) can include:

i. Q&A (HTML)—customized for the selected medium. Answer values are set to defaults as indicated by the “initial selection indicator” OR to the values specified by the user in a previous session.

ii. Pricing Display (HTML)

iii. Client-side event handler (JavaScript)—customized for the selected medium

iv. applet to support remote scripting (Java)

c. Page operation (client-side) can include:

i. Initial display of page triggers a pricing calculation

ii. Any user action to change options (answers) also triggers an immediate pricing calculation

iii. Result of pricing calculation causes an update of the Pricing Display area

iv. Exception: for some web browsers which do not support the required feature set, the pricing calculation is not dynamically performed. The Pricing Display area is suppressed, and the user does not see the effects of their answers until they navigate to a subsequent page.

d. Pricing calculation mechanism can include:

i. Client-side event handler detects need for calculation, invokes remote scripting applet

ii. Remote scripting applet (Java)

1. Inputs can include:

a. PricingModelOffset

b. Answers to pricing questions (up to 10)

c. SelectedTrackMultiplier

d. String for pricing display prefix (dollar sign)

2. Operation can include:

a. Calls server-side pricing calculator, waits for calculated pricing result

b. Returns result to client-side event handler, which updates pricing display

iii. Server-side pricing calculator

1. Inputs—same as remote scripting applet, above

2. Operation can include:

a. An running fee value is initially determined by multiplying the base price of the pricing model (=“medium”) by the SelectedTrackMultiplier.

b. For each question in the pricing model, the running fee value is multiplied by the PricingMultiplier associated with the answer given by the user, the result then being used as the running fee value.

c. After each question is answered, the answer is processed, and the running fee value is calculated, formatted for display, and returned to the remote scripting applet for display to the user.

d. Exceptions:

i. If no track has been selected, the calculation of prices operates to display a “typical” price for several pricing categories. In the current implementation, five different pricing categories are shown, each with a price typical of tracks in that category. The price is still affected by the media selection and user answers.

ii. If the pricing model allows the user to request exclusivity, and the user has in fact requested it, then the pricing display shows a text message telling the user they must contact the licensing vendor to complete a licensing transaction involving exclusivity.

iii. For some mediums, the pricing model allows special rule processing in the server-side pricing calculator.

e. Repeat pricing calculation/display steps each time user changes an answer.

f. User submits answers. These answers are stored in the user's current project record.

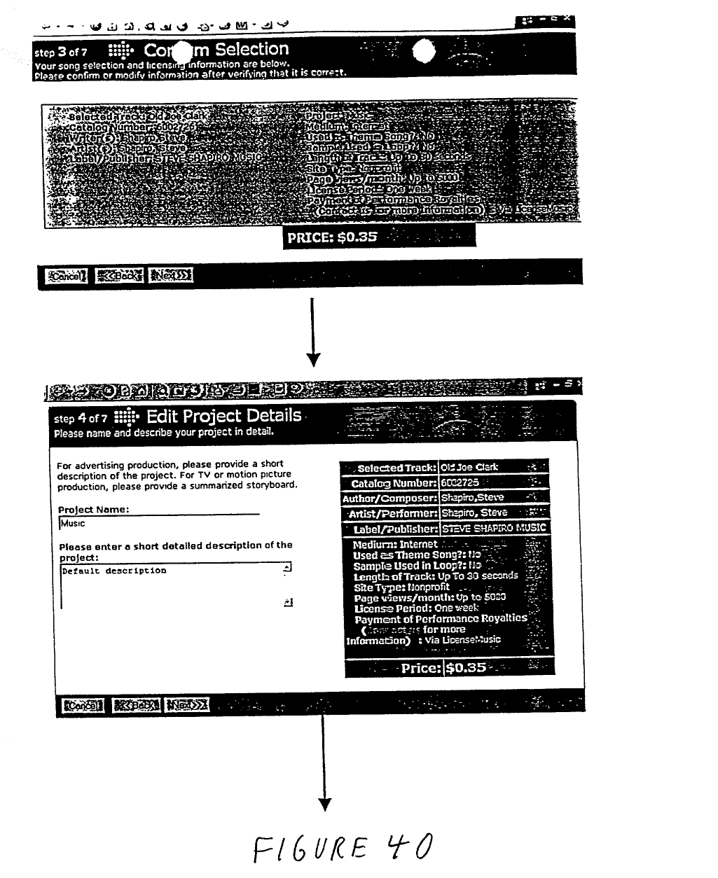

3. STEP 3 OF 7: CONFIRM SELECTION—text summary of choices, “next” to confirm or “back” to change choices, such as the screenshot at the top of FIG. 40.

4. STEP 4 OF 7: EDIT PROJECT DETAILS—text entry for project name and brief description (populated with details from the previously-stored project, if any), such as the screenshot at the bottom of FIG. 40.

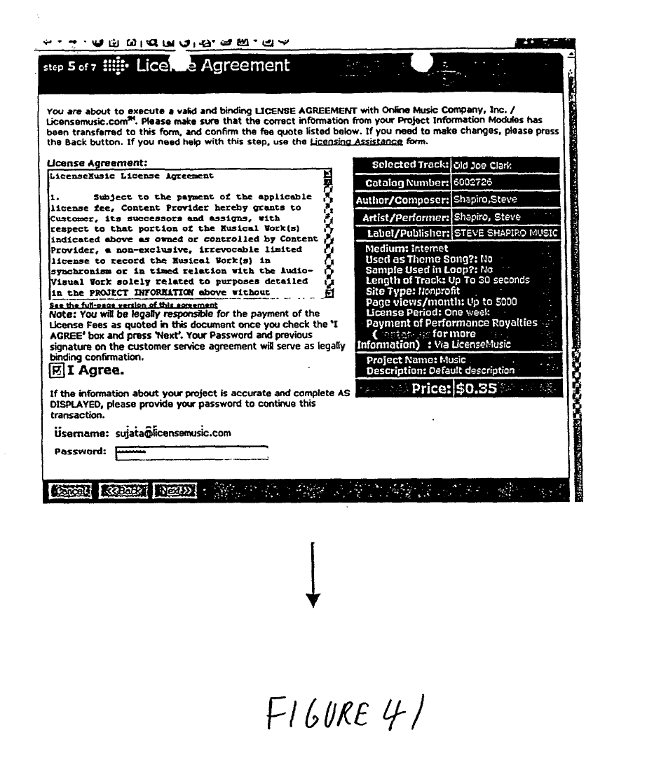

5. STEP 5 OF 7: LICENSE AGREEMENT—displays text of license agreement for use of the specified track for the specified use. User is prompted to indicate agreement by checking a checkbox and entering a valid password. [NOTE: the work flow for steps 5 through 8 is documented in license_flow.JPG, which should be come a new Figure], such as the screenshot in FIG. 41.

6. STEP 6 OF 7: DELIVERY METHOD—user selects format of track (MP3, high-quality audio, or CD)

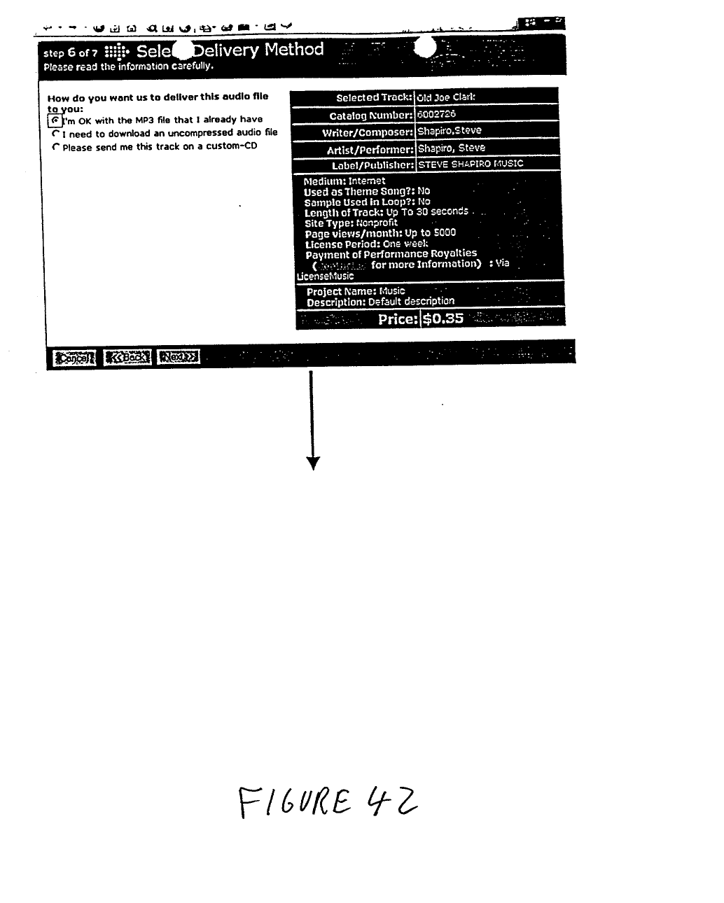

Payment Method—user selects payment method [if credit card, additional screens are displayed to gather credit card information], such as the screenshots in FIGS. 42-44.

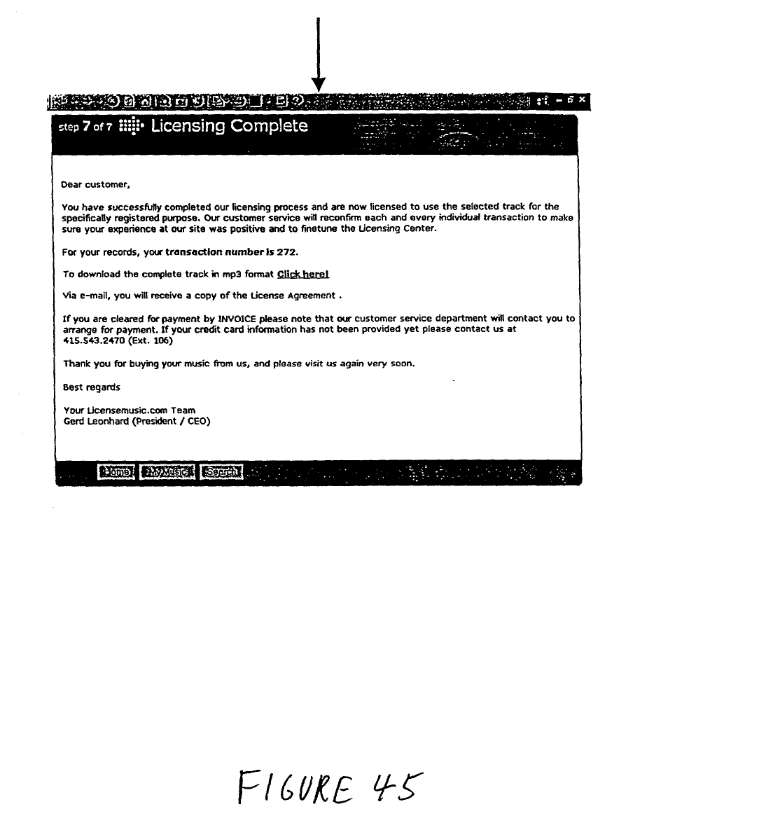

7. STEP 7 OF 7: LICENSING COMPLETE or Thank You/confirmation page, such as the screenshot in FIG. 45.

In an embodiment of the invention, the pricing engine can calculate a license fee by multiplying a Base Fee, which varies by media use, with price factor, which are related to the specifics of the use, and a price factor, which may be specific to individual pieces of media content. Specifics for a use may include an audience size, a territory, an amount of the media being used, and a license term. The specifics may depend on the overall use, such as use related to Radio Advertising, Games, Internet use, TV Advertising, Motion Picture Production, HomeVideo, CD, Corporate Presentation, and/or other uses.

In an embodiment of the invention, one or more price factors for the invention can be a relative measurement of a track or media content's license fee. The price factor can be based on individual agreements with the track or media content's owner and/or publisher. A track or media content with a price factor may have a fee that is, for example, 50% that of a track with a price factor of 1. Licensing formulas may also have fixed fees (i. e. Student films, which may have a fixed $50 fee). The same pricing structure may be used for a wide range of content.

In an embodiment of the invention, the pricing engine can implement discounts, such as for Student Films, which may have a fixed $50 reduced fee. Discounts may be included as multipliers to reduce license fees.

Referring again to FIG. 13, the user can select CANCEL to return to the previous screen. The user can select NEXT to view a CHOOSE OPTIONS screen.

Referring again to FIG. 10, the user may select a media content file, such as a song, to license by clicking or selecting the corresponding icon for the song in the SONG DETAILS column. When the user selects SONG DETAILS for a song, a SONG DETAILS screen, such as the one shown in FIG. 38, is shown.

Referring to FIG. 38, before or after deciding to license any of the media content returned in any search result, the user can choose to PREVIEW a portion of the media content, review a FULL selection of the media content, or DOWNLOAD any of the media content returned by the result. In an embodiment of the invention, if the user selects LICENSING & PRICING, a screen, such as the SELECT MEDIUM screenshot, or STEP 1 OF 7 screen, such as the top screenshot in FIG. 39, can be shown to the user.

In an embodiment of the invention, the SELECT MEDIUM screenshot in FIG. 39 presents the user with a choice of uses, or mediums for use, which are then used to determine which subsequent screen is shown to the user. In an embodiment of the invention, if the user selects INTERNET as a medium for use, for example, the CHOOSE OPTIONS screen shown at the bottom of FIG. 39 can be shown to the user.

In an embodiment of the invention, the questions asked of the user in CHOOSE OPTIONS screen, or STEP 2 OF 7, are based on the medium for use selected by the user. These questions can determine pricing, or a license fee, for the media content the user is seeking to license.

With an example of choices selected by the user such as the ones shown in CHOOSE OPTIONS in FIG. 39, when the user selects NEXT, a screen such as a CONFIRM SELECTION, or STEP 3 OF 7 screen shown in FIG. 40 can be displayed to the user. A license fee, such as $0.35 shown in the CONFIRM SELECTION screen in FIG. 40, can be communicated to the user. The license fee can be calculated by a pricing engine based on the answers to questions presented in the CHOOSE OPTIONS screen. Algorithms such as the ones shown in FIGS. 26-37 can be used to calculated the license fee. If the user selects NEXT from the CONFIRM SELECTION screen, a screen such as an EDIT PROJECT DETAILS screen shown at the bottom of FIG. 40 can be communicated to the client for display to the user.

In an embodiment of the invention, in the EDIT PROJECT DETAILS, or STEP 4 OF 7, screen shown in FIG. 40, the user can be prompted to enter a PROJECT NAME and a SHORT DETAILED DESCRIPTION OF THE PROJECT. If the user selects NEXT from the EDIT PROJECT DETAILS SCREEN, a screen such as the LICENSE AGREEMENT, or STEP 5 OF 7, screen shown in the screenshot in FIG. 41 can be communicated to the client for display to the user.

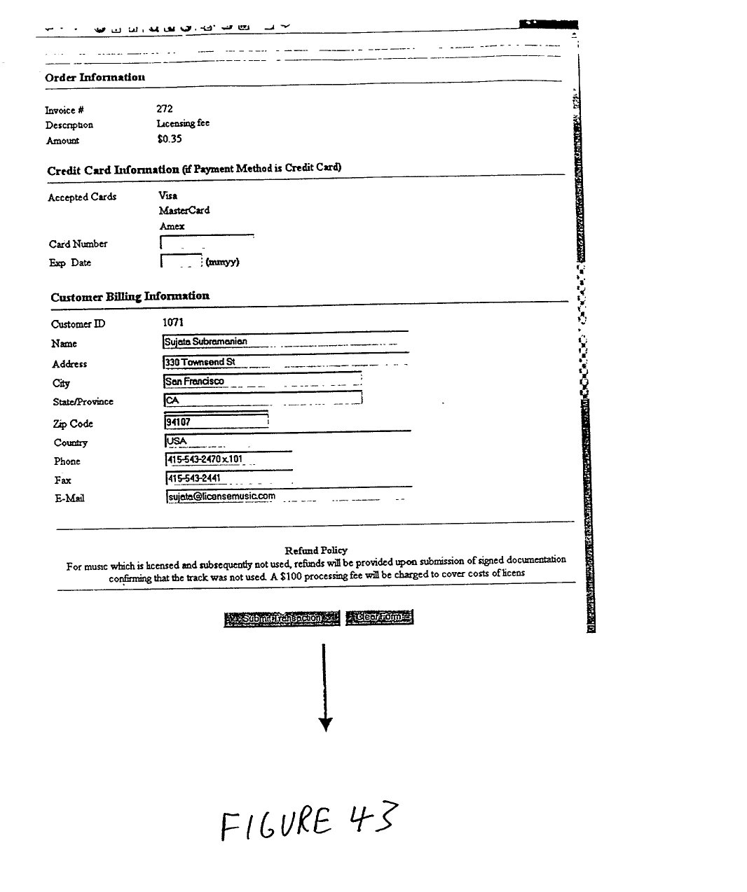

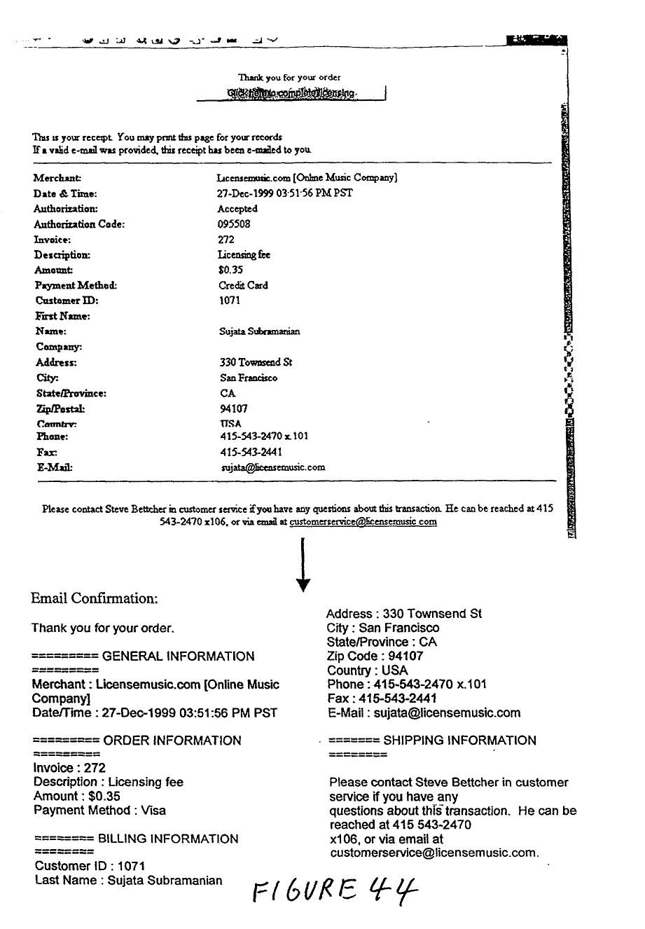

Referring to FIG. 41, if a user selects NEXT from the LICENSE AGREEMENT screen, a screen such as the SELECT DELIVERY METHOD, or STEP 6 OF 7, screen shown in the screenshot in FIG. 42 can be communicated to the client for display to the user. The screen shown in FIG. 42 is continued in FIGS. 43 and 44.

Referring to FIG. 44, if a user selects CLICK HERE TO COMPLETE LICENSING, a screen such as a LICENSING COMPLETE, or STEP 7 OF 7, screen such as the one shown in the screenshot in FIG. 45 can be communicated to the client for display to the user.

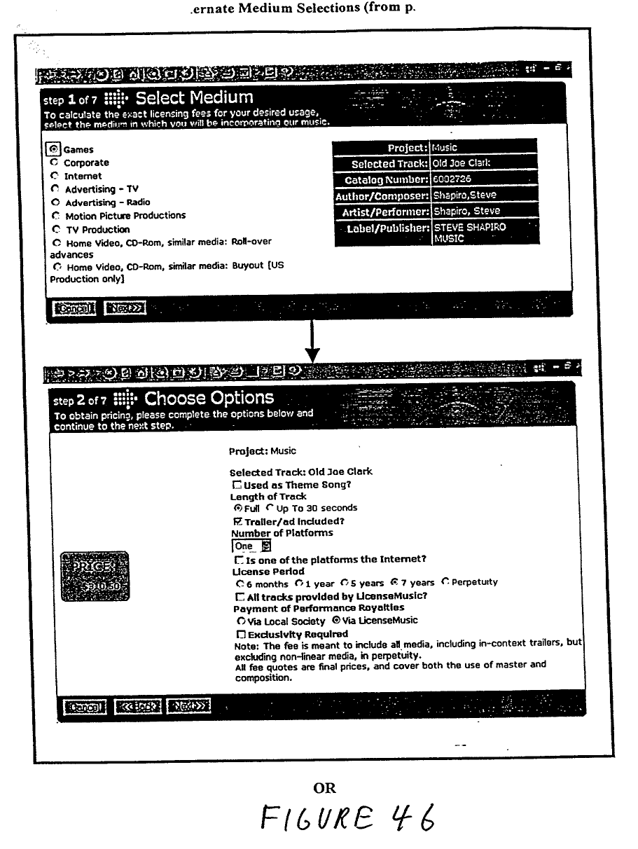

Referring again to FIG. 39, if in the SELECT MEDIUM screen, the user selects GAMES as a use, then the SELECT MEDIUM screen such as the one shown in FIG. 46 may be displayed, with GAMES selected as a use for media content.

Referring to the SELECT MEDIUM screen in FIG. 46, with GAMES selected as a use, if the user selects NEXT, a screen such as the CHOOSE OPTIONS screen shown at the bottom of FIG. 46 can be communicated to the client for display to the user. Questions or requests for information in the CHOOSE OPTIONS screen can depend upon which medium of use is selected. For example, the questions for a GAME use in the CHOOSE OPTIONS screen in FIG. 46 are different from the questions for an INTERNET use that appear in the CHOOSE OPTIONS screen in FIG. 39.

In an embodiment of the invention, the pricing engine for the invention can vary a metamodel for pricing based on use and based on the answers to questions provided by the user or another person seeking to license media content.

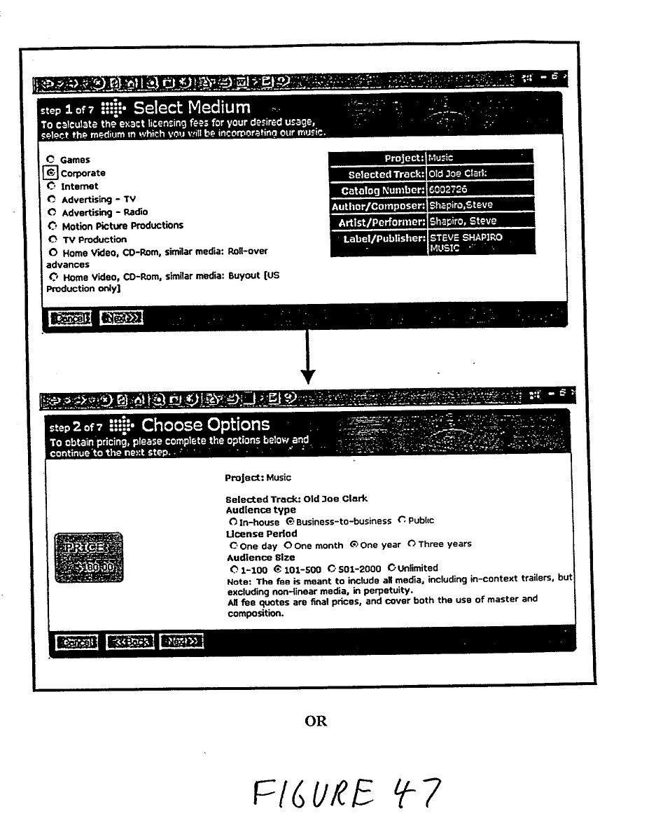

FIG. 47 shows screenshots of an embodiment of what can be communicated to the client for display to the user if the user selects CORPORATE as a use for the media content. The CHOOSE OPTIONS screen in FIG. 47 can be different from CHOOSE OPTIONS screens in FIG. 46 and FIG. 39 because the use for the media content as selected by the user is different.

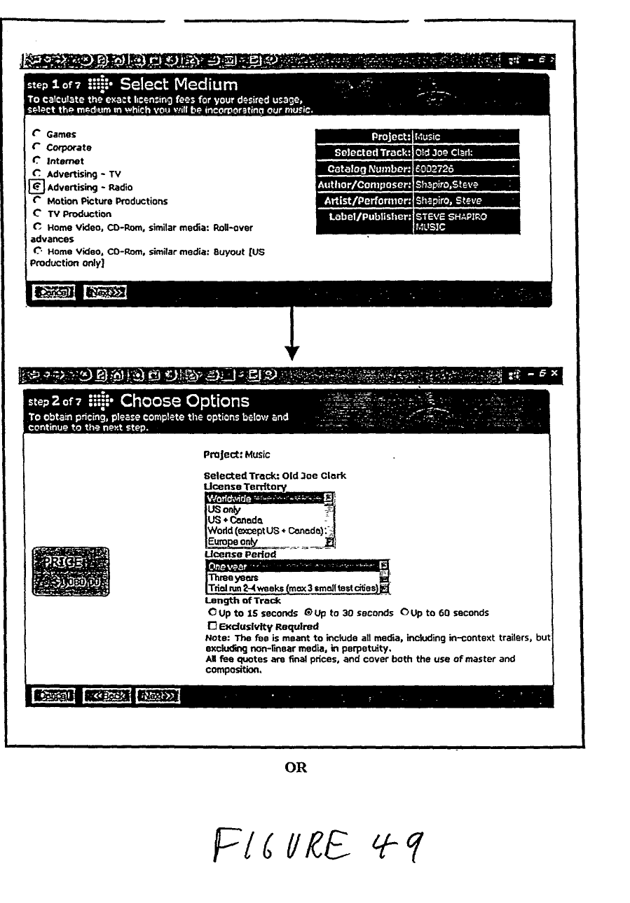

FIG. 49 shows exemplary screenshots of an embodiment of what can be communicated to the client for display to the user if the user selects ADVERTISING—RADIO, or a radio advertisement, as a use for the media content.

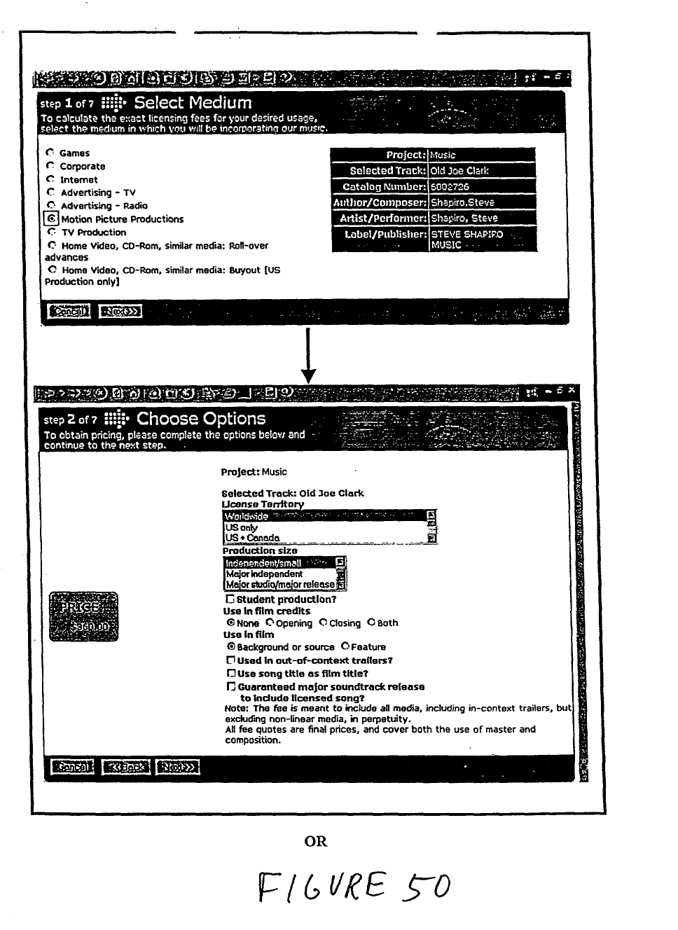

FIG. 50 shows exemplary screenshots of an embodiment of what can be communicated to the client for display to the user if the user selects MOTION PICTURE PRODUCTIONS as a use for the media content.

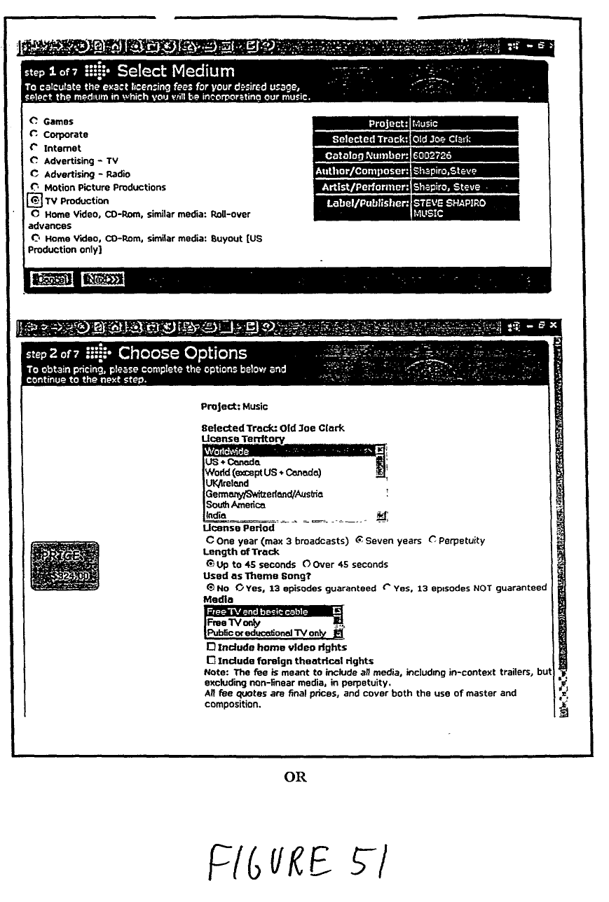

FIG. 51 shows exemplary screenshots of an embodiment of what can be communicated to the client for display to the user if the user selects TV PRODUCTION, or a television production, as a use for the media content.

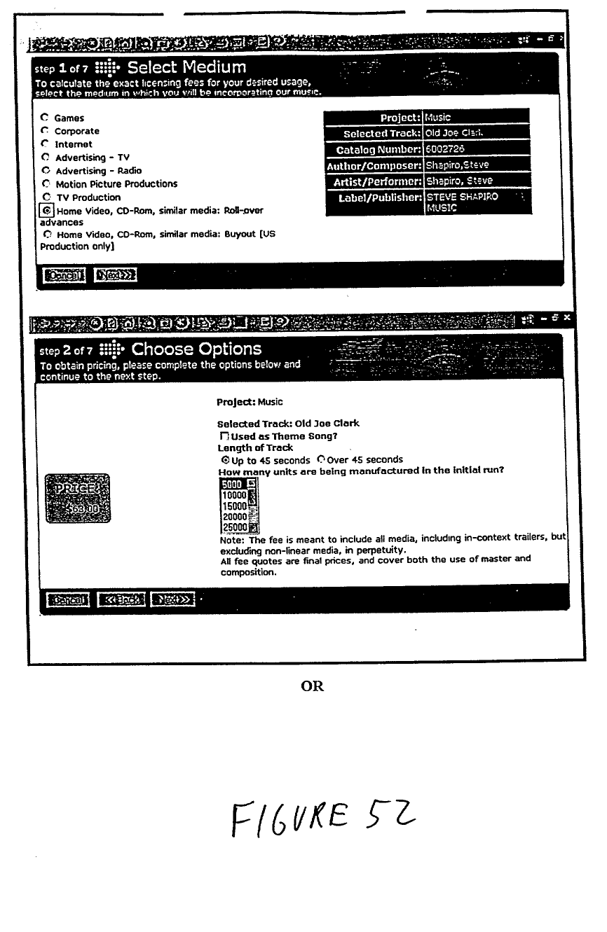

FIG. 52 shows exemplary screenshots of an embodiment of what can be communicated to the client for display to the user if the user selects HOME VIDEO, CD-ROM: ROLL-OVER ADVANCES, as a use for the media content.

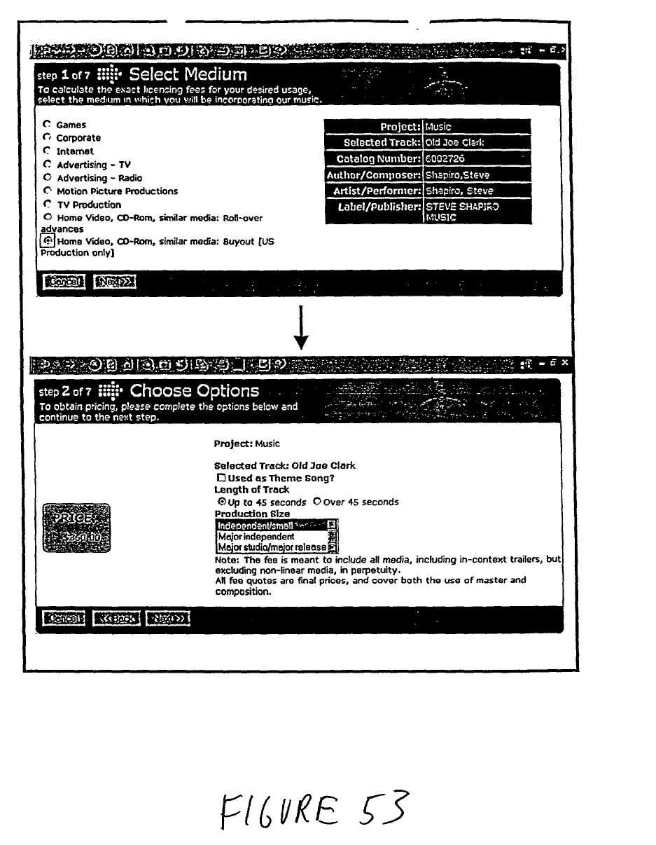

FIG. 53 shows exemplary screenshots of an embodiment of what can be communicated to the client for display to the user if the user selects HOME VIDEO, CD-ROM: BUYOUT, as a use for the media content.

As can be seen in FIGS. 38-53, the questions asked of the user may be different based on a use or medium selected by the user. For more details about the questions and conditions and how they affect pricing, please refer to FIGS. 26-37 and the descriptions for FIGS. 26-37.

Exemplary Embodiment of a Flowchart of a Media Licensing Process of the Invention

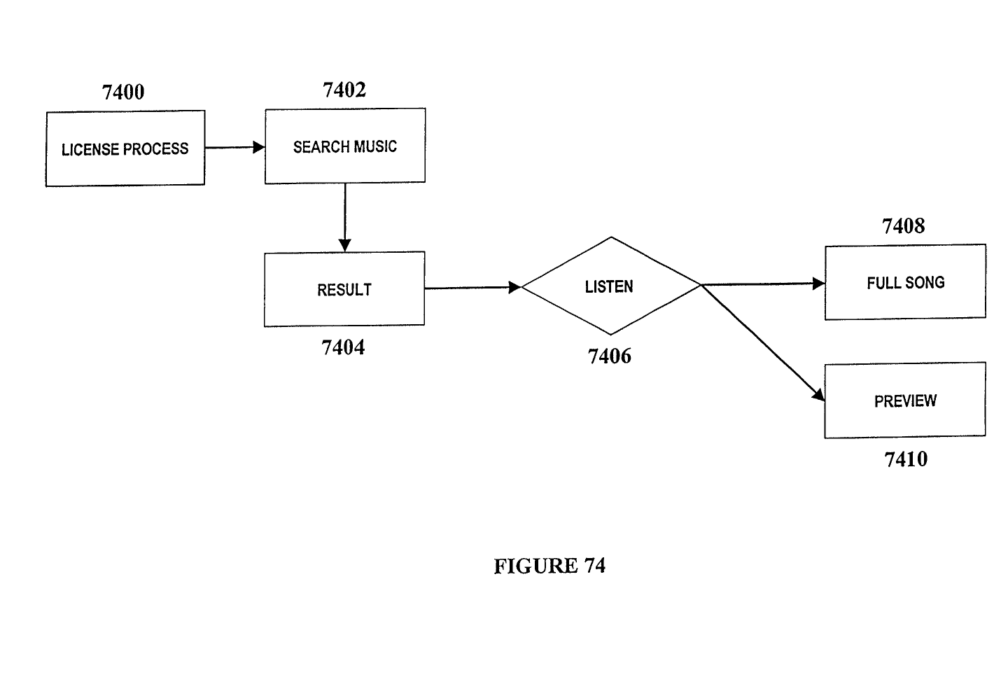

FIGS. 74-80 show exemplary flowcharts for another embodiment of the invention.

FIG. 74 is an exemplary flowchart of another embodiment of the a find media content step of the media licensing process. The LICENSE PROCESS 7400 may begin with a media content search. In one embodiment, the media search is shown by SEARCH MUSIC 7402. As previously described, the user may search for media by using one of seven search tools: VISUAL SEARCH, ADVANCE SEARCH, BROWSE, SEARCH CLASSICAL, ARTIST SEARCH, BUDGET LIBRARY, and QUICK SEARCH. In an embodiment, each music search tool uses parameters specified by the user. The server searches the associated database for media content matching the parameters specified by the user and returns a set of search results, as shown in RESULT 7404.

Before or after deciding to license any of the media content returned in any search result, the user can choose to preview a portion of the media content, review a full selection of the media content, or download any of the media content returned by the result. The user can LISTEN 7406 to a full version of the media content, shown in FIG. 74 as FULL SONG 7408. If the user selects FULL SONG 7408, the full song can be downloaded to the client, or the user can listen to the full-length version of the song. If the user selects PREVIEW 7410, a shortened version of the media content, for example 30 seconds, is downloaded to the client, or the user can preview the shortened version. This shortened version of the media content can contain a portion of the full-length version of the media content.

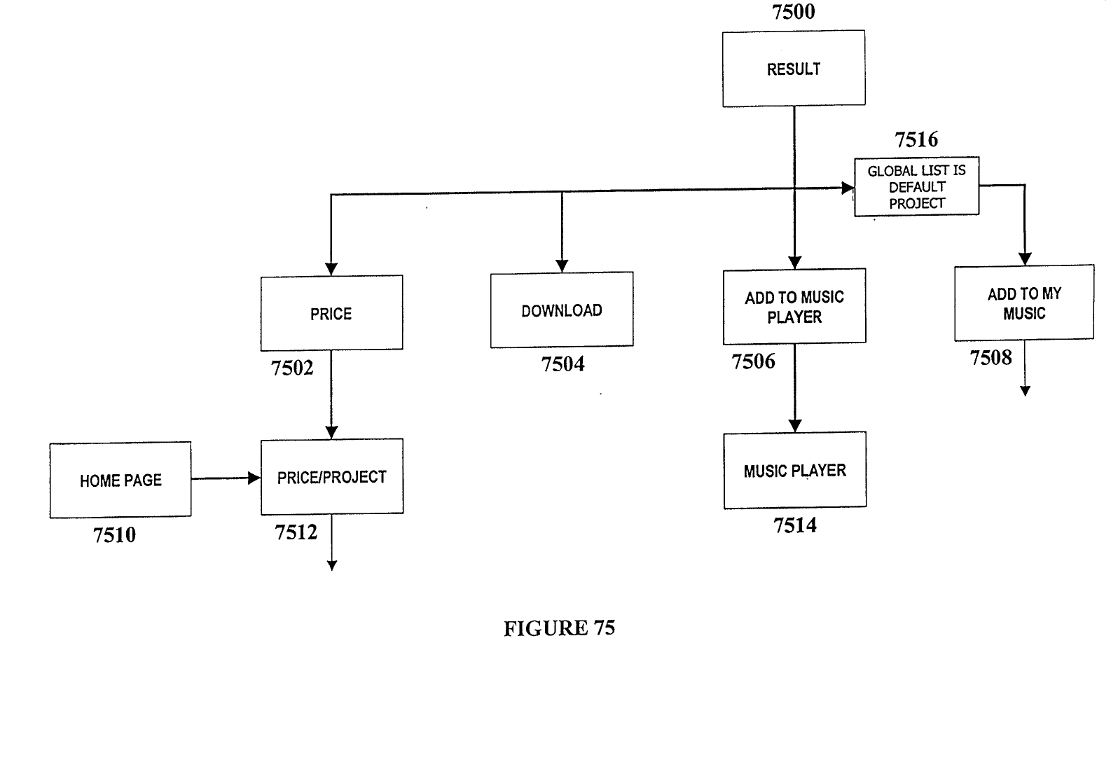

Once the user selects and decides to license a set of media content, the user proceeds from RESULT 7404 to FIG. 75. FIG. 75 is a flowchart showing the next steps of the process, beginning with RESULT 7500. The user can select PRICE 7502, DOWNLOAD 7504, ADD TO MUSIC PLAYER 7506, or ADD TO MY MUSIC 7508 using GLOBAL LIST IS DEFAULT PROJECT 7516.

The user can price one or more media content files by selecting PRICE/PROJECT 7512 on the user's graphical user interface. The user can also proceed directly to PRICE/PROJECT 7512 from the original HOMEPAGE 7510 without having to conduct a search and obtain a result.

The user can DOWNLOAD 7504 a media content file or preview file to the client's hard disk by selecting DOWNLOAD 7504 on the client's graphical user interface.

The user can add one or more media content files from the result to a sophisticated databank and preference storage system by clicking or selecting ADD TO MY MUSIC 7508 on the user's graphical user interface. MY MUSIC is an information storage and retrieval system that the user can personalize for optimum management of the user's account for the licensing media system. MY MUSIC may be used by the user to organize and format the user's account preferences, projects and media content selections into an easily accessible databank. An embodiment of MY MUSIC is shown in the screenshot in FIG. 12.

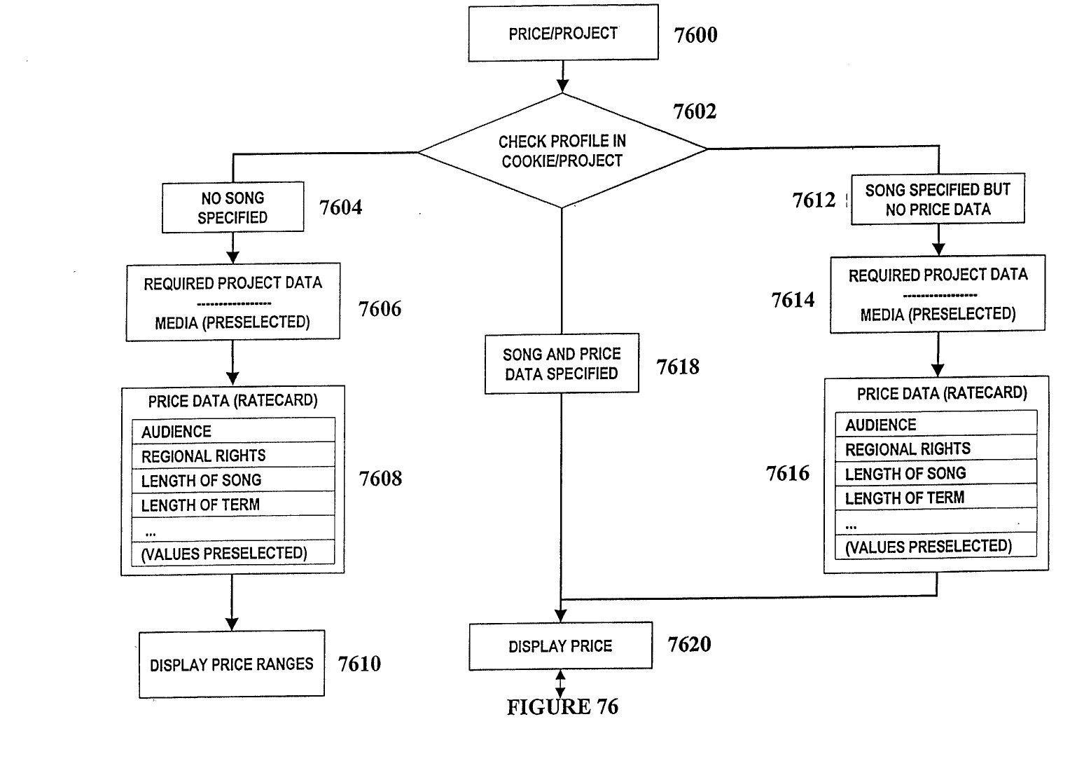

In another embodiment of the invention, FIG. 76 is an exemplary flowchart showing how the invention can price license fees for one or more media content files for a user, for example with the user initiating the process by selecting an option such as PRICE/PROJECT 7600 on one of the screens or displays communicated to the user's graphical user interface. The system can perform step CHECK PROFILE IN COOKIE/PROJECT 7602 to determine the user's inputted preferences and whether a media file, for instance a song, has been specified by the user. The system also checks whether price data has been specified by the user. If SONG AND PRICE DATA 7618 are both specified, the system can directly calculate a licensing price. After calculating price data, step DISPLAY PRICE RANGES 7610 may communicate price data for each song to the user.

If NO SONG SPECIFIED 7604 occurs, the system obtains required project data from the user. REQUIRED PROJECT DATA, MEDIA (PRESELECTED) 7606 can indicate that a choice of medium or use has already been passed as a parameter or fetched from a project record. After a medium or use has been determined, PRICE DATA 7608 can be retrieved, basing pricing on preselected user values, including user answers to questions based on one or more mediums or uses selected by the user, with such questions directed such exemplary factors as an intended audience, regional rights, length of song, and length of term. Intended audience can be the size and composition of the audience. Regional rights can be the user requested territory of distribution for the song. Length of song may be the temporal length of the song. Length of term may be a license duration requested, 1 year, 2 years, or permanent.

If CHECK PROFILE IN COOKIE/PROJECT 7602 determines that a song is specified, but no price data has been input by the user in step 7612, the system may ask the user to input required project data in step 7616. The user can be asked, based upon one or more mediums or uses selected by the user for media content, to input factors affecting price data, such as audience, regional rights, length of song, and length of term. If the user does not input any price data, the system may use preselected values from step 7614.

The system may then calculate price data and display price for the media content, such as a song, to the client in step DISPLAY PRICE 7620.

If the user has specified song and price data, a price for the media content, such as a song, may be automatically calculated and communicated to the client for display to the user.

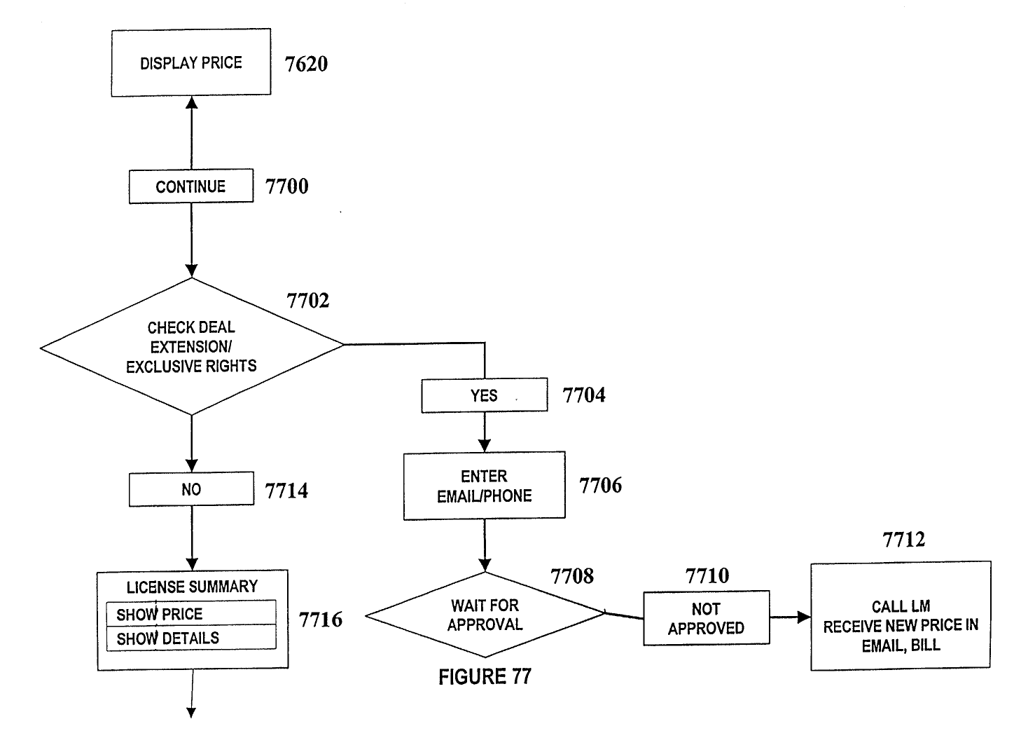

In an embodiment of the invention, FIG. 77 is an exemplary flowchart illustrating functional blocks after the step DISPLAY PRICE 7620 in FIG. 76. The user can CHECK DEAL EXTENSION/EXCLUSIVE RIGHTS 7702 by clicking or selecting CONTINUE 7700 on a price display screen. If the selected media content file or song is not eligible for exclusive licensing rights in step 7714, a LICENSE SUMMARY 7716 may be printed showing price for the media content file or song and details describing licensing terms for the media content file or song.

In an embodiment of the invention, if the selected media content file or song is eligible for exclusive licensing rights in step 7704, the user may be asked to ENTER AN EMAIL ADDRESS AND PHONE NUMBER 7706. Then, the user may be prompted to WAIT FOR APPROVAL 7708 for the transaction. If the transaction is NOT APPROVED 7710, the user may be prompted to phone a licensing manager in step CALL LM RECEIVE NEW PRICE IN EMAIL, BILL 7712.

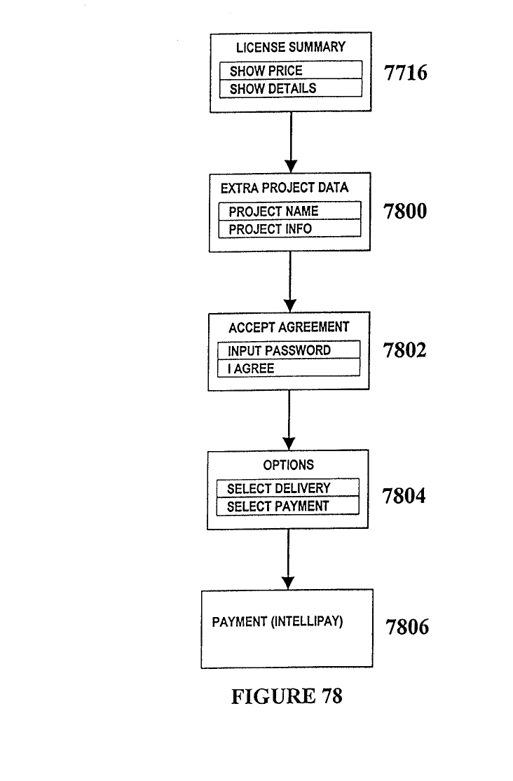

In an embodiment of the invention, FIG. 78 is an exemplary flowchart illustrating functional blocks after step LICENSE SUMMARY 7716 in FIG. 77. After LICENSE SUMMARY 7716, the user may be prompted to enter EXTRA PROJECT DATA 7800. EXTRA PROJECT DATA 7800 may include a PROJECT NAME and PROJECT INFORMATION. The user may also be prompted to accept the agreement in step ACCEPT AGREEMENT 7802, which may require input of the user's password and a final confirmation by the user to continue. OPTIONS 7804 may provide delivery and payment options for the user. PAYMENT 7806 of a license fee may be accomplished through Intellipay or another online payment transaction system.

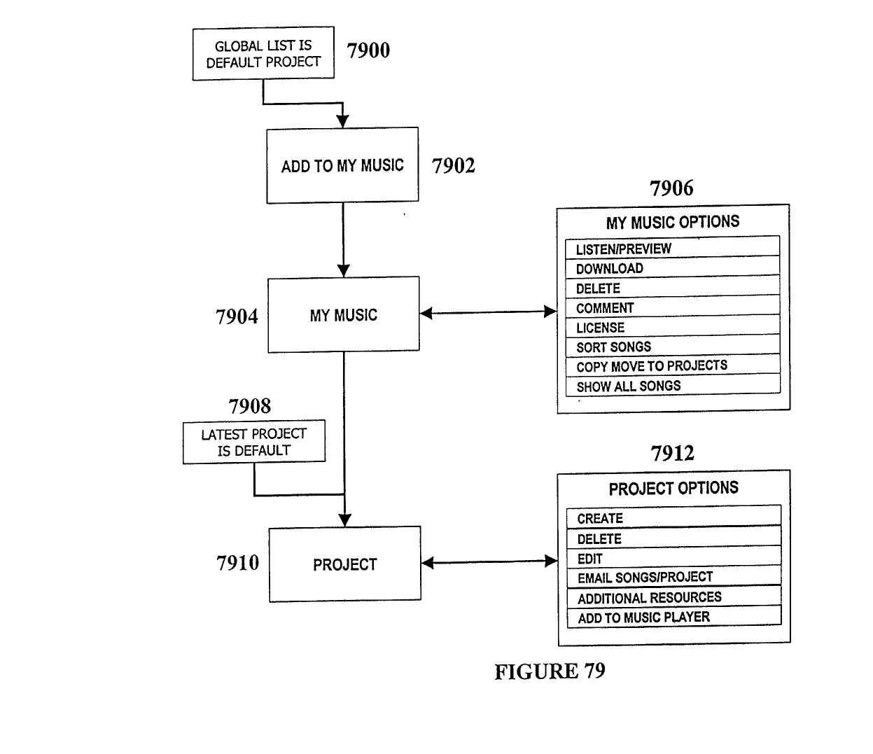

In an embodiment of the invention, FIG. 79 is an exemplary flowchart illustrating in more detail a MY MUSIC 7904 information and storage and retrieval system. Each user may have a unique and customized MY MUSIC 7904 system, which can be based in part on preferences entered by the user. The user can add one or more media content files to the user's MY MUSIC 7904 system from a search results screen after the user has conducted a media content search, such as through one of the search tools of the invention. A default project for the user may be a global list of media content files in step GLOBAL LIST IS DEFAULT PROJECT 7900.

When the user selects ADD TO MY MUSIC 7902 from a search result, a song details, or another screen, a MY MUSIC 7904 screen may be communicated to the client for display to the user. Options on the MY MUSIC 7904 screen may include My Music Options. MY MUSIC OPTIONS 7906 may include such options as listening and previewing media files, downloading media files, deleting media files from the user's project, viewing comments about media files, licensing media files, sorting media files, copying media files to multiple user projects, and displaying all media files in the user's my music system. The user may navigate to the user's set of projects. Each PROJECT 7910 may include a set of media files, plus preferences specified by the user, including the requested licensing use for the media files. A LATEST PROJECT 7908 may be the default project for the user, in that preferences most recently specified by the user may be retained by the system. PROJECT OPTIONS 7912 for the user may include such options as creating a project, deleting a project, editing a project, emailing media files within a project, searching for additional resources, and adding media files to the user's media player.

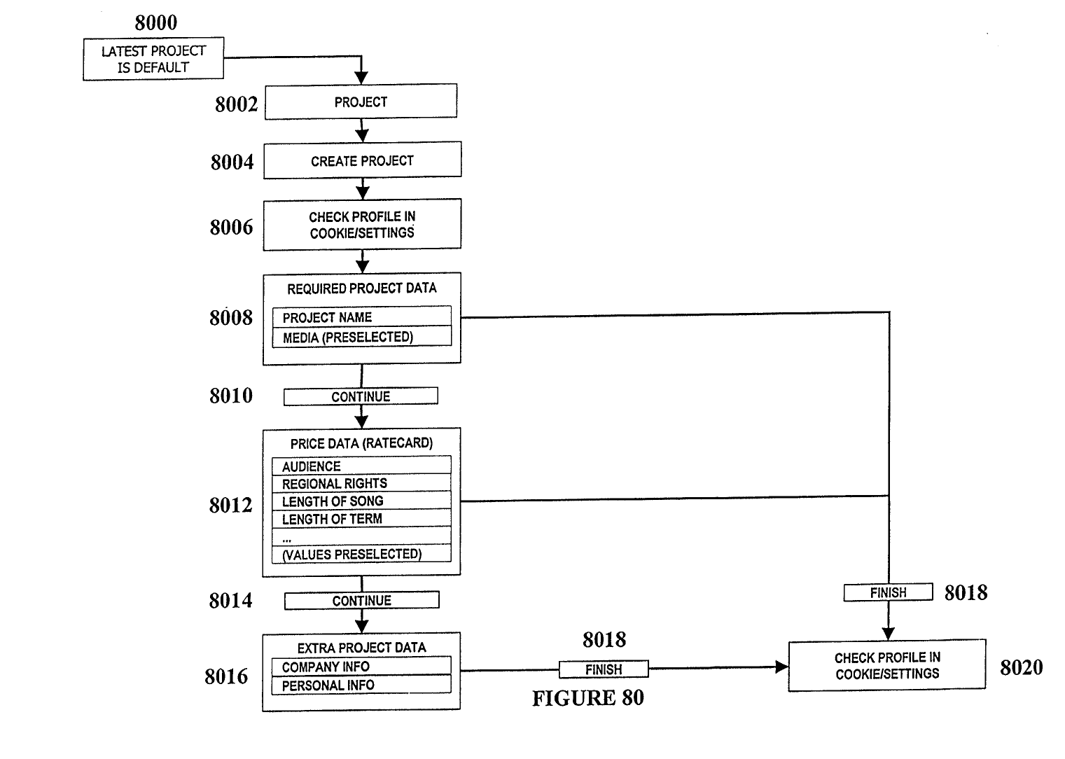

In an embodiment of the invention, FIG. 80 shows an exemplary detailed flowchart for a user's PROJECT 8002 from FIG. 79. If the user has previously entered a project, the most recently entered, or LATEST PROJECT 8000, may be displayed as the PROJECT 8002. If the user has not previously entered a project, the user may be prompted to CREATE a PROJECT 8004.

The system of the present invention, such as the Java applet, may check the user's profile in step CHECK PROFILE IN COOKIE/SETTINGS 8006, for example to determine any additional project data needed, such as a medium or use for the media content. The system may prompts the user for REQUIRED PROJECT DATA 8008, which may include a project name and preselected media, such as one or more mediums or uses selected by the user for licensing of the media content.

After prompting the user to CONTINUE 8010, the system may communicate PRICE DATA 8012 to the client for display to the user. PRICE DATA 8012 may be based on answers to questions such as intended audience, region for which licensing rights are sought, length of the media content, duration or term of license, and other preselected values. Such questions may depend on a medium or a use selected by the user. After prompting the user to CONTINUE 8014, the system may prompt the user to enter EXTRA PROJECT DATA 8016, which may include company information and personal information.

The licensing process completes at step FINISH 8018, with the system making a final check of the user's profile, which may be based on cookies sent to the user and user settings in step CHECK PROFILE IN COOKIE/SETTINGS 8020.

Although the invention has been described in conjunction with particular embodiments, it will be appreciated that various modifications and alterations may be made by those skilled in the art without departing from the spirit and scope of the invention. The invention is not to be limited by the foregoing illustrative details, but rather is to be defined by the appended claims.

The invention claimed is:

1. A method of graphically searching media over a network including a client, a server, and at least one database associated with the server comprising:
communicating to the client at least one objective parameter;
receiving at least one objective parameter choice from the client;
searching the at least one database for at least one matching media file that matches the at least one objective parameter choice.

2. The method of claim 1 further comprising:
graphically displaying to the client the at least one matching media file; and
communicating a license offer for the media content.

3. The method of claim 1, wherein the at least one objective parameter includes at least one member selected from the group consisting of subject, instrument, region, language, composer, time period, and maximum price.

4. The method of claim 2, wherein the graphical display is in the form of a Venn Diagram.

5. A method of graphically searching media over a network including a client, a server, and at least one database associated with the server comprising:
communicating to the client at least one subjective parameter;
receiving at least one subjective parameter choice from the client; and
searching the at least one database for at least one matching media file that matches the at least one subjective parameter choice.

6. The method of claim 5, wherein the at least one subjective parameter includes at least one member selected from the group consisting of genre, style, tempo, and mood.

7. A method of displaying search results for media content, comprising:
(a) receiving a first parameter choice;
(b) searching at least one database for media content matching the first parameter choice;
(c) displaying a graphic representation of media content matching the first parameter choice;
(d) receiving a second parameter choice;
(e) searching the at least one database for media content matching the second parameter choice;
(f) displaying a graphic representation of media content matching the second parameter choice; and
(g) displaying a graphic representation of media content matching both the first parameter choice and the second parameter choice.

8. The method of claim 7, wherein:
step (c) comprises displaying a first region representing the media content matching the first parameter choice;
step (f) comprises displaying a second region representing the media content matching the second parameter choice; and
step (g) comprises displaying a first intersection region, wherein the first intersection region represents the media content matching both the first parameter choice and the second parameter choice.

9. The method of claim 8, further comprising:
calculating a number of matches associated with the first region; and
displaying the number of matches.

10. The method of claim 8, further comprising:
calculating a number of matches associated with the second region; and
displaying the number of matches.

11. The method of claim 8 further comprising displaying a number of matches associated with the first intersection region.

12. The method of claim 8, wherein the first region is re-sized in connection with display of the second region.

13. The method of claim 8, wherein, the second region is re-sized.

14. The method of claim 12, wherein the size of the first region corresponds to the number of media content matches to the first parameter choice from the client.

15. The method of claim 13, wherein the size of the second region corresponds to the number of media content matches to the second parameter choice from the client, and wherein the regions are substantially circular.

16. The method of claim 6 further comprising:
receiving a third parameter choice from the client;
searching the at least one database for media content matching the third parameter choice;
displaying a graphic representation of media content matching the third parameter choice; and
displaying a graphic representation of media content matching the first, second, and third parameter choices.

17. A method of displaying search results for data, comprising:
receiving a first parameter choice and a second parameter choice;
searching at least one database for matches to the first and the second parameter choices;
displaying a graphic representation of data that matches the first parameter choice;
displaying a graphic representation of data that matches the second parameter choice; and
displaying a graphic representation of data that matches both the first and the second parameter choices.

18. The method of claim 17, wherein the data is media content.

19. A method of licensing media over a network including a client and a server, the method comprising:
receiving over the network a request associated with media content, wherein the request contains at least one preference;
calculating a license fee for the media content using the at least one preference; and
communicating a license offer for the media content.

20. The method of claim 19, wherein the media content includes at least one member selected from the group consisting of audio content, still image content, and video content.

21. The method of claim 19, wherein the at least one preference includes a use for the media content.

22. The method of claim 19, wherein the at least one preference includes at least one member selected from the group consisting of a medium for use of the media content, a duration of the media content, and a production size for use of the media content.

23. The method of claim 21, wherein the use is associated with at least one member selected from the group consisting of a game use, a corporate use, an internet use, an advertisement use, a motion picture production use, a home video use, a CD-ROM use, a roll-over advance use, a music compilation use, a music programming and syndication use, and a buyout use.

24. A method of licensing media over a network having a client, a server, and a database associated with the server, wherein the database stores a plurality of media files, comprising:
receiving a search request from the client, wherein the search request contains at least one parameter specified by the client;
searching the database for at least one media file matching the at least one parameter specified by the client; and
communicating a representation of a license offer for the at least one media file matching the set of the at least one parameter.

25. A method of licensing media over a network including a client, a server, and a database associated with the server, wherein the database includes a plurality of media files, comprising:
receiving a search request from the client, wherein the search request contains at least one parameter specified by the client;
searching the database for at least one media file matching the at least one parameter specified by the client;
communicating to the client a list of at least one preview file associated with the at least one matching media file;
receiving a request for a preview file from the list; and
communicating to the client the requested preview file.

26. The method of claim 25, wherein the at least one listed preview file includes at least one full-length version of the associated at least one matching media file.

27. The method of claim 25, further comprising communicating to the client a matching media file associated with the requested preview file.

28. A method of licensing media over a network including a client associated with a user, a server, and a database associated with the server, wherein the database includes a plurality of media files, comprising:
receiving a search request from the client, wherein the search request includes at least one parameter specified by the client;
searching the database for at least one media file matching the at least one parameter specified by the client;
communicating to the client a list of the at least one matching media file;
receiving a license request for at least one of the matching media files, wherein the license request includes at least one user preference;
calculating a license fee for the at least one requested media file using the at least one user preference; and
sending a license offer for the at least one requested matching media file.

29. An apparatus for licensing media over a network comprising:
a server and a database associated with the server, wherein the server communicates at least one objective parameter to a client, receives at least one objective parameter choice from the client, and searches the at least one database for at least one matching media file that matches the at least one objective parameter choice.

30. The apparatus of claim 29, wherein the server graphically displays to the client the at least one matching media file and
communicates a license offer for the media content.

31. The apparatus of claim 30, wherein the graphical display is in the form of a Venn Diagram.

32. An apparatus for graphically searching media over a network comprising:
a server and at least one database associated with the server, wherein the server:
communicates to a client at least one subjective parameter;
receives at least one subjective parameter choice from the client; and
searches the at least one database for at least one matching media file that matches the at least one subjective parameter choice.

33. An apparatus for displaying search results for media content comprising a server and at least one database associated with the server, wherein the server:
(a) receives a first parameter choice;
(b) searches the at least one database for media content matching the first parameter choice;
(c) communicates for display a graphic representation of media content matching the first parameter choice;
(d) receives a second parameter choice;
(e) searches the at least one database for media content matching the second parameter choice;
(f) communicates for display a graphic representation of media content matching the second parameter choice; and
(g) communicates for display a graphic representation of media content matching both the first parameter choice and the second parameter choice.

34. The apparatus of claim 33, wherein:
(c) further comprises communicating for display a first region representing the media content matching the first parameter choice;
(f) further comprises communicating for display a second region representing the media content matching the second parameter choice; and
(g) further comprises communicating for display a first intersection region, wherein the first intersection region represents the media content matching both the first parameter choice and the second parameter choice.

35. The apparatus of claim 34, wherein the server calculates a number of matches associated with the first region and communicates for display a representation of the number of matches.

36. The apparatus of claim 34, wherein the server calculates a number of matches associated with the second region and communicates for display a representation of the number of matches.

37. The apparatus of claim 34, wherein the server communicates for display a representation of a number of matches associated with the first intersection region.

38. The apparatus of claim 34, wherein the first region is re-sized in connection with display of the second region.

39. The apparatus of claim 34, wherein the second region is re-sized.

40. An apparatus for displaying search results for data, comprising a server and at least one database, wherein the server:
receives a first parameter choice and a second parameter choice;
searches the at least one database for matches to the first and the second parameter choices;
communicates for display a graphic representation of data that matches the first parameter choice;
communicates for display a graphic representation of data that matches the second parameter choice; and
communicates for display a graphic representation of data that matches both the first and the second parameter choices.

41. The apparatus of claim 40, wherein the data is media content.

42. An apparatus for licensing media over a network, comprising a client and a server, where in the server:
receives over the network a request associated with media content, wherein the request contains at least one preference;
calculates a license fee for the media content using the at least one preference; and
communicates a representation of a license offer for the media content.

43. The apparatus of claim 42, wherein the media content includes at least one member selected from the group consisting of audio content, still image content, and video content.

44. The apparatus of claim 42, wherein the at least one preference includes a use for the media content.

45. The apparatus of claim 42, wherein the at least one preference includes at least one member selected from the group consisting of a medium for use of the media content, a duration of the media content, and a production size for use of the media content.

46. The method of claim 44, wherein the use is associated with at least one member selected from the group consisting of a game use, a corporate use, an internet use, an advertisement use, a motion picture production use, a home video use, a CD-ROM use, a roll-over advance use, a music compilation use, a music programming and syndication use, and a buyout use.

47. An apparatus for licensing media over a network, comprising a server and a database associated with the server, wherein the database stores a plurality of media files, and wherein the server:
receives a search request from the client, wherein the search request contains at least one parameter specified by a client associated with the server;
searches the database for at least one media file matching the at least one parameter specified by the client; and
communicates a representation of a license offer for the at least one media file matching the set of the at least one parameter.

48. An apparatus for licensing media over a network comprising a server and a database associated with the server, wherein the database includes a plurality of media files, wherein the server:
receives a search request from a client associated with the server, wherein the search request includes at least one parameter specified by the client;
searches the database for at least one media file matching the at least one parameter specified by the client;
communicates to the client a list including the at least one matching media file;
receives a license request for at least one of the matching media files, wherein the license request includes at least one user preference;
calculates a license fee for the at least one requested media file using the at least one user preference; and
sends a representation of a license offer for the at least one requested matching media file.

49. An article of manufacture comprising:
a computer usable medium including computer readable program code embodied therein for causing graphically searching media over a network having a client, a server, and at least one database associated with the server, the computer readable program code in said article of manufacture comprising:
computer readable program code means for causing a computer to effect communicating to the client at least one objective parameter;
computer readable program code means for causing the computer to receive at least one objective parameter choice from the client; and
computer readable program code means for causing the computer to search the at least one database for at least one matching media file that matches the at least one objective parameter choice.

50. The article of manufacture of claim 49, further comprising:
computer readable program code means for causing the computer to graphically display to the client the at least one matching media file; and
computer readable program code means for causing the computer to communicate a license offer for the media content.

51. The article of manufacture of claim 49, wherein the at least one objective parameter includes at least one member selected from the group consisting of subject, instrument, region, language, composer, time period, and maximum price.

52. The article of manufacture of claim 50, wherein the graphical display is in the form of a Venn Diagram.

53. A computer program product for use with a system for graphically searching media over a network having a client, a server, and at least one database associated with the server, said computer program product comprising:
a computer usable medium including computer readable program code means embodied in said medium for causing graphically searching media, said computer program product including:
computer readable program code means for causing a computer to effect communicating to the client at least one objective parameter;
computer readable program code means for causing said computer to receive at least one objective parameter choice from the client; and
computer readable program code means for causing said computer to search the at least one database for at least one matching media file that matches the at least one objective parameter choice.

54. The computer program product of claim 53, further comprising:
computer readable program code means for causing said computer to graphically display to the client the at least one matching media file; and
computer readable program code means for causing said computer to communicate a license offer for the media content.

55. The method of claim 53, wherein the at least one objective parameter includes at least one member selected from the group consisting of subject, instrument, region, language, composer, time period, and maximum price.

56. The method of claim 54, wherein the graphical display is in the form of a Venn Diagram.

57. An article of manufacture comprising:
a computer usable medium including computer readable program code embodied therein for causing graphically searching media over a network including a client, a server, and at least one database associated with the server, the computer readable program code in said article of manufacture comprising:
computer readable program code means for causing a computer to effect communicating to the client at least one subjective parameter;
computer readable program code means for causing the computer to receive at least one subjective parameter choice from the client; and
computer readable program code means for causing the computer to search the at least one database for at least one matching media file that matches the at least one subjective parameter choice.

58. A computer program product for use with a system for graphically searching media over a network having a client, a server, and at least one database associated with the server, said computer program product comprising:
a computer usable medium including computer readable program code means embodied in said medium for causing graphically searching media, said computer program product including:
computer readable program code means for causing a computer to effect communicating to the client at least one subjective parameter;
computer readable program code means for causing said computer to receive at least one subjective parameter choice from the client; and
computer readable program code means for causing said computer to search the at least one database for at least one matching media file that matches the at least one subjective parameter choice.

59. An article of manufacture comprising:
a computer usable medium including computer readable program code embodied therein for causing displaying search results for media content, the computer readable program code in said article of manufacture comprising:
(a) computer readable program code means for causing a computer to effect receiving a first parameter choice;
(b) computer readable program code means for causing the computer to search at least one database for media content matching the first parameter choice;
(c) computer readable program code means for causing the computer to display a graphic representation of media content matching the first parameter choice;
(d) computer readable program code means for causing the computer to receive a second parameter choice;
(e) computer readable program code means for causing the computer to search the at least one database for media content matching the second parameter choice;
(f) computer readable program code means for causing the computer to display a graphic representation of media content matching the second parameter choice; and
(g) computer readable program code means for causing the computer to display a graphic representation of media content matching both the first parameter choice and the second parameter choice.

60. A computer program product for use with a system for displaying search results for media content, said computer program product comprising:
a computer usable medium including computer readable program code means embodied in said medium for causing displaying search results for media content, said computer program product including:
(a) computer readable program code means for causing a computer to effect receiving a first parameter choice;
(b) computer readable program code means for causing the computer to search at least one database for media content matching the first parameter choice;
(c) computer readable program code means for causing said computer to display a graphic representation of media content matching the first parameter choice;
(d) computer readable program code means for causing said computer to receive a second parameter choice;
(e) computer readable program code means for causing said computer to search the at least one database for media content matching the second parameter choice;
(f) computer readable program code means for causing said computer to display a graphic representation of media content matching the second parameter choice; and
(g) computer readable program code means for causing said computer to display a graphic representation of media content matching both the first parameter choice and the second parameter choice.

61. An article of manufacture comprising:
a computer usable medium including computer readable program code embodied therein for causing displaying search results for data, the computer readable program code in said article of manufacture comprising:
(a) computer readable program code means for causing a computer to effect receiving a first parameter choice and a second parameter choice;
(b) computer readable program code means for causing the computer to search at least one database for matches to the first and the second parameter choices;
(c) computer readable program code means for causing the computer to display a graphic representation of data that matches the first parameter choice;
(d) computer readable program code means for causing the computer to display a graphic representation of data that matches the second parameter choice; and
(e) computer readable program code means for causing the computer to display a graphic representation of data that matches both the first and the second parameter choices.

62. A computer program product for use with a system for displaying search results for data, said computer program product comprising:
a computer usable medium including computer readable program code means embodied in said medium for causing displaying search results for data, said computer program product including:
(a) computer readable program code means for causing a computer to effect receiving a first parameter choice and a second parameter choice;
(b) computer readable program code means for causing the computer to search at least one database for matches to the first and the second parameter choices;
(c) computer readable program code means for causing the computer to display a graphic representation of data that matches the first parameter choice;
(d) computer readable program code means for causing the computer to display a graphic representation of data that matches the second parameter choice; and
(e) computer readable program code means for causing the computer to display a graphic representation of data that matches both the first and the second parameter choices.

63. An article of manufacture comprising:
a computer usable medium including computer readable program code embodied therein for causing licensing media over a network having a client and a server, the computer readable program code in said article of manufacture comprising:
(a) computer readable program code means for causing a computer to effect receiving over the network a request associated with media content, wherein the request contains at least one preference;
(b) computer readable program code means for causing the computer to calculate a license fee for the media content using the at least one preference; and
(c) computer readable program code means for causing the computer to communicate a license offer for the media content.

64. A computer program product for use with a system for licensing media over a network having a client and a server, said computer program product comprising:
a computer usable medium including computer readable program code means embodied in said medium for causing licensing media, said computer program product including:
(a) computer readable program code means for causing a computer to effect receiving over the network a request associated with media content, wherein the request contains at least one preference;
(b) computer readable program code means for causing the computer to calculate a license fee for the media content using the at least one preference; and
(c) computer readable program code means for causing the computer to communicate a license offer for the media content.

65. An article of manufacture comprising:
a computer usable medium including computer readable program code embodied therein for causing licensing media over a network having a client, a server, and a database associated with the server, wherein the database stores a plurality of media files, the computer readable program code in said article of manufacture comprising:
(a) computer readable program code means for causing a computer to effect receiving a search request from the client, wherein the search request contains at least one parameter specified by the client;
(b) computer readable program code means for causing the computer to search the database for at least one media file matching the at least one parameter specified by the client; and
(c) computer readable program code means for causing the computer to communicate a representation of a license offer for the at least one media file matching the set of the at least one parameter.

66. A computer program product for use with a system for licensing media over a network having a client, a server, and a database associated with the server, wherein the database stores a plurality of media files, said computer program product comprising:
a computer usable medium including computer readable program code means embodied in said medium for causing licensing media, said computer program product including:
(a) computer readable program code means for causing a computer to effect receiving a search request from the client, wherein the search request contains at least one parameter specified by the client;
(b) computer readable program code means for causing the computer to search the database for at least one media file matching the at least one parameter specified by the client; and
(c) computer readable program code means for causing the computer to communicate a representation of a license offer for the at least one media file matching the set of the at least one parameter.

67. An article of manufacture comprising:
a computer usable medium including computer readable program code embodied therein for causing licensing media over a network having a client, a server, and a database associated with the server, wherein the database includes a plurality of media files, the computer readable program code in said article of manufacture comprising:
(a) computer readable program code means for causing a computer to effect receiving a search request from the client, wherein the search request contains at least one parameter specified by the client;
(b) computer readable program code means for causing the computer to search the database for at least one media file matching the at least one parameter specified by the client;
(c) computer readable program code means for causing the computer to communicate to the client a list of at least one preview file associated with the at least one matching media file;
(d) computer readable program code means for causing the computer to receive a request for a preview file from the list; and
(e) computer readable program code means for causing the computer to communicate to the client the requested preview file.

68. A computer program product for use with a system for licensing media over a network having a client, a server, and a database associated with the server, wherein the database includes a plurality of media files, said computer program product comprising:
a computer usable medium including computer readable program code means embodied in said medium for causing licensing media, said computer program product including:
(a) computer readable program code means for causing a computer to effect receiving a search request from the client, wherein the search request contains at least one parameter specified by the client;
(b) computer readable program code means for causing the computer to search the database for at least one media file matching the at least one parameter specified by the client;
(c) computer readable program code means for causing the computer to communicate to the client a list of at least one preview file associated with the at least one matching media file;
(d) computer readable program code means for causing the computer to receive a request for a preview file from the list; and
(e) computer readable program code means for causing the computer to communicate to the client the requested preview file.

69. An article of manufacture comprising:
a computer usable medium including computer readable program code embodied therein for causing licensing media over a network, the computer readable program code in said article of manufacture comprising:
(a) computer readable program code means for causing a computer to effect receiving a search request from a client, wherein the search request includes at least one parameter specified by the client;
(b) computer readable program code means for causing the computer to searching at least one database for at least one media file matching the at least one parameter specified by the client;
(c) computer readable program code means for causing the computer to communicate to the client a list including a representation of the at least one matching media file;
(d) computer readable program code means for causing the computer to receive a license request for at least one of the matching media files, wherein the license request includes at least one user preference;
(e) computer readable program code means for causing the computer to calculate a license fee for the at least one requested media file using the at least one user preference; and
(f) computer readable program code means for causing the computer to communicate a representation of a license offer for the at least one requested matching media file.

70. A computer program product for use with a system for licensing media over a network, said computer program product comprising:
a computer usable medium including computer readable program code means embodied in said medium for causing licensing media, said computer program product including:
(a) computer readable program code means for causing a computer to effect receiving a search request from a client, wherein the search request includes at least one parameter specified by the client;
(b) computer readable program code means for causing the computer to searching at least one database for at least one media file matching the at least one parameter specified by the client;
(c) computer readable program code means for causing the computer to communicate to the client a list including a representation of the at least one matching media file;
(d) computer readable program code means for causing the computer to receive a license request for at least one of the matching media files, wherein the license request includes at least one user preference;
(e) computer readable program code means for causing the computer to calculate a license fee for the at least one requested media file using the at least one user preference; and
(f) computer readable program code means for causing the computer to communicate a representation of a license offer for the at least one requested matching media file.
